(19) United States
(12) Patent Application Publication
(10) Pub. No.: US 2022/0386248 A1
(43) Pub. Date: Dec. 1, 2022

(54) INFORMATION PROCESSING DEVICE, INFORMATION PROCESSING METHOD, AND COMMUNICATION DEVICE

(71) Applicant: SONY GROUP CORPORATION, TOKYO (JP)

(72) Inventor: SHO FURUICHI, TOKYO (JP)

(21) Appl. No.: 17/755,926

(22) PCT Filed: Nov. 12, 2020
(86) PCT No.: PCT/JP2020/042246

§ 371 Date: May 11, 2022

(30) Foreign Application Priority Data
Nov. 19, 2019 (JP) 2019-209068

(51) Int. Cl. H04W 52/34; H04W 16/08; H04W 16/14; H04W 72/10; H04W 72/08

(52) U.S. Cl. CPC H04W 52/343; H04W 16/08; H04W 16/14; H04W 72/10; H04W 72/082

(57) ABSTRACT

An information processing device (60) includes: an acquisition unit (641) that acquires information regarding each of a plurality of second radio systems that share a radio wave used by a first radio system; a calculation unit (642) that calculates an allocation priority for each of the plurality of second radio systems based on the information acquired by the acquisition unit (641); and an allocation unit (643) that allocates, as an interference amount, a total interference amount allowed by the first radio system to each of the plurality of second radio systems based on the allocation priority calculated by the calculation unit (642).

### FIELD

The present disclosure relates to an information processing device, an information processing method, and a communication device.

### BACKGROUND

There is an emerging problem of exhaustion of radio resources available for allocation to radio systems (radio devices). Therefore, in recent years, “dynamic spectrum sharing (Dynamic Frequency Access (DSA))” that utilizes a temporally or spatially unused space (white space) among frequency bands allocated to a specific radio system has rapidly attracted attention.

### CITATION LIST

### Non Patent Literature

Non Patent Literature 1: WINNF-TS-0247-V1.2.0 CBRS Certified Professional Installer Accreditation Technical Specification.
Non Patent Literature 2: WINNF-TS-0016-V1.2.4 Signaling Protocols and Procedures for Citizens Broadband Radio Service (CBRS): Spectrum Access System (SAS)—Citizens Broadband Radio Service Device (CBSD) Interface Technical Specification
Non Patent Literature 3: ECC Report 186, Technical and operational requirements for the operation of white space devices under geo-location approach, CEPT ECC, 2013 January
Non Patent Literature 4: White Space Database Provider (WSDB) Contract, available at https://www.ofcom.org.uk/_data/assets/pdf_file/0026/84077/white_space_database_contract_for_operational_use_of_wsds.pdf
Non Patent Literature 5: WINNF-TS-0096-V1.3.1 Signaling Protocols and Procedures for Citizens Broadband Radio Service (CBRS): Spectrum Access System (SAS)—SAS Interface Technical Specification
Non Patent Literature 6: WINNF-TS-0112-V1.8.0 Requirements for Commercial Operation in the U.S. 3550-3700 MHz Citizens Broadband Radio Service Band
Non Patent Literature 7: IEEE Std 802.19.1aTM-2017 “Coexistence Methods for Geo-location Capable Devices Operating under General Authorization”
Non Patent Literature 8: 47 C.F.R Part 96 Citizens Broadband Radio Service, https://www.ecfr.gov/cgi-bin/text-idx?node=pt47.5.96#se47.5.96
Non Patent Literature 9: WINNF-TS-0245-V1.0.0 Operations for Citizens Broadband Radio Service (CBRS): Priority Access License (PAL) Database Technical Specification
Non Patent Literature 10: WINNF-TS-0061-V1.5.1 Test and Certification for Citizens Broadband Radio Service (CBRS); Conformance and Performance Test Technical Specification; SAS as Unit Under Test (UUT)
Non Patent Literature 11: WINNF-SSC-0008 Spectrum Sharing Committee Policy and Procedure Coordinated Periodic Activities Policy
Non Patent Literature 12: ITU-R P.452-11, “Prediction procedure for the evaluation of microwave interference between stations on the surface of the Earth at frequencies above about 0.7 GHz”, https://www.itu.int/dms_pubrec/itu-r/rec/p/R-REC-P.452-11-200304-S!!PDF-E.pdf
Non Patent Literature 13: WINNF-TR-2004-V1.0.0 Operations for Citizens Broadband Radio Service (CBRS); GAA Spectrum Coordination—Approach 2

### SUMMARY

### Technical Problem

Here, an interference margin allocation algorithm of a sequential allocation process (iterative allocation process (IAP)) is defined as a method for protecting non-federal incumbents and priority access users from interference from lower-tier users in a citizens broadband radio service (CBRS).

However, since the sequential allocation process performs processing with no priority to all grants, the interference margin cannot be appropriately allocated depending on the state of the base station and the use case.

In view of this, the present disclosure proposes an information processing device, an information processing method, and a communication device capable of appropriately allocating an interference margin.

### Solution to Problem

An information processing device includes: an acquisition unit that acquires information regarding each of a plurality of second radio systems that share a radio wave used by a first radio system; a calculation unit that calculates an allocation priority for each of the plurality of second radio systems based on the information acquired by the acquisition unit; and an allocation unit that allocates, as an interference amount, a total interference amount allowed by the first radio system to each of the plurality of second radio systems based on the allocation priority calculated by the calculation unit.

### BRIEF DESCRIPTION OF DRAWINGS

FIG. 1 is a diagram illustrating an example of allocation of an interference margin to each of communication devices constituting a secondary system.

FIG. 2 is a diagram illustrating a hierarchical structure in CBRS.

FIG. 3 is a diagram illustrating CBRS bands.

FIG. 4 is a diagram illustrating a configuration example of a communication system according to an embodiment of the present disclosure.

FIG. 5 is a diagram illustrating a model in which communication control devices are arranged in a distributed manner.

FIG. 6 is a diagram illustrating a model in which one communication control device centrally controls a plurality of communication control devices.

FIG. 7 is a diagram illustrating another example of an arrangement model of the communication control device.

FIG. 8 is a diagram illustrating a configuration example of a radio wave utilization device according to an embodiment of the present disclosure.

FIG. 9 is a diagram illustrating a configuration example of a management device according to an embodiment of the present disclosure.

FIG. 10 is a diagram illustrating a configuration example of a terminal device according to an embodiment of the present disclosure.

FIG. 11 is a diagram illustrating a configuration example of a base station device according to an embodiment of the present disclosure.

FIG. 12 is a diagram illustrating a configuration example of a proxy device according to an embodiment of the present disclosure.

FIG. 13 is a diagram illustrating a configuration example of a communication control device according to an embodiment of the present disclosure.

FIG. 14 is a diagram illustrating an example of an interference model assumed in an embodiment of the present disclosure.

FIG. 15 is a diagram illustrating another example of an interference model assumed in an embodiment of the present disclosure.

FIG. 16 is a diagram illustrating an interference margin simultaneous allocation type primary system protection method.

FIG. 17 is a diagram illustrating a state in which a surplus margin occurs.

FIG. 18 is a diagram illustrating an interference margin sequential allocation type primary system protection method.

FIG. 19 is a diagram illustrating specifications of a transmission bandwidth.

FIG. 20 is a diagram illustrating specifications of a transmission bandwidth.

FIG. 21 is a diagram illustrating specifications of a transmission bandwidth.

FIG. 22 is a diagram illustrating specifications of a transmission bandwidth.

FIG. 23 is a diagram illustrating specifications of a transmission bandwidth.

FIG. 24 is a diagram illustrating specifications of a transmission bandwidth.

FIG. 25 is a sequence diagram illustrating a registration procedure.

FIG. 26 is a sequence diagram illustrating an available spectrum query procedure.

FIG. 27 is a sequence diagram illustrating a spectrum grant procedure.

FIG. 28 is a state transition diagram illustrating a radio transmission permission state.

FIG. 29 is a sequence diagram illustrating a spectrum use notification/heartbeat procedure.

FIG. 30 is a sequence diagram illustrating a management information exchange procedure.

FIG. 31 is a diagram illustrating an example of a signaling procedure in a case where communication between terminal devices is assumed as communication of a secondary system.

FIG. 32 is a sequence diagram illustrating an example of an operation related to a grant.

FIG. 33 is a diagram illustrating specific processing contents of a periodic process.

FIG. 34 is a diagram in a case where there is a plurality of protection points to be interference calculation targets.

FIG. 35 is a diagram illustrating a relationship between base station devices in an upper group obtained as grouping and protection points.

FIG. 36 is a flowchart illustrating a procedure of an interference margin allocation process.

### DESCRIPTION OF EMBODIMENTS

Embodiments of the present disclosure will be described below in detail with reference to the drawings. Note that, in each of the following embodiments, the same parts are denoted by the same reference symbols, and a repetitive description thereof will be omitted.

Moreover, in the present specification and the drawings, a plurality of components having substantially the same functional configuration will be distinguished by attaching different numbers or alphabets after the same reference numerals. For example, a plurality of configurations having substantially the same functional configuration is distinguished as necessary, such as communication control devices 60₁ and 60₂. Moreover, a plurality of configurations having substantially the same functional configuration is distinguished as necessary, such as communication systems 2A and 2B. However, when it is not particularly necessary to distinguish between the plurality of components having substantially the same functional configuration, only the same reference numeral is given. For example, when there is no need to distinguish between the communication control devices 60₁ and 60₂ in particular, they are simply referred to as a communication control device 60. Furthermore, when there is no need to distinguish between the communication systems 2A and 2B in particular, they are simply referred to as the communication system 2.

The present disclosure will be described in the following order.

1. Introduction

1-1. Control of radio system for achieving spectrum sharing

1-2. Outline of present embodiment

1-3. Terms related to spectrum and sharing

2. Configuration of communication system

2-1. Overall configuration of communication system

2-2. Configuration of radio wave utilization device

2-3. Configuration of management device

2-4. Configuration of terminal device

2-5. Configuration of base station device

2-6. Configuration of intermediate device

2-7. Configuration of communication control device

3. Interference model

4. Primary system protection method

4-1. Interference margin simultaneous allocation type

4-2. Interference margin sequential allocation type

5. Description of various procedures

5-1. Registration procedure

5-2. Available spectrum query procedure

5-3. Spectrum grant procedure

5-4. Spectrum use notification/heartbeat

5-5. Supplement to various procedures

5-6. Various procedures related to terminal device

5-7. Procedure occurring between communication control

devices

5-8. Information transmission means

5-9. Representative operation flow

6. Operation related to allocation of interference margin

6-1. Operation according to conventional IAP

6-2. Case of allocation prioritization

7. Modification

8. Conclusion

### 1. Introduction

With recent increase and diversification of radio environments having a mixture of various radio systems and the volume of content transferred via radio communications, there has been an emerging problem of exhaustion of radio resources (for example, frequency/spectrum) available for allocation to the radio systems. However, many radio bands are already used by incumbent radio systems, making it difficult to allocate new radio resources. In view of this, in recent years, more effective use of radio resources by utilization of cognitive radio technology has started to attract attention.

In the cognitive radio technology, radio resources are worked out by utilizing temporally and spatially unused radio spectrum (white space) of the incumbent radio system (for example, by using dynamic spectrum sharing (Dynamic Spectrum Access (DSA))). In the United States, for example, with the aim of opening a Federal use band (3.55-3.70 GHz), which overlaps with a frequency band that is worldwide 3GPP bands 42 and 43, to the general public, legislation and standardization of a Citizens Broadband Radio Service (CBRS) utilizing a spectrum sharing technology are accelerating.

Note that the cognitive radio technology contributes not merely to dynamic spectrum sharing but also to improvement of spectrum use efficiency by a radio system. For example, ETSI EN 303 387 and IEEE 802.19.1-2014 define a technology of inter-radio system coexistence technology using unused radio spectrum.

<1-1. Control of Radio System for Achieving Spectrum Sharing>

In general case of spectrum sharing, it is required, by the National Regulatory Authority (NRA) of each country/region, to protect the radio system (primary system) of the primary user licensed or authorized for the use of a frequency band. Typically, an acceptable interference reference value regarding the primary system is defined by the NRA, and the radio system (secondary system) of the secondary user is required to suppress the interference occurring by sharing to a value below the acceptable interference reference value.

In the following description, a “system” represents a set of a plurality of components (devices, modules (components), and the like). At this time, it would not matter whether or not all the components are in the same housing. For example, each of a plurality of devices housed in separate housings and connected via a network or the like, and one device in which a plurality of modules is housed in one housing, is a “system” in each case. That is, a radio system such as a primary system and a secondary system may each be configured by a plurality of devices or may be configured by one device.

In order to achieve spectrum sharing, for example, a communication control device (for example, the spectrum management database) controls communication of the secondary system so as not to give fatal interference to the primary system. The communication control device is a device that manages communication and the like of the communication device. For example, the communication control device is a system for managing radio resources (for example, spectrum), such as a geo-location database (GLDB) and a spectrum access system (SAS). In the present embodiment, the communication control device corresponds to the communication control device 60 described below. The communication control device 60 will be described in detail below.

Here, the primary system is, for example, a system (for example, an incumbent system) that preferentially uses a predetermined frequency band over other systems. In addition, the secondary system is, for example, a system that performs secondary use (for example, dynamic spectrum sharing) of a frequency band used by the primary system. Each of the primary system and the secondary system may include a plurality of communication devices or may include one communication device. The communication control device allocates an interference tolerance to one or a plurality of communication devices constituting the secondary system such that interference aggregation of the one or a plurality of communication devices toward the primary system would not exceed an interference tolerance (also referred to as an interference margin) of the primary system. At this time, the interference tolerance may be an interference amount preliminarily determined by an operator of the primary system, a public organization that manages radio waves, or the like. In the following description, the interference margin refers to the interference tolerance. In addition, interference aggregation may be referred to as aggregated interfering power.

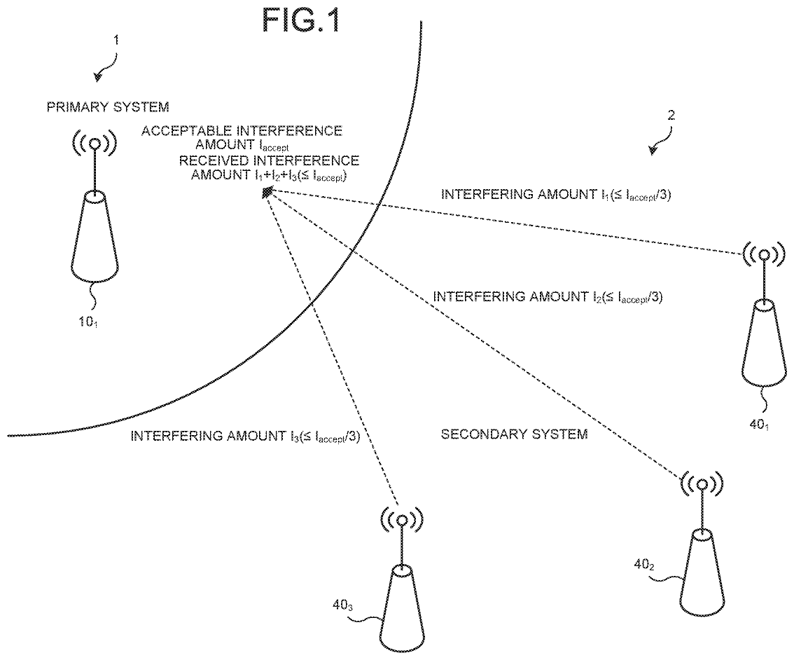

FIG. 1 is a diagram illustrating an example of allocation of an interference margin to each of communication devices constituting a secondary system. In the example of FIG. 1, a communication system 1 is the primary system, while a communication system 2 is the secondary system. The communication system 1 includes a radio wave utilization device 10₁ and the like. Furthermore, the communication system 2 includes base station devices 40₁, 40₂, 40₃, and the like. Although the example of FIG. 1 is a case where the communication system 1 includes only one radio wave utilization device 10, the communication system 1 may include a plurality of radio wave utilization devices 10. Furthermore, although the example of FIG. 1 is a case where the communication system 2 includes three base station devices 40, the number of base station devices 40 included in the communication system 2 may be less than or more than three. In addition, the radio communication device included in the communication system 2 does not necessarily have to be a base station device. Although the example of FIG. 1 illustrates only one primary system (the communication system 1 in the example of FIG. 1) and only one secondary system (the communication system 2 in the example of FIG. 1), the primary system and the secondary system may each be provided in plurality.

Each of the radio wave utilization device 10₁ and the base station devices 40₁, 40₂, and 40₃ can transmit and receive radio waves. The interference amount acceptable by the radio wave utilization device 10₁ is I_{accept}. In addition, interference amounts given to predetermined protection points of the communication system 1 (primary system) by the base station devices 40₁, 40₂, and 40₃ are interfering amounts I₁, I₂, and I₃, respectively. Here, the protection point is a reference-point regarding interference calculation for protection of the communication system 1.

The communication control device allocates the interference margin I_{accept} to the plurality of base station devices 40 such that interference aggregation to a predetermined protection point of the communication system 1 (received interference amount I₁+I₂+I₃ illustrated in FIG. 1) would not exceed the interference margin I_{accept}. For example, the communication control device allocates the interference margin I_{accept} to each of the base station devices 40 such that the interfering amounts I₁, I₂, and I₃ become I_{accept}/3, individually. Alternatively, the communication control device allocates the interference margin I_{accept} to each base station device 40 such that the interfering amounts I₁, I₂, and I₃ become I_{accept}/3 or less, individually. Note that the method of allocating the interference margin is not limited to this example.

The communication control device calculates the maximum transmission power acceptable for each of the base station devices 40 (hereinafter, referred to as maximum allowable transmission power) based on the interference amount that is allocated (hereinafter, referred to as an allocated interference amount). For example, the communication control device calculates the maximum allowable transmission power of each of the base station devices 40 by calculating back from the allocated interference amount based on the propagation loss, the antenna gain, and the like. Subsequently, the communication control device notifies each of the base station devices 40 of information of the calculated maximum allowable transmission power.

<1-2. Outline of Present Embodiment>

The citizens broadband radio service (CBRS) established by the Federal Communications Commission (FCC) in the US approves leasing of the license to spectrum use based on a Priority Access License (PAL). In addition, according to Public consultation (https://www.ofcom.org.uk/consultations-and-statements/category-1/enabling-opportunities-for-innovation) published by Office of Communications (Ofcom) in the UK, it has become clear that local spectrum licensing is being examined in the UK.

Here, an interference margin allocation algorithm of sequential allocation process (iterative allocation process (IAP)) is defined as a method for protecting non-federal incumbents and priority access users from interference from lower-tier users in CBRS.

The sequential allocation process performs processing on all grants with no prioritization. However, for example, for the following reasons (1), (2), and the like, it is not always appropriate to allocate the interference margin to all grants with no prioritization.

(1) Presence of Priority Access Tier and GAA Tier

The Priority Access Tier needs to acquire a license (PAL) through an auction and bears more investment cost related to the spectrum use compared to the GAA Tier, and thus, equally handling the PAL grant and the GAA grant is not considered to be appropriate.

(2) Presence of Various Use Cases

There is an anticipation that the CBRS will utilize 5G, which is highly expected as a communication method for realizing various use cases. However, depending on uses cases, there might be a difference in parameters such as required transmission power, required quality of service (QoS), and coverage between use cases, making it inappropriate to handle all grants equally.

Considering this situation, it is desirable to provide an information processing device capable of appropriately allocating a suitable interference margin. Here, the information processing device that allocates the interference margin may be a spectrum management server such as a spectrum access system (SAS). The spectrum management server is a communication control device in the present embodiment.

In the present embodiment, the communication control device being an information processing device executes the following processing. Specifically, the communication control device first acquires information regarding each of a plurality of second radio systems (for example, secondary systems) that perform shared use of radio waves used by a first radio system (for example, a primary system). Examples of information to be acquired include information regarding the hierarchy of the CBRS, communication-related parameter information such as required transmission power, required QoS, and coverage according to a use case, and the like.

Subsequently, the communication control device calculates the allocation priority for each of the second radio systems based on the acquired information. For example, the communication control device performs calculations such that the higher the hierarchy of the second radio system in CBRS, the higher the allocation priority to be given. Subsequently, the communication control device allocates a total interference amount allowed by the first radio system to each of the plurality of second radio systems as an interference amount based on the calculated allocation priority.

This makes it possible, for example, to increase the interfering amount for the Priority Access Tier in the CBRS to be greater than that for the GAA tier. Therefore, with the communication control device according to the present embodiment, it is possible to appropriately allocate the interference margin (interference amount).

<1-3. Terms Related to Spectrum and Sharing>

Following the outline of the present embodiment described above, details of the present embodiment will be described below. Before describing the present embodiment in detail, terms related to spectrum and sharing used in the present embodiment will be clearly defined.

The present embodiment assumes that the primary system (for example, the communication system 1) and the secondary system (for example, the communication system 2) are in an environment of dynamic spectrum sharing (Dynamic Spectrum Access (DSA)). Hereinafter, terms related to spectrum and sharing will be described by using a Citizens Broadband Radio Service (CBRS) established by the United States Federal Communications Commission (FCC), as an example. Note that the communication system 1 and the communication system 2 of the present embodiment are not limited to systems in the CBRS.

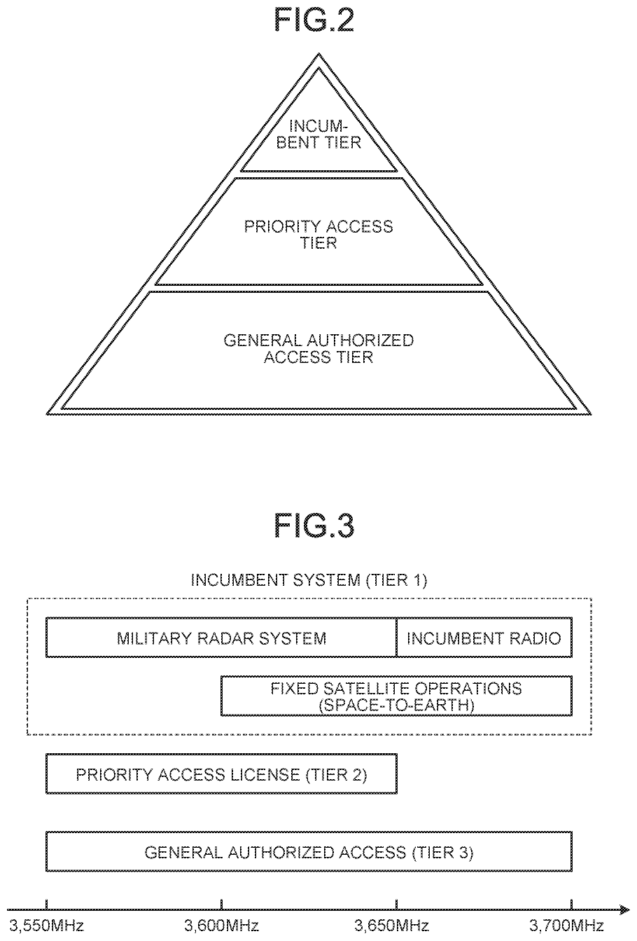

FIG. 2 is a diagram illustrating a hierarchical structure in the CBRS. As illustrated in FIG. 2, each of users in a shared frequency band is classified into one of three groups. This group is referred to as a “tier”. The three groups are referred to as an Incumbent Tier, a Priority Access Tier, and a General Authorized Access Tier. In the example of FIG. 2, the Priority Access Tier is located above the General Authorized Access Tier, and the Incumbent Tier is located above the Priority Access Tier. Using the CBRS as an example, a system located in the Incumbent Tier (incumbent system) is a primary system, and systems located in the General Authorized Access Tier and the Priority Access Tier are secondary systems, for example.

The Incumbent Tier is a group including incumbent users who conventionally use a frequency band defined as a shared frequency band. The incumbent user may be referred to as a primary user. The incumbent users defined in the CBRS include: the Department of Defense (DOD), fixed satellite service operators, and Grandfathered Wireless Broadband Licensees (GWBL). The Incumbent Tier is not required to avoid or suppress interference to lower priority tiers, namely, the Priority Access Tier and the General Authorized Access Tier (GAA Tier). In addition, the Incumbent Tier is protected against the interference from the Priority Access Tier and the General Authorized Access Tier (GAA Tier). That is, the user of the “Incumbent Tier” can use the frequency band without considering the presence of other groups.

The Priority Access Tier is a group of users who utilizes the above-described shared frequency band based on a license referred to as a Priority Access License (PAL). A user who uses the above-described shared frequency band may be referred to as a secondary user. In spectrum sharing in the Priority Access tier, the Priority Access Tier is required to avoid or suppress interference to a higher priority tier, namely, the Incumbent Tier, but is not required to avoid or suppress interference to the lower priority tier, namely, the General Authorized Access Tier (GAA Tier). In addition, the Priority Access Tier is not protected against the interference from the higher priority tier, namely, the Incumbent Tier, but is protected against the interference from the lower priority tier, namely, the General Authorized Access Tier (GAA Tier).

The General Authorized Access Tier (GAA Tier) is a group of the other users, that is, users not belonging to any of the Incumbent Tier or the Priority Access Tier. Users at this tier may also be referred to as secondary users. However, this tier may be referred to as a low priority secondary user because its priority of shared use is lower than that of the Priority Access Tier. In the shared use of spectrum in the General Authorized Access Tier (GAA Tier), it is required to avoid or suppress interference to the Incumbent Tier and the Priority Access Tier, which have higher priority. In addition, the General Authorized Access Tier (GAA Tier) is not protected against the interference from the higher priority tiers, namely, the Incumbent Tier and the Priority Access Tier. That is, the General Authorized Access Tier (GAA Tier) corresponds to a “tier” that is legislatively required to allow opportunistic shared use of spectrum.

The hierarchical structure is not limited to these definitions. Typically, the CBRS is a three-tier structure, but may be a two-tier structure. Typical examples of this include two-tier structures such as Licensed Shared Access (LSA) and TV band White Space (TVWS). The LSA has employed a structure equivalent to a combination of the Incumbent Tier and the Priority Access Tier. In addition, the TVWS has employed a structure equivalent to a combination of the Incumbent Tier and the General Authorized Access Tier (GAA Tier). In addition, there may be four or more tiers. Specifically, for example, an intermediate tier corresponding to the Priority Access Tier may be further prioritized. In addition, for example, the General Authorized Access Tier (GAA Tier) may be similarly prioritized.

FIG. 3 is a diagram illustrating CBRS bands. In the CBRS described above as an example, the primary system is a military radar system, a grandfathered wireless system, or a fixed satellite service (space-to-earth). Here, the military radar system is typically an in-ship radar. In addition, the secondary system is a radio network system including base stations and terminals referred to as a Citizens Broadband Radio Service Device (CBSD) and an End User Device (EUD), respectively. The secondary system is further prioritized into levels, namely, as a Priority Access License (PAL) for which a shared band can be licensed and a General Authorized Access (GAA) equivalent to unlicensed access. The Tier 1 illustrated in FIG. 3 corresponds to the Incumbent Tier illustrated in FIG. 2. The Tier 2 illustrated in FIG. 3 corresponds to the Priority Access Tier illustrated in FIG. 2. The Tier 3 illustrated in FIG. 3 corresponds to the General Authorized Access Tier illustrated in FIG. 2.

Note that the primary system and the secondary system are not limited to the above examples. For example, a radio system included in the Priority Access Tier may be regarded as a primary system, and a system included in a General Authorized Access Tier (GAA Tier) may be regarded as a secondary system.

In addition, the primary system (communication system 1) of the present embodiment is not limited to the example illustrated in FIG. 3. Other types of radio system may be used as the primary system (communication system 1). Examples of the primary system include radio systems such as a TV broadcast, a fixed microwave line (Fixed System (FS)), a meteorological radar, a radio altimeter, a communications-based train control, and radio astronomy. In addition, the primary system may be a television broadcasting system such as a Digital Video Broadcasting-Terrestrial (DVB-T) system or a cellular communication system such as Long Term Evolution (LTE) or New Radio (NR). The primary system may also be an aeronautical radio system such as an Aeronautical Radio Navigation Service (ARNS). Note that the primary system is not limited to the above radio system, and may be other types of radio system. Other radio systems may be set as the primary system according to the country, region, and frequency band to be applied.

Furthermore, an unused radio spectrum (white space) used by the communication system 2 is not limited to the radio wave of the Federal use band (3.55-3.70 GHz). The communication system 2 may use a radio wave in a frequency band different from the Federal use band (3.55-3.70 GHz) as an unused radio spectrum. For example, when the primary system (communication system 1) is a television broadcasting system, the communication system 2 may be a system that uses a TV white space as an unused radio spectrum. Here, the TV white space refers to a frequency band that is not currently used by the television broadcasting system among frequency channels allocated to the television broadcasting system (primary system). At this time, the TV white space may be a channel that is not currently used according to the area.

The relationship between the communication system 1 and the communication system 2 is not limited to the spectrum sharing relationship in which the communication system 1 is a primary system and the communication system 2 is a secondary system. The relationship between the communication system 1 and the communication system 2 may be a network coexistence relationship between the same or different radio systems using the same spectrum.

In addition, application of the present embodiment is not limited to the spectrum sharing environment. As terms used in general regarding spectrum sharing or secondary use of the spectrum, an incumbent system using a target band is referred to as a primary system, and a system of a secondary user is referred to as a secondary system. However, in a case where the present embodiment is applied to an environment other than the spectrum sharing environment, these systems (primary system and secondary system) may be replaced with a system with different terms. For example, a macro cell base station in a heterogeneous network (HetNet) may be defined as a primary system, and a small cell or a relay station may be defined as a secondary system. In addition, the base station may be defined as a primary system, and a relay UE or a vehicle UE implementing D2D or V2X present in its coverage may be defined as a secondary system. The base station is not limited to a fixed type, and may be a portable/mobile type. In such a case, for example, the communication control device provided by the present invention may be included in a core network, a base station, a relay station, a relay UE, or the like.

In the present disclosure, the term “frequency” or “spectrum” may be replaced with other terms. For example, the term “frequency” or “spectrum” may be replaced with terms such as “resource”, “resource block”, “resource element”, “resource pool”, “channel”, “component carrier”, “Bandwidth Part (BWP)”, “carrier”, “subcarrier”, “Bandwidth Part (BWP)”, and “beam”, or terms having equivalent or similar meanings.

### 2. Configuration of Communication System

Hereinafter, a communication system 1000 according to an embodiment of the present disclosure will be described. The communication system 1000 includes a communication system 1 and a communication system 2. The communication system 1 (first radio system) is a radio communication system that conducts radio communication using a predetermined frequency band (primary use). The communication system 2 (second radio system) is a radio communication system that conducts radio communication by performing secondary use of a frequency band used by the communication system 1. For example, the communication system 2 is a radio communication system that performs dynamic spectrum sharing of an unused radio spectrum of the communication system 1. The communication system 2 provides a radio service to a user or a device owned by the user by utilizing a predetermined radio access technology.

The communication systems 1 and 2 may be cellular communication systems such as wideband code division multiple access (W-CDMA), code division multiple access 2000 (cdma2000), LTE, NR, and the like. In the following, “LTE” shall include LTE-advanced (LTE-A), LTE-advanced pro (LTE-A Pro), and evolved universal terrestrial radio access (EUTRA). In addition, “NR” shall include new radio access technology (NRAT) and further EUTRA (FEUTRA).

NR is a radio access technology (RAT) as next generation (fifth generation) following LTE. The NR is a radio access technology that can support various use cases including enhanced mobile broadband (eMBB), massive machine type communications (mMTC), and Ultra-Reliable and Low Latency Communications (URLLC).

Note that the communication systems 1 and 2 are not limited to the cellular communication systems. For example, the communication system 2 may be other radio communication systems such as a wireless local area network (wireless LAN) system, a television broadcasting system, an aeronautical radio system, or a space radio communication system.

In the present embodiment, it is defined that the communication system 1 is a primary system, and the communication system 2 is a secondary system. As described above, the communication system 1 and the communication system 2 may each be provided in plurality. Although the example of FIG. 1 is a case where the communication system 1 includes one radio wave utilization device 10 (radio wave utilization device 10₁ illustrated in FIG. 1), the communication system 1 may include a plurality of radio wave utilization devices 10 as described above. The configuration of the radio wave utilization device 10 may be the same as or different from the configuration of a base station device 40 or a terminal device 30 described below.

<2-1. Overall Configuration of Communication System>

The communication system 1000 typically includes the following entities.

Communication devices (for example, a radio wave utilization device, a base station device, or an intermediate device)

Terminal device

Management device (for example, communication control device)

The following description is a case where the entities working as the communication devices are assumed to be the radio wave utilization device 10, the base station device 40, and an intermediate device 50. However, the entities working as the communication devices are not limited to these devices, and may be other communication devices (for example, a management device 20, the terminal device 30, and the communication control device 60). For example, an external device to be described below may be regarded as a part of the communication system 1000. Note that the external device need not be a part of the communication system 1000. Furthermore, the terminal device 30 may be regarded as an external device.

In the present embodiment, unless otherwise noted, the terminal device 30 and the base station device 40 are entities constituting the secondary system that shares a part or all of a frequency band allocated to the primary system. The present embodiment assumes that there are two different types of communication devices in these communication devices constituting the secondary system.

First, a communication device that can access the communication control device 60 without using a wireless path involving permission of the communication control device 60 is referred to as a “communication device (Type A)”. Specifically, for example, a communication device capable of wired Internet connection can be regarded as the “communication device (Type A)”. In addition, for example, even in the case of a wireless relay device having no wired Internet connection function, the wireless relay device may be regarded as a “communication device (Type A)” when a radio backhaul link using a spectrum that does not require the permission of the communication control device 60 is constructed with another communication device (Type A).

Furthermore, a communication device that cannot access the communication control device 60 without a wireless path involving the permission of the communication control device 60 is referred to as a “communication device (Type B)”. For example, a wireless relay device that needs to construct a backhaul link using a spectrum that requires permission of the communication control device 60 can be regarded as the “communication device (Type B)”. Furthermore, for example, it is allowable to handle a terminal device such as a smartphone having a wireless network providing function represented by tethering and using a spectrum that requires permission of the communication control device 60 for both the backhaul link and the access link, as the “communication device (Type B)”.

The communication device is not necessarily fixedly installed, and may be installed in a moving object such as an automobile. Furthermore, the communication device does not necessarily need to exist on the ground, and the communication device function may be provided on an object existing in the air or space, such as an aircraft, a drone, a helicopter, or a satellite, or on an object existing on the sea or under the sea, such as a ship or a submarine. Typically, such a mobile communication device corresponds to the communication device (Type B), and performs wireless communication with another communication device (Type A), thereby ensuring an access route to the communication control device. As a matter of course, even a mobile communication device can be handled as the communication device (Type A) as long as the frequency/spectrum used in the wireless communication with the communication device (Type A) is not managed by the communication control device.

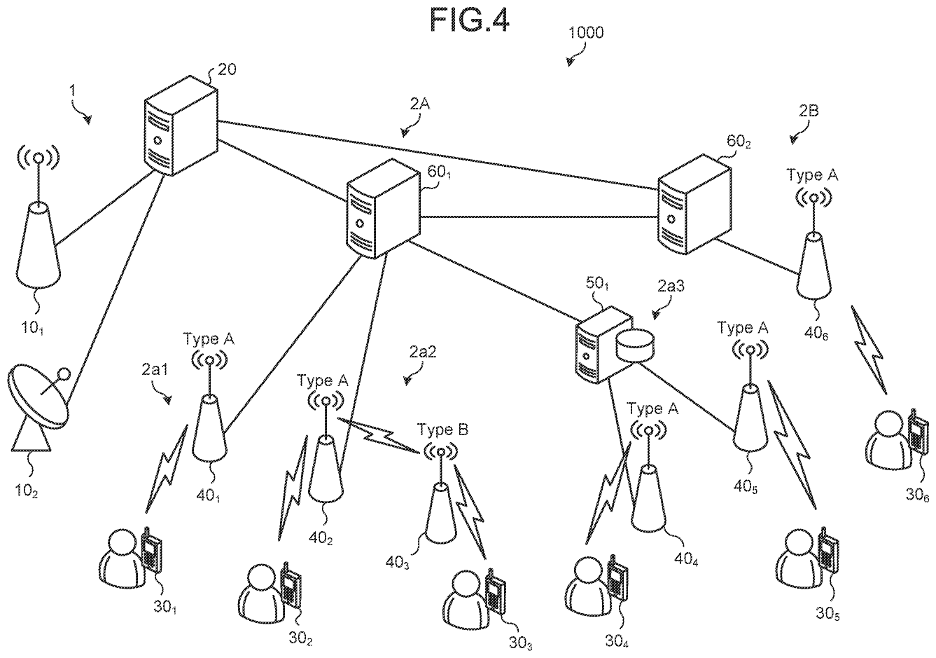

FIG. 4 is a diagram illustrating a configuration example of a communication system 1000 according to an embodiment of the present disclosure. As described above, the communication system 1000 includes the communication system 1 and the communication system 2. Note that the device in the figure can also be considered as a device in a logical sense. That is, parts of the device in the drawing may be partially actualized by a virtual machine (VM), a container, a docker, or the like, and they may be implemented on physically the same hardware.

The communication system 1 includes the radio wave utilization device 10 and the management device 20. In the example of FIG. 4, the communication system 1 includes the radio wave utilization devices 10₁ and 10₂ and the management device 20 that manages the radio wave utilization devices 10₁ and 10₂. Note that the communication system 1 does not necessarily have to include the management device 20. Furthermore, the communication system 1 may include a plurality of radio wave utilization devices 10 or may include only one radio wave utilization device 10. In the example of FIG. 4, each of the radio wave utilization devices 10₁ and 10₂ can be regarded as one communication system 1.

The communication system 2 includes the terminal device 30, the base station device 40, the intermediate device 50, and the communication control device 60. In the example of FIG. 4, the communication system 2 is described as a communication system 2A and a communication system 2B. The communication system 2A includes a communication system 2a1, a communication system 2a2, and a communication system 2a3.

The communication system 2a1 includes a terminal device 30₁ and a base station device 40₁. The communication system 2a2 includes terminal devices 30₂ and 30₃ and base station devices 40₂ and 40₃. The communication system 2a3 includes terminal devices 30₄ and 30₅, base station devices 40₄ and 40₅, and an intermediate device 50₁. The communication system 2B includes a terminal device 30₆ and a base station device 40₆. In the example of FIG. 4, the base station devices 40₁ and 40₂ as well as 40₄ to 40₆ are communication devices (Type A), and the base station device 40₃ is a communication device (Type B).

Note that the communication system 2 does not necessarily have to include the communication control device 60. To describe by using the example of FIG. 4, each of the communication system 2a2 and the communication system 2a3 having an external communication control device 60 may be regarded as one communication system 2. Furthermore, the communication system 2 does not necessarily have to include the intermediate device 50. In the example of FIG. 4, the communication system 2a1 without the intermediate device 50 may be regarded as one communication system 2.

With cooperative operations of the devices (for example, communication devices such as radio communication devices) constituting the communication systems 1 and 2, the communication systems 1 and 2 provide radio services to a user or a device possessed by the user. The radio communication device is a device having a function of radio communication. In the example of FIG. 4, the radio communication device corresponds to the radio wave utilization device 10, the base station device 40, and the terminal device 30.

Note that the intermediate device 50 and the communication control device 60 may have a wireless communication function. In this case, the intermediate device 50 and the communication control device 60 can also be regarded as radio communication devices. In the following description, a radio communication device may be simply referred to as a communication device. The communication device is not limited to a radio communication device, and for example, a device capable of wired communication alone and not equipped with a wireless communication function can also be regarded as a communication device.

In the present embodiment, the concept of the “communication device” includes not only a portable mobile device (for example, a terminal device) such as a mobile terminal but also a device installed in a structure or a mobile body. The structure or a mobile body itself may be regarded as a communication device. In addition, the concept of the communication device includes not only a terminal device but also a base station device and a relay device. The communication device is a type of processing device and information processing device. The description of the “communication device” in the following description can be appropriately rephrased as a “transmission device” or a “reception device”. In the present embodiment, the concept of “communication” shall include “broadcasting”. In this case, the description of the “communication device” can be appropriately rephrased as a “broadcasting device”. Accordingly, the description of the “communication device” may be appropriately rephrased as a “transmission device” or a “reception device”.

The communication system 2 may include a plurality of the terminal devices 30, a plurality of the base station devices 40, a plurality of the communication control devices 60, and a plurality of the intermediate devices 50. In the example of FIG. 4, the communication system 2 includes terminal devices 30₁, 30₂, 30₃, 30₄, 30₅, and the like as the terminal device 30. The communication system 2 includes base station devices 40₁, 40₂, 40₃, 40₄, 40₅, 40₆, and the like as the base station device 40. The communication system 2 includes communication control devices 60₁, 60₂, and the like as the communication control device 60.

In the following description, a radio communication device may be referred to as a radio system. For example, each of the terminal devices 30₁ to 30₅ is one radio system. In addition, each of the radio wave utilization device 10 and the base station devices 40₁ to 40₆ is one radio system. In the following description, the communication system 1 is referred to as a first radio system. However, each of one or a plurality of radio wave utilization devices 10 included in the communication system 1 may be regarded as the first radio system. In the following description, each of one or a plurality of base station devices 40 included in the communication system 2 is referred to as a second radio system. However, the communication system 2 itself may be regarded as a second radio system, or each of one or the plurality of terminal devices 30 included in the communication system 2 may be regarded as a second radio system. When the intermediate device 50 and the communication control device 60 have a wireless communication function, each of the intermediate devices 50 or each of the communication control devices 60 may be regarded as the second radio system.

Note that the radio system may be one system including a plurality of communication devices including at least one radio communication device. For example, a system including one or a plurality of base station devices 40 and one or a plurality of terminal devices 30 under the base station devices 40 may be regarded as one radio system. Furthermore, the communication system 1 and the communication system 2 can each be regarded as one radio system. In the following description, a communication system including a plurality of communication devices including at least one radio communication device may be referred to as a radio communication system or simply as a communication system. Note that one system including a plurality of communication devices including one radio communication device may be regarded as the first radio system or the second radio system.

In the present embodiment, a system represents a set of a plurality of components (devices, modules (components), or the like). At this time, all the components constituting the system may be or need not be in the same housing. For example, a plurality of devices housed in separate housings and connected by wired and/or wireless connection is defined as one system. In addition, one device having a plurality of modules housed in one housing is also one system.

(Radio Wave Utilization Device)

The radio wave utilization device 10 is a radio communication device constituting the communication system 1 (primary system). The radio wave utilization device 10 may be a radio wave emission device such as a radar or a reflected wave reception device. As described above, the primary system is, for example, a military radar system, an incumbent system (for example, a television broadcasting system or an incumbent cellular communication system), or a fixed satellite service system.

When the communication system 1 is a military radar system, the radio wave utilization device 10 is an in-ship radar, for example. When the communication system 1 is a television broadcasting system, the radio wave utilization device 10 is a broadcasting station (broadcasting station as a facility) such as a broadcasting relay station, for example. When the communication system 1 is a fixed satellite service system, the radio wave utilization device 10 is a parabolic antenna that receives radio waves from an artificial satellite, for example. Note that the radio wave utilization device 10 is not limited to these devices. For example, when the communication system 1 is an incumbent cellular communication system, the radio wave utilization device 10 may be a base station device.

Similarly to the base station device 40 to be described below, the radio wave utilization device 10 may be capable of communicating with other communication devices using a radio access technology. Note that the radio access technology used by the radio wave utilization device 10 may be a cellular communication technology or a wireless LAN technology. Note that the radio access technology used by the base station device 40 is not limited thereto, and may be other radio access technologies. For example, the radio access technology used by the radio wave utilization device 10 may be a low power wide area (LPWA) communication technology. Here, the LPWA communication is communication conforming to the LPWA standard. Examples of the LPWA standard include ELTRES, ZETA, SIGFOX, LoRaWAN, and NB-IoT. Naturally, the LPWA standard is not to be limited thereto, and may be other LPWA standards. In addition, the radio communication used by the radio wave utilization device 10 may be radio communication using millimeter waves. Furthermore, the radio communication used by the radio wave utilization device 10 may be radio communication using radio waves or wireless communication (optical wireless communication) using infrared rays or visible light.

In addition, the configuration of the radio wave utilization device 10 may be similar to the configuration of the terminal device 30 or the base station device 40 described below.

(Management Device)

The management device 20 is a device that manages the radio wave utilization device 10. For example, the management device 20 is a server or a database owned by an operator or an administrator of the communication system 1.

The management device 20 may be a server or a database owned by a public organization. For example, the management device 20 may be a database (for example, a regulatory database) managed and operated by a national or regional radio administration agency. Examples of the regulatory database include Universal Licensing System (ULS) operated by Federal Communications Commissions (FCC).

In addition, when the communication system 1 is an incumbent cellular communication system, the management device 20 may be a device that manages a radio network. For example, the management device 20 may be a device that functions as a Mobility Management Entity (MME), an Access and Mobility Management Function (AMF), or a Session Management Function (SMF).

When the communication system 2 constitutes a network including the radio wave utilization device 10 as one of nodes, the management device 20 may be a network manager that integrally controls the radio wave utilization device 10 in the network, for example.

Note that the management device 20 is not limited to these examples. The radio wave utilization device 10 may have the function of the management device 20. In this case, the radio wave utilization device 10 can be regarded as the management device 20.

In addition, the management device 20 may have a function of a communication control device. In this case, the management device 20 can be regarded as the communication control device 60.

(Terminal Device)

The terminal device 30 is a communication device having a communication function. The terminal device 30 is typically a communication device such as a smartphone. The terminal device 30 may be a user terminal such as a mobile phone, a smart device (smartphone or tablet), a wearable terminal, an Internet of Things (IoT) device, a personal digital assistant (PDA), or a personal computer. Furthermore, the terminal device 30 may be a business camera equipped with a communication function, or may be a communication device such as a radio relay transmission device (field pickup unit (FPU)) for television broadcasting. Furthermore, the terminal device 30 may be a motorcycle, a moving relay vehicle, or the like, equipped with a communication device such as the field pickup unit (FPU). In addition, a device called customer premises equipment (CPE) provided to ensure Internet connection may behave as a terminal. The terminal device 30 may be a machine to machine (M2M) device or an Internet of Things (IoT) device. The terminal device may be referred to as User Equipment, User Terminal, User Station, Mobile Terminal, Mobile Station, or the like. Furthermore, the terminal device 30 may also be referred to as MTC UE, NB-IoT UE, or Cat.M UE, for example.

Furthermore, the terminal device 30 may be capable of sidelink communication with another terminal device 30. When performing sidelink communication, the terminal device 30 may be able to use an automatic retransmission technology such as hybrid automatic repeat request (Hybrid ARQ (HARQ)). The radio communication (including sidelink communication) used by the terminal device 30 may be radio communication using radio waves or wireless communication (optical wireless communication) using infrared rays or visible light.

Furthermore, the terminal device 30 may be a mobile device. Here, the mobile device is a movable radio communication device. At this time, the terminal device 30 may be a radio communication device installed on a mobile body, or may be the mobile body itself. For example, the terminal device 30 may be a vehicle that moves on a road, such as an automobile, a bus, a truck, or a motorbike, or may be a radio communication device mounted on the vehicle. The mobile body may be a mobile terminal, or may be a mobile body that moves on land (on the ground in a narrow sense), in the ground, on water, or under water. Furthermore, the mobile body may be a mobile body that moves inside the atmosphere, such as a drone or a helicopter, or may be a mobile body that moves outside the atmosphere, such as an artificial satellite.

The terminal device 30 may perform communication while being simultaneously connected to a plurality of base station devices or a plurality of cells. For example, when one base station device supports a communication area via a plurality of cells (for example, pCell and sCell), it is possible to bundle the plurality of cells and communicate between the base station device 40 and the terminal device 30 by using a carrier aggregation (CA) technology, a dual connectivity (DC) technology, or a multi-connectivity (MC) technology. Alternatively, the terminal device 30 and the plurality of base station devices 40 can communicate with each other by a Coordinated Multi-Point Transmission and Reception (CoMP) technology via cells of different base station devices 40.

Note that the terminal device 30 does not need to be used by a person. The terminal device 30 may be a sensor installed in a machine or a building of a factory, such as a sensor used for communication referred to as machine type communication (MTC). The terminal device 30 may be a machine to machine (M2M) device or an Internet of Things (IoT) device. Furthermore, the terminal device 30 may be a device having a relay communication function as represented by Device to Device (D2D) and Vehicle to everything (V2X). Furthermore, the terminal device 30 may be a device referred to as Customer Premises Equipment (CPE) used in a radio backhaul or the like. Furthermore, the terminal device 30 may be a radio communication device installed on a mobile body, or may be the mobile body itself.

In the present embodiment, unless otherwise noted, the terminal device 30 corresponds to an entity that terminates a radio link using the spectrum that requires permission of the communication control device 60. However, the terminal device 30 can perform an operation equivalent to that of the communication device depending on a function included in the terminal device 30 or a network topology to be applied. In other words, at implementation of the technology disclosed in the present embodiment, the communication device may be referred to as a terminal device or the terminal device may be referred to as a communication device, depending on the network topology.

(Base Station Device)

The base station device 40 (second radio system) is a radio communication device that performs radio communication with the terminal device 30 or other communication devices (other base station devices 40 or other intermediate devices 50). For example, the base station device 40 is a radio device that provides communication services to terminals. The base station device 40 is a type of communication device. The base station device 40 is, for example, a device corresponding to a radio base station (Base Station, Node B, eNB, gNB, etc.) or a radio access point. When the base station device 40 is a radio access point, the base station device 40 may be referred to as non-3GPP access. The base station device 40 may be a wireless relay station (Relay Node). Furthermore, the base station device 40 may be an on-road base station device such as a Road Side Unit (RSU). Furthermore, the base station device 40 may be an optical link device referred to as a Remote Radio Head (RRH). Furthermore, the base station device 40 may be a receiving station device such as a Field Pickup Unit (FPU). In addition, the base station device 40 may be an Integrated Access and Backhaul (IAB) donor node or an LAB relay node that provides a radio access channel and a radio backhaul channel by using time division multiplexing, frequency division multiplexing, or space division multiplexing.

Note that the radio access technology used by the base station device 40 may be a cellular communication technology or a wireless LAN technology. Note that the radio access technology used by the base station device 40 is not limited thereto, and may be other radio access technologies. For example, the radio access technology used by the base station device 40 may be a low power wide area (LPWA) communication technology. Here, the LPWA communication is communication conforming to the LPWA standard. Examples of the LPWA standard include ELTRES, ZETA, SIGFOX, LoRaWAN, and NB-IoT. Naturally, the LPWA standard is not to be limited thereto, and may be other LPWA standards. In addition, the radio communication used by the base station device 40 may be radio communication using millimeter waves. Furthermore, the radio communication used by the base station device 40 may be radio communication using radio waves or wireless communication (optical wireless communication) using infrared rays or visible light.

In the present embodiment, a base station of a radio communication system may be referred to as a base station device. Note that the radio access technology used by the base station device 40 may be a cellular communication technology or a wireless LAN technology. Note that the radio access technology used by the base station device 40 is not limited thereto, and may be other radio access technologies. Furthermore, the radio communication used by the base station device 40 may be radio communication using radio waves or wireless communication (optical wireless communication) using infrared rays or visible light.

The base station device 40 is not necessarily to be fixed, and may be installed in a moving object such as an automobile. Furthermore, the base station device 40 does not necessarily need to exist on the ground. The communication device function may be provided on an object existing in the air or space, such as an aircraft, a drone, a helicopter, or a satellite, or on an object existing on the sea or under the sea, such as a ship or a submarine. In such a case, the base station device 40 can perform radio communication with another fixedly installed communication device.

The concept of the base station device (also referred to as a base station) includes not only a donor base station but also a relay base station (also referred to as a relay station or a relay station device). The concept of a base station also includes an access point. Furthermore, a base station conceptually includes not only a structure having a function of a base station but also a device installed in the structure.

Examples of the structure include a building such as an office building, a house, a steel tower, a station facility, an airport facility, a port facility, or a stadium. A structure conceptually includes not only buildings but also non-building structures such as tunnels, bridges, dams, fences, and steel columns, as well as facilities such as cranes, gates, and windmills. In addition, a structure conceptually includes not only land-based (ground-based, in a narrow sense) structures or underground structures but also structures on the water, such as a jetty and a mega-float, and underwater structures such as an ocean observation facility.

The base station device 40 may be a donor station or a relay station. In a case where the base station device 40 is a relay station, there is no limitation regarding the device on which the base station device 40 is mounted as long as the function of relay is satisfied. For example, the base station device 40 may be mounted on a terminal device such as a smartphone, may be mounted on an automobile or a human-powered vehicle, may be mounted on a balloon, an airplane, or a drone, or on a home appliance such as a television, a game machine, an air conditioner, a refrigerator, or a lighting fixture. Naturally, these devices themselves may be regarded as the base station device 40.

The base station device 40 may be a fixed station or a mobile station. The mobile station is a radio communication device (for example, a base station device) configured to be movable. At this time, the base station device 40 may be a device installed on a mobile body, or may be the mobile body itself. For example, a relay station device having mobility can be regarded as the base station device 40 as a mobile station. In addition, a device designed to have mobility, such as a vehicle, a drone, or a smartphone, and having a function of a base station device (at least a part of the function of a base station device) also corresponds to the base station device 40 as a mobile station.

Here, the mobile body may be a mobile terminal such as a smartphone or a mobile phone. The mobile body may be a mobile body that moves on the land (ground in a narrow sense) (for example, a vehicle such as an automobile, a bicycle, a bus, a truck, a motorbike, a train, or a linear motor car), or a mobile body (for example, subway) that moves under the ground (for example, through a tunnel).

The mobile body may be a mobile body that moves on the water (for example, a ship such as a passenger ship, a cargo ship, and a hovercraft), or a mobile body that moves underwater (for example, a submersible ship such as a submersible boat, a submarine, or an unmanned submarine).

Furthermore, the mobile body may be a mobile body that moves in the atmosphere (for example, an aircraft (aerial vehicle) such as an airplane, an airship, or a drone), or may be a mobile body that moves outside the atmosphere (for example, an artificial astronomical object such as an artificial satellite, a spaceship, a space station, or a spacecraft). A mobile body moving outside the atmosphere can be rephrased as a space mobile body.

Furthermore, the base station device 40 may be a terrestrial base station device (ground station device) installed on the ground. For example, the base station device 40 may be a base station device arranged in a structure on the ground, or may be a base station device installed in a mobile body moving on the ground. More specifically, the base station device 40 may be an antenna installed in a structure such as a building and a signal processing device connected to the antenna. Note that the base station device 40 may be a structure or a mobile body itself. The “ground” represents not only a land (ground in a narrow sense) but also a ground or terrestrial in a broad sense including underground, above-water, and underwater.

Note that the base station device 40 is not limited to the terrestrial base station device. The base station device 40 may be a non-terrestrial base station device (non-terrestrial station device) capable of floating in the air or space. For example, the base station device 40 may be an aircraft station device or a satellite station device.

The aircraft station device is a radio communication device capable of floating in the atmosphere (including stratosphere), such as an aircraft. The aircraft station device may be a device mounted on an aircraft or the like, or may be an aircraft itself. The concept of the aircraft includes not only heavy aircraft such as an airplane and a glider but also light aircraft such as a balloon and an airship. In addition, the concept of an aircraft includes not only a heavy aircraft and a light aircraft but also a rotorcraft such as a helicopter and an auto-gyro. Note that the aircraft station device (or an aircraft on which an aircraft station device is mounted) may be an unmanned aerial vehicle such as a drone.

Note that the concept of the unmanned aerial vehicle also includes an unmanned aircraft system (UAS) and a tethered UAS. The concept of unmanned aerial vehicles also includes a Lighter-than-Air (LTA) unmanned aircraft system (UAS) and a Heavier-than-Air (HTA) unmanned aircraft system (UAS). Other concepts of unmanned aerial vehicles also include High Altitude Platforms (HAPs) unmanned aircraft system (UAS).

The satellite station device is a radio communication device capable of floating outside the atmosphere. The satellite station device may be a device mounted on a space mobile body such as an artificial satellite, or may be a space mobile body itself. The satellite serving as the satellite station device may be any of a low earth orbiting (LEO) satellite, a medium earth orbiting (MEO) satellite, a geostationary earth orbiting (GEO) satellite, or a highly elliptical orbiting (HEO) satellite. Accordingly, the satellite station device may be a device mounted on a low earth orbiting satellite, a medium earth orbiting satellite, a geostationary earth orbiting satellite, or a highly elliptical orbiting satellite.

As described above, the base station device 40 may be a relay station device. The relay station device is an aeronautical station or an earth station, for example. The relay station device can be regarded as a type of the above-described relay device. The aeronautical station is a radio station installed on the ground or a mobile body moving on the ground in order to communicate with an aircraft station device. Furthermore, the earth station is a radio station located on the earth (including air) in order to communicate with the satellite station device. The earth station may be a large earth station or a small earth station such as a very small aperture terminal (VSAT).

Note that the earth station may be a VSAT control earth station (also referred to as a master station or a HUB station) or may be a VSAT earth station (also referred to as a slave station). Furthermore, the earth station may be a radio station installed in a mobile body moving on the ground. Examples of an earth station mounted on a ship include Earth Stations on board Vessels (ESV). Furthermore, the earth station may include an aircraft earth station that is installed in an aircraft (including a helicopter) and that communicates with a satellite station. Furthermore, the earth station may include an aeronautical earth station that is installed on a mobile body moving on the ground and that communicates with the aircraft earth station via a satellite station. Note that the relay station device may be a mobile radio station that communicates with a satellite station or an aircraft station.

The coverage of the base station device 40 may be large such as a macro cell or small such as a pico cell. Needless to say, the coverage of the base station device 40 may be extremely small such as a femto cell. Various sizes are accepted for the coverage of the base station device 40. Note that one cell may be formed by a plurality of base station devices 40, such as the case of a distributed antenna system (DAS). Furthermore, the base station device 40 may have a beamforming capability. In this case, the base station device 40 may form a cell or a service area for each beam.

The base station device 40 can be utilized, operated, and/or managed by various entities. Assumable examples of the base station device 40 include a mobile network operator (MNO), a mobile virtual network operator (MVNO), a mobile network enabler (MNE), a mobile virtual network enabler (MVNE), a shared facility operator, a neutral host network (NHN) operator, a broadcaster, an enterprise, an educational institution (incorporated educational institutions, boards of education of local governments, and the like), a real estate (building, apartment, etc.) administrator, or an individual. Note that the subject of use, operation, and/or management of the base station device 40 is not limited thereto.

The base station device 40 may be installed and/or operated by one business operator, or may be installed and/or operated by one individual. Note that the installation/operation subject of the base station device 40 is not limited thereto. For example, the base station device 40 may be installed and operated by a plurality of business operators or a plurality of individuals in cooperation. Furthermore, the base station device 40 may be a shared facility used by a plurality of business operators or a plurality of individuals. In this case, installation and/or operation of the facility may be performed by a third party different from the user.

The base station device 40 operated by business operators is typically connected to the Internet via a core network. Furthermore, operation management and maintenance of the base station device 40 is performed by a function referred to as Operation, Administration & Maintenance (OA & M). Incidentally, the communication system 2 can include a network manager that integrally controls the base station device 40 in the network, for example.

In a case where the radio access technology used by the base station device 40 is a cellular communication technology, each of the plurality of base station devices 40 may form a cell. The cell provided by the base station device 40 is referred to as a serving cell, for example. The serving cell may include a primary cell (pCell) and a secondary cell (sCell). When the dual connectivity is provided to the UE (for example, the terminal device 30), the pCell and the sCell(s) provided by a master node (MN) are referred to as a master cell group. Examples of dual connectivity include EUTRA-EUTRA Dual Connectivity, EUTRA-NR Dual Connectivity (ENDC), EUTRA-NR Dual Connectivity with 5GC, NR-EUTRA Dual Connectivity (NEDC), and NR-NR Dual Connectivity.

Furthermore, the serving cell may include a Primary Secondary Cell or Primary SCG Cell (PSCell). That is, in a case where dual connectivity is provided to the UE, the PSCell and the sCell(s) provided by a secondary node (SN) are referred to as Secondary Cell Group (SCG).

One downlink component carrier and one uplink component carrier may be associated with one cell. In addition, the system bandwidth corresponding to one cell may be divided into a plurality of bandwidth parts (BWPs). In this case, one or a plurality of BWPs may be configured for the UE, and one BWP may be used for the UE as an active BWP. In addition, radio resources (for example, a frequency band, a numerology (subcarrier spacing), and a slot format (slot configuration)) usable by the terminal device 30 may be different for each cell, each component carrier, or each BWP. Furthermore, one base station device 40 may provide a plurality of cells.

(Intermediate Device)

The intermediate device 50 is a device that communicates with the communication control device 60 substituting (representing) one or a plurality of communication devices (for example, the base station device 40). For example, the intermediate device 50 is a proxy device (proxy system). The intermediate device 50 is also a type of communication device.

The intermediate device 50 may be a domain proxy (DP) defined in Non Patent Literature 2 and the like. Here, the DP refers to an entity that communicates with a communication control device such as SAS instead of each of a plurality of CBSDs, or an entity that communicates with a communication control device such as SAS instead of a network including a plurality of CBSDs. The intermediate device 50 is not limited to the DP defined in Non Patent Literature 2 as long as it has a function of communicating with the communication control device 60 substituting (representing) one or a plurality of communication devices. A network manager that integrally controls the base station device 40 in the network may be regarded as the intermediate device 50.

Note that the proxy system may include one device or may include a plurality of devices. Communication between the intermediate device 50 and the base station device 40 may be wired communication or wireless communication. Similarly, the communication between the intermediate device 50 and the communication control device 60 may be wired communication or wireless communication.

The communication device substituted (or represented) by the intermediate device 50 is not limited to the base station device 40, and may be the terminal device 30, for example. In the following description, one or a plurality of communication devices (for example, one or a plurality of base station devices 40) substituted (or represented) by the intermediate device 50 will sometimes be referred to as subordinate communication devices (for example, the subordinate base station device 40).

(Communication Control Device)

The communication control device 60 is a device that manages a communication device (for example, the base station device 40). For example, the communication control device 60 is a device that controls radio communication of the base station device 40. For example, the communication control device 60 is a device that determines communication parameters (also referred to as operational parameters) to be used by the base station device 40 and gives permission or an instruction to the base station device 40.

The communication control device 60 is, for example, a database server referred to as a TV white space database (TVWSDB), geolocation database (GLDB), spectrum access system (SAS), or automated frequency coordination (AFC). The communication control device 60 may be a network manager that integrally controls radio devices within the network. In an example of definition of ETSI EN 303 387 or IEEE 802.19.1-2018, the communication control device 60 may be a control device such as a Spectrum Manager/Coexistence Manager that performs radio wave interference control between radio devices. Furthermore, for example, a registered location secure server (RLSS) defined in IEEE 802.11-2016 can also work as the communication control device 60. In addition, under the spectrum sharing environment, a database (database server, device, and system) such as a geo-location database (GLDB) or a spectrum access system (SAS) can also work as the communication control device 60. Naturally, the communication control device 60 is not limited to these examples. The entity that performs determination and/or permission, instruction, and management of the communication parameters of the communication device related to spectrum sharing may be referred to as a communication control device. Basically, the communication control device 60 has the base station device 40 as a control target, but may also control the terminal device 30 under the base station device 40.

When the communication system 2 is a cellular communication system, the communication control device 60 may be a device constituting a core network. The core network CN is, for example, an evolved packet core (EPC) or a 5G core network (5GC). When the core network is the EPC, the communication control device 60 may be a device having a function as a mobility management entity (MME), for example. When the core network is a 5GC, the communication control device 60 may be a device having a function as an access and mobility management function (AMF) or a session management function (SMF), for example. Note that even when the communication system 2 is a cellular communication system, the communication control device 60 does not necessarily have to be a device constituting a core network. For example, the communication control device 60 may be a device having a function as a radio network controller (RNC).

Note that the communication control device 60 may have a function of a gateway. For example, when the core network is an EPC, the communication control device 60 may be a device having a function as a serving gateway (S-GW) or a packet data network gateway (P-GW). When the core network is a 5GC, the communication control device 60 may be a device having a function as a user plane function (UPF). Furthermore, the communication control device 60 may be an SMF, a PCF, a UDM, or the like. The core network CN may include an SMF, a PCF, a UDM, and the like.

Note that the communication control device 60 does not necessarily have to be a device constituting the core network. For example, it is assumed that the core network is a core network of Wideband Code Division Multiple Access (W-CDMA) or Code Division Multiple Access 2000 (cdma2000). At this time, the communication control device 60 may be a device that functions as a radio network controller (RNC).

The communication control device 60 may be connected to each of the plurality of base station devices 40. For example, in the case of 5GC, an N2 reference point exists between the AMF and the NG-RAN, and the AMF and the NG-RAN are logically connected to each other via an NG interface.

The communication control device 60 manages communication of the base station device 40. For example, the communication control device 60 may manage the location of the terminal device 30 for each terminal device 30 in units of areas (for example, tracking areas or RAN notification areas) including a plurality of cells. Note that the communication control device 60 may grasp and manage, for each terminal device 30, which base station device 40 (or which cell) the terminal device is connected to, in which base station device 40 (or which cell) the terminal device 30 exists in the communication area, and the like.

Basically, the communication control device 60 has the base station device 40 as a control target, but the communication control device 60 may also control the terminal device 30 under the base station device 40. Furthermore, the communication control device 60 may control a plurality of secondary systems. In this case, the communication system 2 can be regarded as a system including the plurality of secondary systems.

Furthermore, a plurality of communication control devices 60 may be present in one communication system 2. In a case where there is a plurality of communication control devices, at least one of the following three types of decision-making topologies can be applied to the communication control device 60.
Autonomous decision-making
Centralized decision-making Distributed decision-making

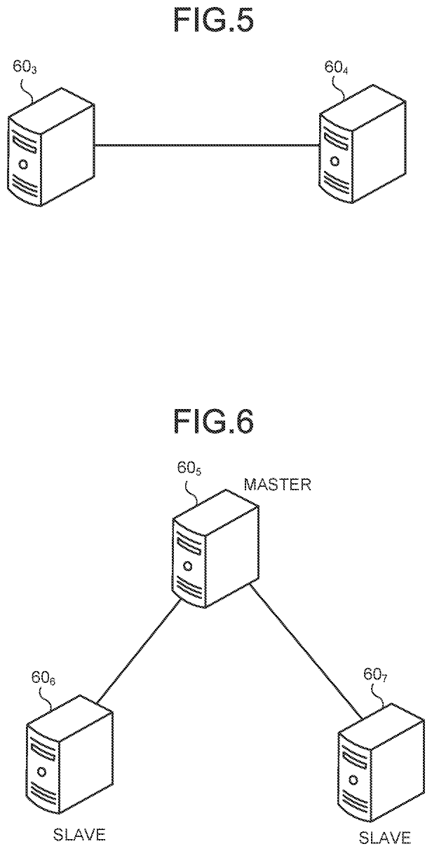

Autonomous decision-making is a decision-making topology in which an entity that makes a decision (decision-making entity; here, communication control device) makes a decision independently from another decision-making entity. The communication control device independently calculates necessary frequency allocation and interference control. FIG. 5 is a diagram illustrating a model in which the communication control device 60 is arranged in a distributed manner. The autonomous decision-making can be applied to a case, for example, where a plurality of communication control devices 60 is arranged in a distributed manner as illustrated in FIG. 5. In this case, the plurality of communication control devices 60 (the communication control device 60₃ and the communication control device 60₄ in the case of the example of FIG. 5) exchange information regarding their managed base station devices 40 with each other, and perform allocation of necessary spectrum and calculation of interference control.

Centralized decision-making is a decision-making topology in which a decision-making entity delegates decision-making to another decision-making entity. FIG. 6 is a diagram illustrating a model (referred to as a master-slave model) in which one communication control device centrally controls a plurality of communication control devices. In a case where middle-sized decision-making is performed, a model as illustrated in FIG. 6 is assumed, for example. In the example of FIG. 6, the communication control device 60₅ is a master communication control device, while the communication control devices 60₆ and 60₇ are slave communication control devices. In such a system, the master communication control device can control the plurality of slave communication control devices to collectively make a decision. In addition, the master communication control device can also perform delegation, discarding, and the like of the decision-making authority to each of the slave communication control devices for the purpose of load balancing and the like.

Distributed decision-making is a decision-making topology in which a decision-making entity makes a decision in cooperation with another decision-making entity. For example, in a case where a plurality of communication control devices is arranged as illustrated in FIG. 5, performing mutual adjustment, negotiation, and the like of decision-making results after each communication control device makes a decision can correspond to “distributed decision-making”. Furthermore, for example, in the model as illustrated in FIG. 6, dynamically conducting, by the master communication control device, delegation, discarding, and the like of the decision-making authority to each slave communication control device for the purpose of load balancing, and the like, can also be considered as “distributed decision-making”.

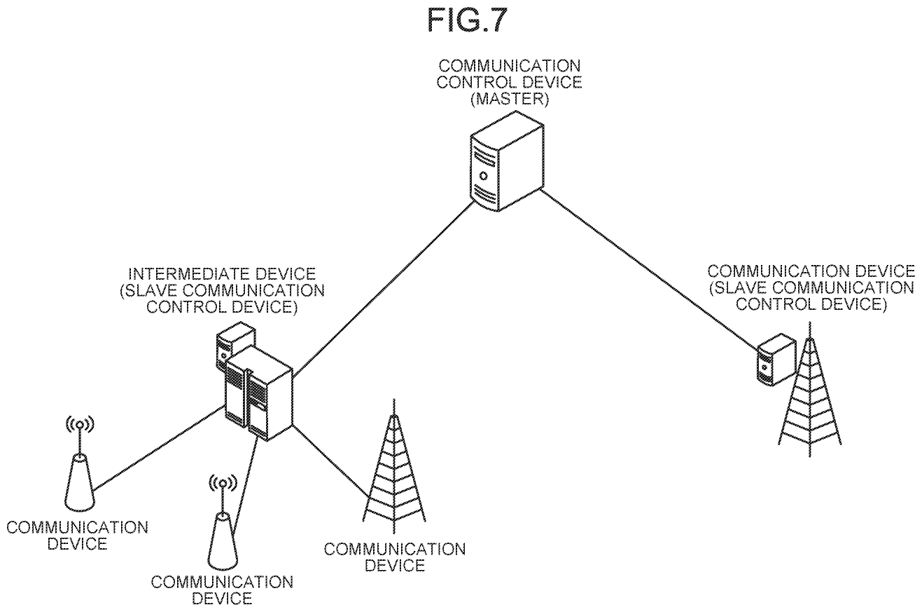

In a scenario that performs application of the centralized decision-making and distributed decision-making, implementation as illustrated in FIG. 7 is also possible as a modification. It is allowable to apply an implementation in which a master communication control device exists as an external device, and a communication device (for example, the base station device 40) or an intermediate device (for example, the intermediate device 50) that bundles a plurality of communication devices behaves as a slave communication control device.

Note that the communication control device 60 can also acquire necessary information from entities other than the base station device 40, the terminal device 30, and the intermediate device 50 for achieving its functions. Specifically, the communication control device 60 can acquire information necessary for protection, such as location information of the primary system, from a database (regulatory database) managed and operated by a national or regional radio administration agency (National Regulatory Authority (NRA)), for example. An example of the regulatory database is a Universal Licensing System (ULS) operated by the United States Federal Communications Commissions (FCC). Examples of information necessary for protection can include information such as location information regarding the primary system, communication parameters of the primary system, out-of-band emission (OOBE) limit, Adjacent Channel Leakage Ratio (ACLR), Adjacent Channel Selectivity, fading margin, and/or protection ratio (PR). For these examples, in a case where a fixed numerical value or an acquisition/derivation method is defined by a law or the like, it is desirable to use the defined values and methods.

Furthermore, as another example, it is also conceivable that the communication control device 60 acquires radio wave sensing information from a radio wave sensing system installed and operated for the purpose of radio wave detection in the primary system. As a specific example, the communication control device 60 can acquire radio wave detection information regarding the in-ship radar as the primary system from a radio wave sensing system referred to as an Environmental Sensing Capability (ESC) in CBRS of the United States. Furthermore, in a case where the communication device or the terminal has a sensing function, the communication control device 60 may acquire the radio wave detection information of the primary system from the communication device or the terminal.

Hereinafter, configurations of individual devices included in the communication system 1000, together with an external device, will be specifically described.

<2-2. Configuration of Radio Wave Utilization Device>

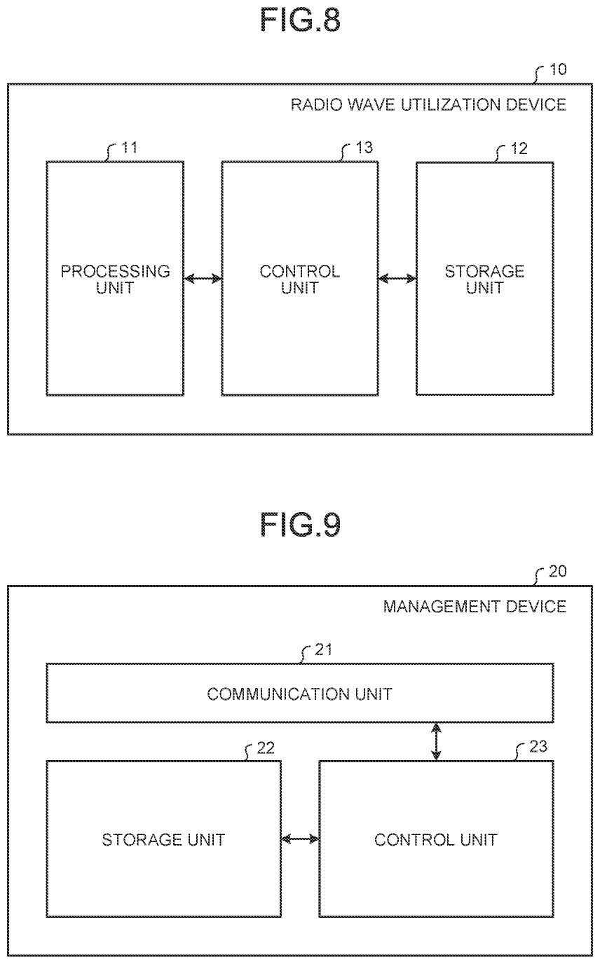

First, the configuration of the radio wave utilization device 10 will be described. FIG. 8 is a diagram illustrating a configuration example of the radio wave utilization device 10 according to an embodiment of the present disclosure. The radio wave utilization device 10 performs primary use of a predetermined frequency band. For example, the radio wave utilization device 10 is a communication device (radio system) that performs radio communication with other radio communication device(s). In this case, the radio wave utilization device 10 can be regarded as a type of communication device. Note that the radio wave utilization device 10 may be a radio wave emission device or a reflected wave reception device. The radio wave utilization device 10 is a type of information processing device.

The radio wave utilization device 10 includes a processing unit 11, a storage unit 12, and a control unit 13. Note that the configuration illustrated in FIG. 8 is a functional configuration, and the hardware configuration may be different from this. Furthermore, the functions of the radio wave utilization device 10 may be implemented in a distributed manner in a plurality of physically separated configurations.

The processing unit 11 is a processing unit for utilizing a radio wave in a predetermined frequency band. For example, the processing unit 11 is a signal processing unit that performs various processes for outputting and receiving a radio wave in a predetermined frequency band. When the radio wave utilization device 10 works as a radio communication device, the processing unit 11 may be a radio communication interface that performs radio communication with other communication device(s). Here, the other communication devices include not only communication devices that perform cellular communication and the like but also transmission devices that transmit broadcast waves, such as television broadcasting, and reception devices that receive broadcast waves.

The storage unit 12 is a data readable/writable storage device such as dynamic random access memory (DRAM), static random access memory (SRAM), a flash drive, or a hard disk. The storage unit 12 functions as a storage means in the radio wave utilization device 10.

The control unit 13 is a controller that controls individual components of the radio wave utilization device 10. The control unit 13 is actualized by a processor such as a central processing unit (CPU) or a micro processing unit (MPU), for example. For example, the control unit 13 is actualized by execution of various programs stored in the storage device inside the radio wave utilization device 10 by the processor using random access memory (RAM) or the like as a work area. Note that the control unit 13 may be actualized by an integrated circuit such as an application specific integrated circuit (ASIC) or a field programmable gate array (FPGA). The CPU, MPU, ASIC, and FPGA can all be regarded as controllers.

Note that the radio wave utilization device 10 may have a function as the management device 20. In this case, the control unit 13 may have individual functional blocks included in the control unit of the management device 20.

<2-3. Configuration of Management Device>

Next, a configuration of the management device 20 will be described. FIG. 9 is a diagram illustrating a configuration example of the management device 20 according to an embodiment of the present disclosure. The management device 20 is a device that manages the radio wave utilization device 10. The management device 20 may be a device that manages radio wave output of the radio wave utilization device 10, or may be a device that manages information such as an installation mode and a management subject of the radio wave utilization device 10. The management device 20 is a type of information processing device.

The management device 20 includes a communication unit 21, a storage unit 22, and a control unit 23. Note that the configuration illustrated in FIG. 8 is a functional configuration, and the hardware configuration may be different from this. Furthermore, the functions of the management device 20 may be implemented in a distributed manner in a plurality of physically separated configurations.

The communication unit 21 is a communication interface for communicating with other devices. The communication unit 21 may be a network interface or a device connection interface. For example, the communication unit 21 may be a local area network (LAN) interface such as a network interface card (NIC), or may be a universal serial bus (USB) interface including a USB host controller, a USB port, and the like. Furthermore, the communication unit 21 may be a wired interface or a wireless interface. The communication unit 21 functions as a communication means of the management device 20. The communication unit 21 communicates with the radio wave utilization device 10 under the control of the control unit 23.

The storage unit 22 is a data readable/writable storage device such as DRAM, SRAM, a flash drive, and a hard disk. The storage unit 22 functions as a storage means in the management device 20. The storage unit 22 stores the first identifier and the like. The first identifier will be described below.

The control unit 23 is a controller that controls individual parts of the management device 20. The control unit 23 is actualized by a processor such as a CPU or an MPU, for example. For example, the control unit 23 is actualized by the processor executing various programs stored in the storage device inside the management device 20 using RAM or the like as a work area. Note that the control unit 23 may be actualized by an integrated circuit such as an ASIC or an FPGA. The CPU, MPU, ASIC, and FPGA can all be regarded as controllers.

As described above, the radio wave utilization device 10 can be regarded as the management device 20. In this case, the description of “management device 20” in the following description can be appropriately replaced with “radio wave utilization device 10”.

<2-4. Configuration of Terminal Device>

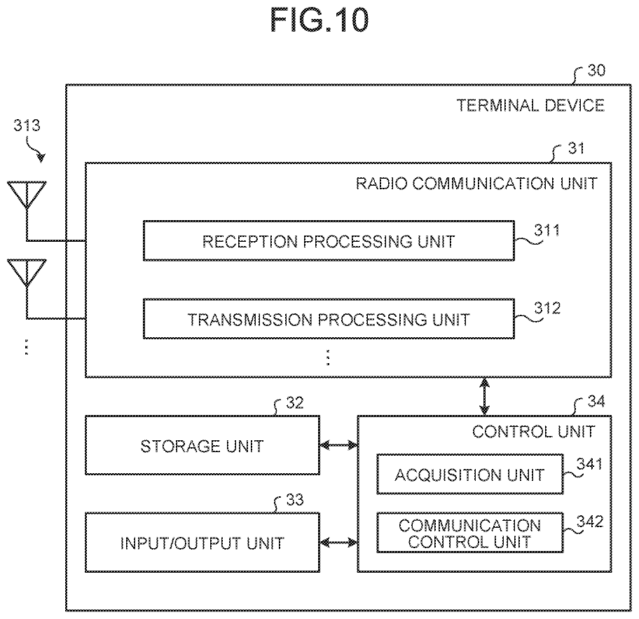

Next, a configuration of the terminal device 30 will be described. FIG. 10 is a diagram illustrating a configuration example of the terminal device 30 according to an embodiment of the present disclosure. The terminal device 30 is a communication device (radio system) that performs radio communication with the base station device 40 and/or the communication control device 60. The terminal device 30 is a type of information processing device.

The terminal device 30 includes a radio communication unit 31, a storage unit 32, an input/output unit 33, and a control unit 34. Note that the configuration illustrated in FIG. 10 is a functional configuration, and the hardware configuration may be different from this. Furthermore, the functions of the terminal device 30 may be implemented in a distributed manner in a plurality of physically separated configurations.

The radio communication unit 31 is a radio communication interface that performs radio communication with other communication devices (for example, the base station device 40 and other terminal device(s) 30). The radio communication unit 31 operates under the control of the control unit 34. The radio communication unit 31 may support one or a plurality of radio access methods. For example, the radio communication unit 31 supports both NR and LTE. The radio communication unit 31 may support other radio access methods such as W-CDMA and cdma2000.

The radio communication unit 31 includes a reception processing unit 311, a transmission processing unit 312, and an antenna 313. The radio communication unit 31 may include a plurality of the reception processing units 311, a plurality of the transmission processing units 312, and a plurality of the antennas 313. In a case where the radio communication unit 31 supports a plurality of radio access methods, individual portions of the radio communication unit 31 can be configured separately for each of the radio access methods. For example, the reception processing unit 311 and the transmission processing unit 312 may be individually configured depending on LTE and NR. The configurations of the reception processing unit 311 and the transmission processing unit 312 are similar to those of a reception processing unit 411 and a transmission processing unit 412 of the base station device 40.

The storage unit 32 is a data readable/writable storage device such as DRAM, SRAM, a flash drive, and a hard disk. The storage unit 32 functions as a storage means in the terminal device 30.

The input/output unit 33 is a user interface for exchanging information with the user. For example, the input/output unit 33 is an operation device such as a keyboard, a mouse, operation keys, and a touch panel, used by a user to perform various operations. Alternatively, the input/output unit 33 is a display device such as a liquid crystal display, or an organic electroluminescence (EL) display. The input/output unit 33 may be an acoustic device such as a speaker or a buzzer. Furthermore, the input/output unit 33 may be a lighting device such as a light emitting diode (LED) lamp. The input/output unit 33 functions as an input/output means (input means, output means, operation means, or notification means) provided on the terminal device 30.

The control unit 34 is a controller that controls individual parts of the terminal device 30. The control unit 34 is actualized by a processor such as a CPU or an MPU, for example. For example, the control unit 34 is actualized by a processor executing various programs stored in a storage device inside the terminal device 30 using RAM or the like as a work area. Note that the control unit 34 may be actualized by an integrated circuit such as an ASIC or an FPGA. The CPU, MPU, ASIC, and FPGA can all be regarded as controllers. Note that the control unit 34 may include individual functional blocks included in the control unit of the base station device 40.

As illustrated in FIG. 10, the control unit 34 includes an acquisition unit 341 and a communication control unit 342. Individual blocks (acquisition unit 341 to communication control unit 342) constituting the control unit 34 are functional blocks individually indicating functions of the control unit 34. These functional blocks may be software blocks or hardware blocks. For example, each of the functional blocks described above may be one software module actualized by software (including a microprogram) or one circuit block on a semiconductor chip (die). Needless to say, each of the functional blocks may be formed as one processor or one integrated circuit. The functional block may be configured by using any method. Note that the control unit 34 may be configured in a functional unit different from the above-described functional block.

<2-5. Configuration of Base Station Device>

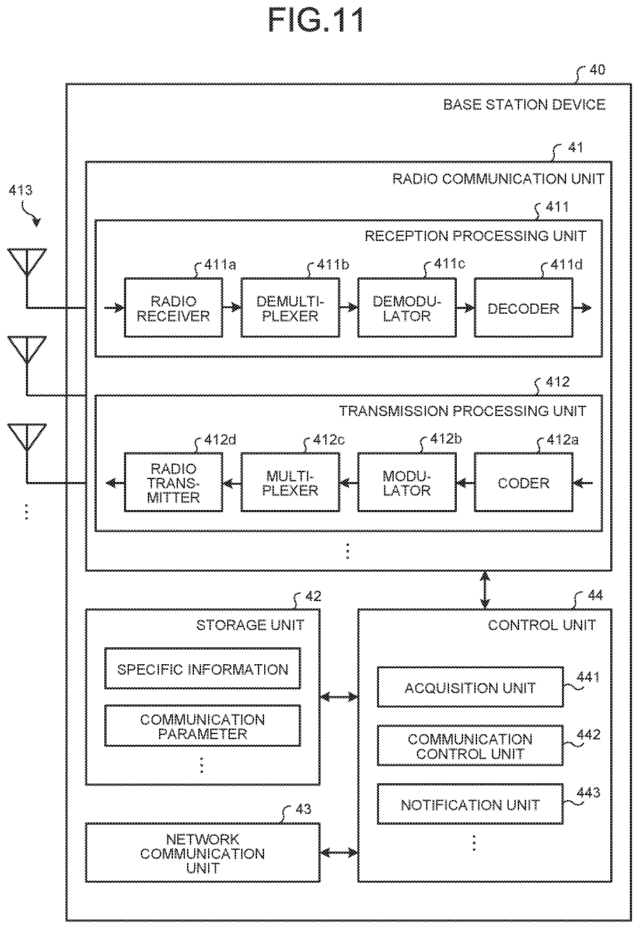

Next, a configuration of the base station device 40 will be described. FIG. 11 is a diagram illustrating a configuration example of the base station device 40 according to an embodiment of the present disclosure. The base station device 40 is a communication device (radio system) that performs radio communication with the terminal device 30 under the control of the communication control device 60. The base station device 40 is a type of information processing device.

The base station device 40 includes a radio communication unit 41, a storage unit 42, a network communication unit 43, and a control unit 44. Note that the configuration illustrated in FIG. 11 is a functional configuration, and the hardware configuration may be different from this. Furthermore, the functions of the base station device 40 may be implemented in a distributed manner in a plurality of physically separated devices.

The radio communication unit 41 is a radio communication interface that performs radio communication with other communication devices (for example, the terminal device 30, the communication control device 60, the intermediate device 50, and another base station device 40). The radio communication unit 41 operates under the control of the control unit 44. The radio communication unit 41 may support a plurality of radio access methods. For example, the radio communication unit 41 may support both NR and LTE. The radio communication unit 41 may support other cellular communication methods such as W-CDMA and cdma2000. For example, the radio communication unit 41 may support the wireless LAN communication method in addition to the cellular communication method. Needless to say, the radio communication unit 41 may be configured to support a single radio access method.

The radio communication unit 41 includes a reception processing unit 411, a transmission processing unit 412, and an antenna 413. The radio communication unit 41 may include a plurality of the reception processing units 411, a plurality of the transmission processing units 412, and a plurality of the antennas 413. In a case where the radio communication unit 41 supports a plurality of radio access methods, individual portions of the radio communication unit 41 can be configured separately for each of the radio access methods. For example, if the base station device 40 is compatible with NR and LTE, the reception processing unit 411 and the transmission processing unit 412 may be configured separately for NR and LTE.

The reception processing unit 411 processes an uplink signal received via the antenna 413. The reception processing unit 411 includes a radio receiver 411a, a demultiplexer 411b, a demodulator 411c, and a decoder 411d.

The radio receiver 411a performs processes on the uplink signal, such as down-conversion, removal of unnecessary frequency components, amplification level control, orthogonal demodulation, conversion to digital signal, removal of guard interval, and frequency domain signal extraction using fast Fourier transform. For example, it is assumed that the radio access method of the base station device 40 is a cellular communication method such as LTE. At this time, the demultiplexer 411b demultiplexes an uplink channel such as a physical uplink shared channel (PUSCH) or a physical uplink control channel (PUCCH) and an uplink reference signal from the signal output from the radio receiver 411a. Using a modulation scheme such as binary phase shift keying (BPSK) or quadrature phase shift keying (QPSK) for the modulation symbol of the uplink channel, the demodulator 411c demodulates the received signal. The modulation scheme used by the demodulator 411c may be multi-valued quadrature amplitude modulation (QAM) such as 16 QAM, 64 QAM, or 256 QAM. The decoder 411d performs a decoding process on the demodulated coded bits of the uplink channel. The decoded uplink data and uplink control information are output to the control unit 44.

The transmission processing unit 412 performs transmission processing of downlink control information and downlink data. The transmission processing unit 412 includes a coder 412a, a modulator 412b, a multiplexer 412c, and a radio transmitter 412d.

The coder 412a encodes the downlink control information and the downlink data input from the control unit 44 by using a coding method such as block coding, convolutional coding, or turbo coding. The modulator 412b modulates the coded bits output from the coder 412a by a predetermined modulation scheme such as BPSK, QPSK, 16 QAM, 64 QAM, or 256 QAM. The multiplexer 412c multiplexes the modulation symbol of each of channels and the downlink reference signal and allocates the multiplexed signals on a predetermined resource element. The radio transmitter 412d performs various types of signal processing on the signal from the multiplexer 412c. For example, the radio transmitter 412d performs processes such as conversion to the time domain using fast Fourier transform, addition of a guard interval, generation of a baseband digital signal, conversion to an analog signal, quadrature modulation, upconvert, removal of extra frequency components, and power amplification. The signal generated by the transmission processing unit 412 is transmitted from the antenna 413.

The storage unit 42 is a data readable/writable storage device such as DRAM, SRAM, a flash drive, and a hard disk. The storage unit 42 functions as a storage means in the base station device 40. The storage unit 42 stores desired transmission power information, operational parameters, resource holding information, and the like.

The desired transmission power information is information regarding transmission power required by the base station device 40 for information regarding transmission power necessary for transmission of radio waves, to the communication control device 60.

The operational parameter is information (for example, the setting information) related to the radio transmission operation of the base station device 40. For example, the operational parameter is information regarding the maximum value of the transmission power (maximum allowable transmission power) allowed for the base station device 40. Note that the operational parameter is not limited to the information of the maximum allowable transmission power.

In addition, the resource holding information is information related to holding of radio resources of the base station device 40. For example, the resource holding information is information of radio resources currently usable by the base station device 40. For example, the resource holding information is information regarding a holding amount of the interference margin allocated from the communication control device 60 to the base station device 40. The information regarding the holding amount may be information in units of resource blocks described below. That is, the resource holding information may be information regarding the resource block held by the base station device 40 (for example, the resource block holding amount).

The network communication unit 43 is a communication interface for communicating with other devices (for example, the communication control device 60, the intermediate device 50, and other base station devices 40). An example of the network communication unit 43 is a local area network (LAN) interface such as a Network Interface Card (NIC). The network communication unit 43 may be a universal serial bus (USB) interface including a USB host controller, a USB port, and the like. Furthermore, the network communication unit 43 may be a wired interface or a wireless interface. The network communication unit 43 functions as a network communication means of the base station device 40. The network communication unit 43 communicates with other devices under the control of the control unit 44

The control unit 44 is a controller that controls individual components of the base station device 40. The control unit 44 is actualized by a processor such as a central processing unit (CPU) or a micro processing unit (MPU), for example. For example, the control unit 44 is actualized by execution of various programs stored in the storage device inside the base station device 40 by the processor using random access memory (RAM) or the like as a work area. The control unit 44 may be actualized by an integrated circuit such as an application specific integrated circuit (ASIC) or a field programmable gate array (FPGA). The CPU, MPU, ASIC, and FPGA can all be regarded as controllers.

As illustrated in FIG. 11, the control unit 44 includes an acquisition unit 441, a communication control unit 442, and a notification unit 443. Individual blocks (the acquisition unit 441 to the notification unit 443) constituting the control unit 44 are functional blocks individually indicating functions of the control unit 44. These functional blocks may be software blocks or hardware blocks. For example, each of the functional blocks described above may be one software module actualized by software (including a microprogram) or one circuit block on a semiconductor chip (die). Needless to say, each of the functional blocks may be formed as one processor or one integrated circuit. The functional block may be configured by using any method. Note that the control unit 44 may be configured in a functional unit different from the above-described functional block.

Note that the control unit 34 of the terminal device 30 may include individual functional blocks (the acquisition unit 441 to the notification unit 443) included in the control unit 44 of the base station device 40. In this case, the description of the “base station device 40” in the following description can be appropriately replaced with the “terminal device 30”. In addition, descriptions of “control unit 44”, “acquisition unit 441”, “communication control unit 442”, and “notification unit 443” in the following description can also be replaced with “control unit 34” as appropriate.

<2-6. Configuration of Intermediate Device>

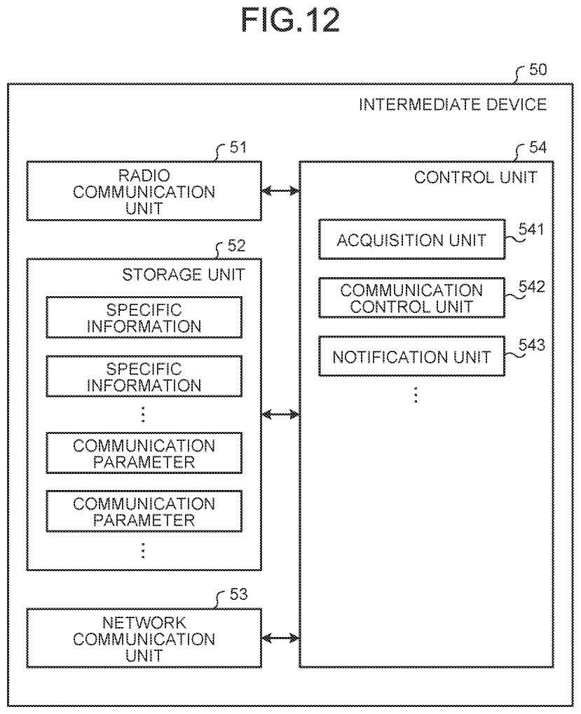

Next, a configuration of the intermediate device 50 will be described. FIG. 12 is a diagram illustrating a configuration example of the intermediate device 50 according to an embodiment of the present disclosure. The intermediate device 50 is a communication device that communicates with the base station device 40 and the communication control device 60. The intermediate device 50 is a type of information processing device.

The intermediate device 50 includes a radio communication unit 51, a storage unit 52, a network communication unit 53, and a control unit 54. Note that the configuration illustrated in FIG. 12 is a functional configuration, and the hardware configuration may be different from this. Furthermore, the functions of the intermediate device 50 may be implemented in a distributed manner in a plurality of physically separated configurations.

The radio communication unit 51 is a radio communication interface that performs radio communication with other communication devices (for example, the base station device 40, the terminal device 30, the communication control device 60, and another intermediate device 50). The radio communication unit 51 operates under the control of the control unit 54. The radio communication unit 51 may support one or a plurality of radio access methods. For example, the radio communication unit 51 supports both NR and LTE. The radio communication unit 51 may support other radio access methods such as W-CDMA and cdma2000. The configuration of the radio communication unit 51 is similar to that of the radio communication unit 41 of the base station device 40.

The storage unit 52 is a data readable/writable storage device such as DRAM, SRAM, a flash drive, and a hard disk. The storage unit 52 functions as a storage means in the intermediate device 50. The storage unit 52 may store specific information, communication parameters, and the like of each of the subordinate base station devices 40 (alternatively, the terminal device 30 further subordinate to the subordinate base station device 40).

The network communication unit 53 is a communication interface for communicating with other devices (for example, the base station device 40, the communication control device 60, and another intermediate device 50). For example, the network communication unit 53 is a LAN interface such as an NIC. The network communication unit 53 may be a USB interface including a USB host controller, a USB port, and the like. Furthermore, the network communication unit 53 may be a wired interface or a wireless interface. The network communication unit 53 functions as a network communication means of the intermediate device 50. The network communication unit 53 communicates with other devices under the control of the control unit 54.

The control unit 54 is a controller that controls individual parts of the intermediate device 50. The control unit 54 is actualized by a processor such as a CPU or an MPU, for example. For example, the control unit 54 is actualized by the processor executing various programs stored in the storage device inside the intermediate device 50 using RAM or the like as a work area. Note that the control unit 54 may be actualized by an integrated circuit such as an ASIC or an FPGA. The CPU, MPU, ASIC, and FPGA can all be regarded as controllers.

As illustrated in FIG. 12, the control unit 54 includes an acquisition unit 541, a communication control unit 542, and a notification unit 543. Individual blocks (the acquisition unit 541 to the notification unit 543) constituting the control unit 54 are functional blocks individually indicating functions of the control unit 54. These functional blocks may be software blocks or hardware blocks. For example, each of the functional blocks described above may be one software module actualized by software (including a microprogram) or one circuit block on a semiconductor chip (die). Needless to say, each of the functional blocks may be formed as one processor or one integrated circuit. The functional block may be configured by using any method. Note that the control unit 54 may be configured in a functional unit different from the above-described functional block. The operation of individual blocks constituting the control unit 54 will be described below.

The operations of individual blocks (the acquisition unit 541 to the notification unit 543) constituting the control unit 54 may be the same as the operations of individual blocks (the acquisition unit 441 to the notification unit 443) constituting the control unit 44 of the base station device 40. In this case, the description of the “intermediate device 50” in the following description can be appropriately replaced with the “base station device 40”. Similarly, description of “control unit 54”, “acquisition unit 541”, “communication control unit 542”, and “notification unit 543” in the following description can be appropriately replaced with “control unit 44”, “acquisition unit 441”, “communication control unit 442”, and “notification unit 443”, respectively.

<2-7. Configuration of Communication Control Device>

The communication control device 60 is a device that controls radio communication of the base station device 40. The communication control device 60 may control radio communication of the terminal device 30 via the base station device 40 or directly. The communication control device 60 is a type of information processing device.

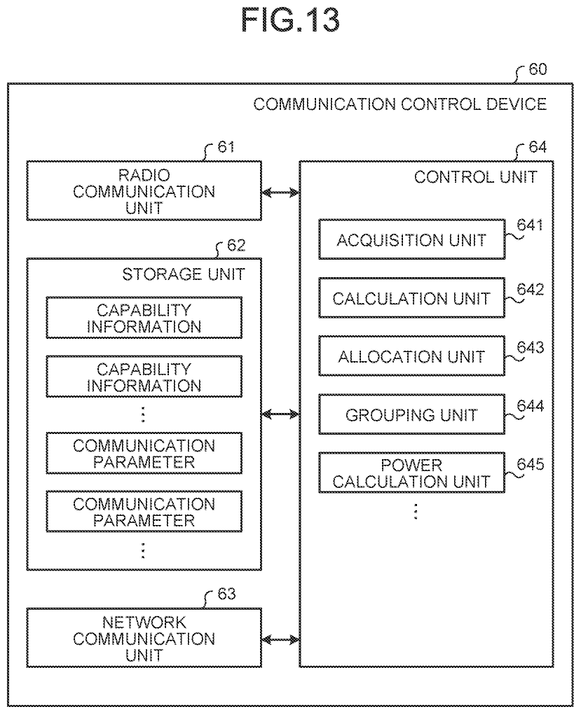

FIG. 13 is a diagram illustrating a configuration example of the communication control device 60 according to an embodiment of the present disclosure. The communication control device 60 includes a radio communication unit 61, a storage unit 62, a network communication unit 63, and a control unit 64. Note that the configuration illustrated in FIG. 13 is a functional configuration, and the hardware configuration may be different from this. Furthermore, the functions of the communication control device 60 may be implemented in a distributed manner in a plurality of physically separated configurations. For example, the communication control device 60 may be constituted with a plurality of server devices.

The radio communication unit 61 is a radio communication interface that performs radio communication with other communication devices (for example, the base station device 40, the terminal device 30, the intermediate device 50, and other communication control device(s) 60). The radio communication unit 61 operates under the control of the control unit 64. The radio communication unit 61 may support one or a plurality of radio access methods. For example, the radio communication unit 61 supports both NR and LTE. The radio communication unit 61 may support other radio access methods such as W-CDMA and cdma2000. The configuration of the radio communication unit 61 is similar to that of the radio communication unit 41 of the base station device 40.

The storage unit 62 is a data readable/writable storage device such as DRAM, SRAM, a flash drive, and a hard disk. The storage unit 62 functions as a storage means in the base station device 40. The storage unit 62 stores operational parameters of each of the plurality of base station devices 40 constituting the communication system 2. Note that the storage unit 62 may store the resource holding information of each of the plurality of base station devices 40 constituting the communication system 2. As described above, the resource holding information is information regarding holding of the radio resource of the base station device 40.

The network communication unit 63 is a communication interface for communicating with other devices (for example, the base station device 40, the intermediate device 50, and other communication control device(s) 60). The network communication unit 63 may be a network interface or a device connection interface. For example, the network communication unit 63 may be a local area network (LAN) interface such as a Network Interface Card (NIC). In addition, the network communication unit 63 may be a universal serial bus (USB) interface including a USB host controller, a USB port, and the like. Furthermore, the network communication unit 63 may be a wired interface or a wireless interface. The network communication unit 63 functions as a communication means in the communication control device 60. Under the control of the control unit 64, the network communication unit 63 communicates with the base station device 40, the terminal device 30, and the intermediate device 50.

The control unit 64 is a controller that controls individual parts of the communication control device 60. The control unit 64 is actualized by a processor such as a CPU or an MPU, for example. For example, the control unit 64 is actualized by a processor executing various programs stored in a storage device inside the communication control device 60 using RAM or the like as a work area. Note that the control unit 64 may be actualized by an integrated circuit such as an ASIC or an FPGA. The CPU, MPU, ASIC, and FPGA can all be regarded as controllers.

As illustrated in FIG. 13, the control unit 64 includes an acquisition unit 641, a calculation unit 642, an allocation unit 643, a grouping unit 644, and a power calculation unit 645. Individual blocks (the acquisition unit 641 to the power calculation unit 645) constituting the control unit 64 are functional blocks individually indicating functions of the control unit 64. These functional blocks may be software blocks or hardware blocks. For example, each of the functional blocks described above may be one software module actualized by software (including a microprogram) or one circuit block on a semiconductor chip (die). Needless to say, each of the functional blocks may be formed as one processor or one integrated circuit. The functional block may be configured by using any method. Note that the control unit 64 may be configured in a functional unit different from the above-described functional block. The operation of individual blocks constituting the control unit 64 will be described below.

Note that the control unit 44 of the base station device 40 may include individual functional blocks (the acquisition unit 641 to the power calculation unit 645) included in the control unit 64 of the communication control device 60. In this case, the description of the “communication control device 60” in the following description can be appropriately replaced with the “base station device 40” or the “intermediate device 50”. In addition, the description of “control unit 64”, “acquisition unit 641”, “calculation unit 642”, “allocation unit 643”, “grouping unit 644”, and “power calculation unit 645” in the following description can also be appropriately replaced with “control unit 44” or “control unit 54”.

### 3. Interference Model

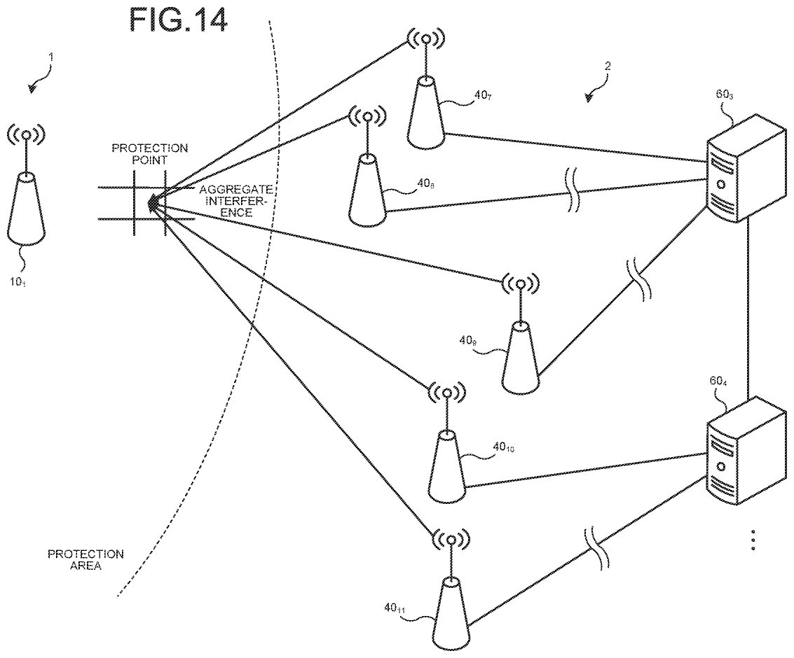

Next, an interference model assumed in the present embodiment will be described. FIG. 14 is a diagram illustrating an example of an interference model assumed in an embodiment of the present disclosure. Note that the description of the base station device 40 in the following description can be replaced with a word indicating another communication device having a wireless communication function.

The interference model illustrated in FIG. 14 is applied in a case where the primary system has a service area, for example. In the example of FIG. 14, the communication system 1 (primary system) is a radio communication system having a service area. This service area is to be a protection area of the communication system 1, for example. The interference calculation reference-point (hereinafter, referred to as an interference calculation point or a protection point) is set in plurality in the protection area. The protection point is set by an operator of the communication system 1, a public organization that manages radio waves, or the like (hereinafter, referred to as an administrator), for example. For example, the administrator may divide the protection area into a grid-like shape and set the center of a predetermined grid as the protection point. The protection point can be determined by any method.

The protection point may be set not only in the horizontal direction but also in the vertical direction. That is, the protection points may be arranged three-dimensionally. In the following description, a three-dimensionally arranged protection point (that is, a protection point under an assumption of a three-dimensional space, rather than in a protection point under an assumption of a horizontal plane) may be referred to as a spatial protection point.

The interference margin of each protection point is set by an administrator or the like. FIG. 14 illustrates interference given to a protection point by a plurality of base station devices 40 constituting the communication system 2 (secondary system). The communication control device 60 of the communication system 2 controls the transmission power of the plurality of base station devices 40 such that the aggregate interference at each protection point does not exceed a set interference margin.

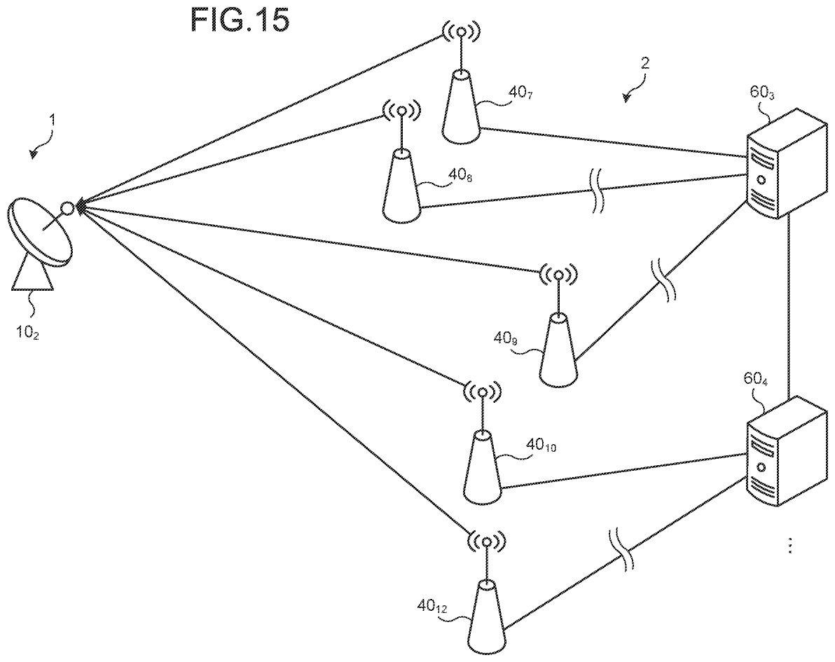

FIG. 15 is a diagram illustrating another example of an interference model assumed in an embodiment of the present disclosure. The interference model illustrated in FIG. 15 is applied in a case where the primary system performs only reception, for example. In the example of FIG. 15, the communication system 1 (primary system) includes a reception antenna as the radio wave utilization device 102. The radio wave utilization device 102 is a reception antenna of a satellite ground station, for example. The communication control device 60 of the communication system 2 sets the position of the reception antenna as a protection point, and controls the transmission power of the plurality of base station devices 40 such that the aggregate interference at the point does not exceed an interference margin.

### 4. Primary System Protection Method

Next, a primary system protection method will be described. As described above, the primary system protection method can be classified into the following two types, for example.

(1) Interference margin simultaneous allocation type

(2) Interference margin sequential allocation type

An example of the interference margin simultaneous allocation type primary system protection method is a method disclosed in Non Patent Literature 3 (for example, a calculation method of the maximum allowable EIRP), for example. In addition, an example of the interference margin sequential allocation type primary system protection method is a sequential allocation process (iterative allocation process (IAP)) disclosed in Non Patent Literature 6, for example.

Hereinafter, the “interference margin simultaneous allocation type” primary system protection method and the “interference margin sequential allocation type” primary system protection method will be described. Note that the description of the base station device 40 in the following description can be replaced with a word indicating another communication device having a wireless communication function.

<4-1. Interference Margin Simultaneous Allocation type>

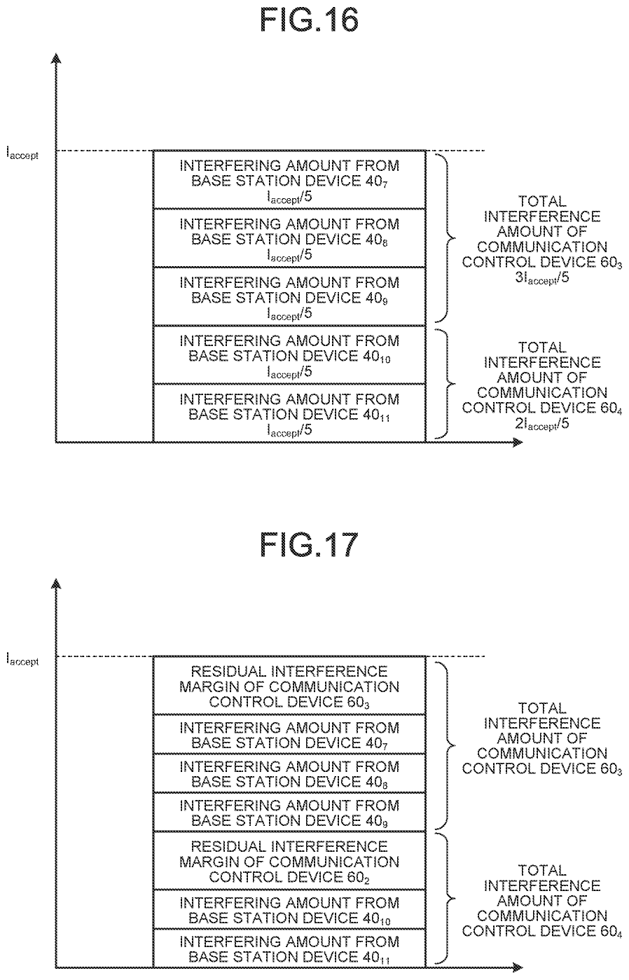

First, an interference margin simultaneous allocation type primary system protection method will be described. FIG. 16 is a diagram illustrating an interference margin simultaneous allocation type primary system protection method. As described above, in the interference margin simultaneous allocation type, the communication control device 60 calculates the maximum allowable transmission power of the secondary system using a “value uniquely obtained by positional relationship between the protection reference-point regarding the primary system and the secondary system” as a reference value. In the example of FIG. 16, an allowable interference threshold of the primary system is represented by I_{accept}. This threshold may be an actual threshold, or may be a value set assuming a certain margin (for example, a protection ratio) from the actual threshold in consideration of a calculation error and an interference variation.

In the interference margin simultaneous allocation type primary system protection method, interference control represents determination of transmission power (EIRP, Conducted Power+Antenna gain, and the like) of a radio device so as not to exceed an allowable interference threshold. At this time, when there are a large number of base station devices 40 and an attempt is made so as not to allow each to exceed an allowable interference threshold, there might be a concern that interference power received in the communication system 1 (primary system) exceeds the allowable interference threshold. To handle this, the interference margin (allowable interference amount) is “allocated” based on the number of base station devices 40 registered in the communication control device 60.

For example, in the example of FIG. 16, the total number of base station devices 40 is five. Therefore, the acceptable interference amount being I_{accept}/5 is allocated to each of the base station devices 40. Since the base station device 40 cannot self recognize the allocation amount, the base station device 40 recognizes the allocation amount through the communication control device or acquires transmission power determined based on the allocation amount. The communication control device cannot recognize the number of radio devices managed by other communication control devices. Therefore, by exchanging information with each other, the communication control device can recognize the total number of devices and can allocate the acceptable interference amount. For example, an acceptable interference amount of 3I_{accept}/5 is allocated in the communication control device 60₃.

Note that, the interference margin that has not been used by the base station device 40 can be a residual interference margin in this method. FIG. 17 is a diagram illustrating a state in which a residual interference margin occurs. FIG. 17 illustrates a total interference amount set in each of the two communication control devices 60 (communication control devices 60₃ and 60₄. In addition, FIG. 17 illustrates an interference amount (interfering amount) given to a predetermined protection point of the communication system 1 by a plurality of base station devices 40 (base station devices 40₇ to 40₁₁) under the management of the two communication control devices 60. An interference amount obtained by subtracting the interference amount of the base station device 40 from the total interference amount of each of the two communication control devices 60 is the residual interference margin. In the following description, an excessive interference amount is referred to as the residual interference margin. The residual interference margin can be rephrased as a residual interference amount.

<4-2. Interference Margin Sequential Allocation Type>

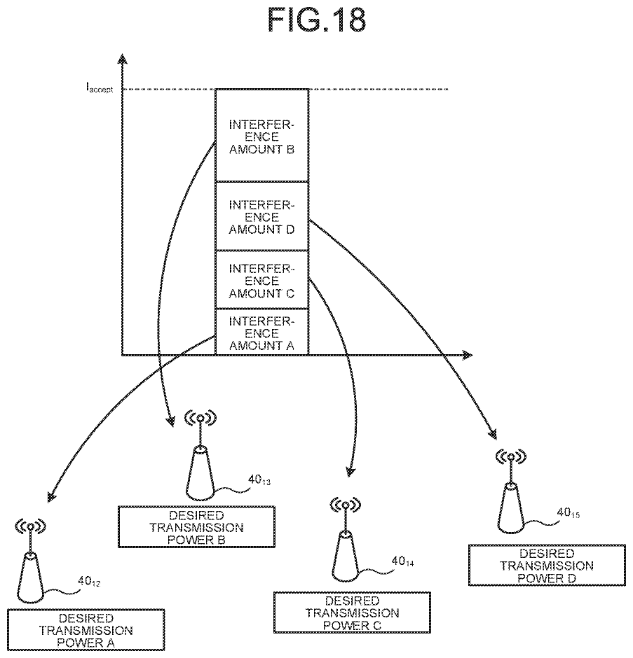

Next, an interference margin sequential allocation type primary system protection method will be described. As described above, in the case of interference margin sequential allocation type, the communication control device 60 calculates the maximum allowable transmission power of the secondary system using the “desired transmission power of the secondary system” as a reference value. FIG. 18 is a diagram illustrating an interference margin sequential allocation type primary system protection method. In the interference margin sequential allocation type, for example, each of the plurality of base station devices 40 stores the desired transmission power information in the storage unit 42. The desired transmission power information is information regarding transmission power required by the base station device 40 for information regarding transmission power necessary for transmission of radio waves, to the communication control device 60. In the example of FIG. 18, the base station devices 40₁₂ to 40₁₅ hold desired transmission power information A to D, respectively. The communication control device 60 allocates the interference amounts A to D to the base station devices 40₁₂ to 40₁₅ based on the desired transmission power information A to D, respectively. The interference amounts A to D are allocated based on the allocation priority in the present embodiment, and details of which will be described below in <6>.

### 5. Description of Various Procedures

Next, a basic procedure applicable at the implementation of the system (for example, the communication system 2) of the present embodiment will be described. Note that the description of the base station device 40 in the following description can be replaced with a word indicating another communication device having a wireless communication function.

<5-1. Registration Procedure>

A registration procedure is a procedure of registering a device parameter related to the base station device 40 to the communication control device 60. Typically, the registration procedure is started when one or more communication systems including the base station device 40 or the plurality of base station devices 40 notify the communication control device 60 of a registration request including the device parameter. The registration request may be transmitted by a communication system (for example, a proxy system such as the intermediate device 50) substituting (representing) one or a plurality of base station devices 40.

In the following description, the communication system that substitutes (represents) the plurality of base station devices 40 is assumed to be the intermediate device 50. However, a word of the intermediate device 50 in the following description can be replaced with a word indicating a communication system that substitutes (represents) other communication devices such as a proxy system. Naturally, the description of the base station device 40 can also be replaced with a word indicating other communication devices having a wireless communication function.

(Details of Required Parameters)

The device parameter refers to the following information, for example.

Communication device user information

Information specific to communication device

Position-related information

Antenna information

Wireless interface information

Legal Information

Installer information

Communication device group information

At the time of implementation, information other than these may be handled as device parameters.

The communication device user information is information related to a user of the communication device. Assumable examples include a user ID, an account name, a user name, a user contact, and a call sign. The user ID and the account name may be independently generated by the communication device user or may be issued in advance by the communication control device 60. Regarding the call sign, it is desirable to use a call sign issued by the NRA.

The communication device user information can be used for the purpose of interference resolution. As a specific example, there is a case where the communication control device makes, in the spectrum use notification/heartbeat procedure in <5-4> to be described below, a determination and instruction of use suspension regarding the spectrum currently used by a communication device, and where a spectrum use notification/heartbeat request is continuously notified even after this instruction, it is possible, with suspect of a failure of the communication device, to notify the user contact included in the communication device user information of a behavior confirmation request regarding the communication device. Not limited to this example, when it is determined that a communication device is performing an operation against the communication control performed by the communication control device, it is possible to make a contact using communication device user information.

Examples of the information specific to the communication device include information by which a communication device can be specified, communication device product information, communication device hardware information, and communication device software information. For example, the information can include a serial number, a product model number, and the like. Here, the communication device is the base station device 40, for example.

Examples of the information by which the communication device can be specified include communication device user information, a communication device serial number, and communication device ID. For example, assumable communication device user information can include user ID, call sign, and the like. The user ID may be independently generated by the communication device user or may be issued in advance by the communication control device 60. The communication device ID may be uniquely assigned by the communication device user, for example.

The communication device product information may include, for example, an authentication ID, a product model number, manufacturer information, and the like. The authentication ID is ID given from an authentication organization in each country or region, such as an FCC ID, a CE number, and a technical standard conformity certification (technical standard), for example. This may include ID issued by an industry association or the like based on a unique authentication program.

The information specific to the communication device represented by these can be used for the purpose of whitelist/blacklist applications. For example, in a case where any piece of information corresponding to the communication device in operation is included in a blacklist, the communication control device can take a behavior of instructing to perform spectrum use suspension in the spectrum use notification/heartbeat procedure in <5-4> to be described below and not cancelling the use suspension measure until the blacklist is canceled. Furthermore, for example, in a case where a communication device included in the blacklist performs a registration procedure, the communication control device can reject the registration. Furthermore, for example, it is also possible to perform an operation of not taking a communication device corresponding to information included in a blacklist into consideration at the interference calculation described in the present specification, or operation of taking only a communication device corresponding to information included in a whitelist into consideration at the interference calculation.

The information regarding the hardware of the communication device can include, for example, transmission power class information, manufacturer information, and the like. In FCC C.F.R Part 96, for example, the transmission power class information can include one of two types of defined classes, namely, Category A and Category B. Furthermore, 3GPP TS 36.104 and TS 38.104 define some classes of eNodeB and gNodeB, and these can also be used as the information.

The transmission power class information may be used, for example, in an application of interference calculation. The interference calculation can be performed using the maximum transmission power defined for each class as the transmission power of the communication device.

The information regarding the software of the communication device can include, for example, version information, a build number, and the like regarding an execution program in which processing necessary for interaction with the communication control device 60 is described. In addition, the information may include version information, a build number, and the like of software for operating as the base station device 40.

The position-related information is typically information by which the geographical location of the communication device (for example, the base station device 40) can be specified. For example, the location information is coordinate information acquired by a positioning function represented by a global positioning system (GPS), Beidou, a Quasi-Zenith Satellite System (QZSS), Galileo, or an assisted global positioning system (A-GPS). Typically, the location information can include information regarding latitude, longitude, altitude, and positioning error. Alternatively, for example, the location information may be location information registered in an information management device managed by a National Regulatory Authority (NRA) or its agency. Alternatively, for example, it is allowable to use coordinates of an X axis, a Y axis, and a z axis having its origin in a specific geographical location. In addition, coordinate information like this can be added with an identifier indicating outdoor/indoor.

Furthermore, the position-related information may be information indicating a region where the communication device (for example, the base station device 40) is located. For example, it is allowable to use information defined by the government, such as a postal code and a postal address. Furthermore, for example, the area may be indicated by a set of three or more geographic coordinates. The information indicating these regions may be provided together with the coordinate information.

Furthermore, in a case where the communication device (for example, the base station device 40) is located indoors, information indicating a floor of a building may be added to the position-related information. For example, it is allowable to add an identifier or the like indicating floor number or ground/underground. Furthermore, it is allowable to add information indicating a further closed space inside the building, such as a room number and a room name in the building, for example.

Typically, the positioning function is desirably provided in the communication device (for example, the base station device 40). However, it is not always possible to acquire the location information satisfying required accuracy depending on the performance of the positioning function or the installation position. Therefore, the positioning function may be used by the installer. In such a case, the location information measured by the installer is to be desirably written in the base station device 40.

The antenna information is typically information indicating performance, a configuration, and the like of an antenna included in the communication device (for example, the base station device 40). Typically, for example, the antenna information can include information such as an antenna installation height, a tilt angle (Downtilt), a horizontal direction (Azimuth), an aim (Boresight), an antenna peak gain, and an antenna model.

The antenna information can also include information regarding a formable beam. For example, it is allowable to include information such as a beamwidth, a beam pattern, and an analog/digital beamforming capability.

In addition, the antenna information can also include information related to performance and a configuration of Multiple Input Multiple Output (MIMO) communication. For example, information such as the number of antenna elements and the maximum number of spatial streams can be included. In addition, the antenna information can include codebook information to be used, weight matrix information (a unitary matrix obtained by singular value decomposition (SVD), eigen value decomposition (EVD), block diagonalization (BD), or the like, a zero-forcing (ZF) matrix, or a minimum mean square error (MMSE) matrix), and the like. In addition, when equipped with Maximum Likelihood Detection (MLD) or the like that requires nonlinear calculation, information indicating the MLD or the like may be included.

The antenna information may include Zenith of Direction, Departure (ZoD). The ZoD is a type of radio wave arrival angle. The ZoD may be estimated from a radio wave radiated from an antenna of the communication device (for example, the base station device 40) by another communication device (for example, another base station device 40). In this case, the communication device may be a terminal device that operates as a base station or an access point, a device that performs D2D communication, a moving relay base station, or the like. The ZoD can be estimated by a radio wave arrival direction estimation technology such as Multiple Signal Classification (MUSIC) or Estimation of Signal Propagation via Rotation Invariance Techniques (ESPRIT). This information can be used as measurement information by the communication control device 60.

The wireless interface information is typically information indicating a wireless interface technology included in the communication device (for example, the base station device 40). For example, the wireless interface information includes identifier information indicating a technology used in GSM (registered trademark), CDMA2000, UMTS, E-UTRA, E-UTRA NB-IoT, 5G NR, or technologies used in further next generation cellular system, derivative technologies based on LTE such as MulteFire or LTE-Unlicensed (LTE-U), or standard technologies such as a Metropolitan Area Network (MAN) such as WiMAX or WiMAX2+, or a wireless LAN based on IEEE 802.11. The wireless interface information may be identifier information indicating a proprietary radio technology. In addition, it is also possible to add a version number or a release number of the technical specification that defines the information like this.

The wireless interface information can also include frequency band information supported by the communication device (for example, the base station device 40). For example, the information can be expressed by one or more combinations of the upper limit frequency and the lower limit frequency, one or more combinations of the center frequency and the bandwidth, one or more 3GPP Operating Band numbers, and the like.

The frequency band information supported by the communication device can further include capability information regarding bandwidth extension technology such as carrier aggregation (CA) and channel bonding. For example, combinable band information or the like can be included. Furthermore, the carrier aggregation can also include information regarding a band to be used as a primary component carrier (PCC) or a secondary component carrier (SCC). Also, the number of CCs that can be aggregated at the same time can be included.

The frequency band information supported by the communication device may further include combination information of frequency bands supported by the dual connectivity and the multi connectivity. In addition, information regarding other communication devices that cooperatively provide the dual connectivity and the multi connectivity may be provided together.

The frequency band information supported by the communication device may also include information indicating radio wave utilization priority such as PAL and GAA.

The wireless interface information can also include modulation scheme information supported by the communication device (for example, the base station device 40). For example, as a representative example, the wireless interface information can include information indicating a primary modulation scheme such as frequency shift keying (FSK), n-value phase shift keying (PSK) (n is 2, 4, 8, or the like), or n-value quadrature amplitude modulation (QAM) (n is 4, 16, 64, 256, or the like), or information indicating a secondary modulation scheme such as orthogonal frequency division multiplexing (OFDM), Scalable OFDM, DFT spread OFDM (DFT-s-OFDM), Generalized Frequency Division Multiplexing (GFDM), or Filter Bank Multi Carrier (FBMC).

The wireless interface information can also include information related to an error correction code. For example, the information can include capabilities regarding a turbo code, a low density parity check (LDPC) code, a polar code, and an erasure correction code, as well as coding rate information to be applied.

The modulation scheme information and the information related to the error correction code can also be expressed by a Modulation and Coding Scheme (MCS) index as another aspect.

In addition, the wireless interface information can also include information indicating functions specific to each of radio technology specifications supported by the communication device (for example, the base station device 40). For example, there is transmission mode (TM) information defined in LTE, as a representative example. In addition, information having two or more modes with respect to a specific function can be included in the wireless interface information as in the TM described above. In addition, in a case where, in the technical specification, the base station device 40 supports a function that is not essential in the specification even in the absence of two or more modes, information indicating this function can also be included.

The wireless interface information can also include radio access method (radio access technology (RAT)) information supported by the communication device (for example, the base station device 40). For example, the wireless interface information can include information indicating: an orthogonal multiple access (OMA) scheme such as time division multiple access (TDMA), frequency division multiple access (FDMA), or orthogonal frequency division multiple access (OFDMA); a non orthogonal multiple access (NOMA) scheme such as Power Division Multiple Access ((PDMA) which is represented by techniques implemented by combining Superposition Coding (SPC) and Successive Interference Canceller (SIC)), Code Division Multiple Access (CDMA), Sparse Code Multiple Access (SCMA), Interleaver Division Multiple Access (IDMA), and Spatial Division Multiple Access (SDMA); and opportunistic access schemes such as Carrier Sense Multiple Access/Collision Avoidance (CSMA/CA) and Carrier Sense Multiple Access/Collision Detection (CSMA/CD).

When information indicating an opportunistic access scheme is included in the wireless interface information, information indicating details of the access scheme may be further included. As a specific example, information indicating which one of Frame Based Equipment (FBE) and Load Based Equipment (LBE) defined in ETSI EN 301 598 may be included.

When the wireless interface information described above indicates LBE, information specific to LBE, such as Priority Class defined in ETSI EN 301 598, may be further included.

In addition, the wireless interface information can also include information regarding a duplex mode supported by the communication device (for example, the base station device 40). For example, frequency division duplex (FDD), time division duplex (TDD), and full duplex (FD) can be included as a representative example.

In a case where TDD is included as the wireless interface information, TDD Frame Configuration information used/supported by the base station device 40 can be added. Furthermore, information regarding the duplex mode may be included for each frequency band indicated by the frequency band information.

When the FD is included as the wireless interface information, information related to an interference power detection level may be included.

The wireless interface information can also include information related to a transmission diversity method supported by the communication device (for example, the base station device 40). For example, space time coding (STC) or the like may also be included.

The wireless interface information can also include guardband information. For example, information related to a standard guardband size can be included. Alternatively, for example, information regarding a guardband size desired by the base station device 40 may be included.

The wireless interface information may be provided for each frequency band regardless of the above-described aspect.

The legal information typically corresponds to information related to regulations that the communication device (for example, the base station device 40) must comply with, which are defined by radio administration agencies in different countries and regions or equivalent organizations, authentication information acquired by the communication device (for example, the base station device 40), and the like. The information regarding the regulation typically includes, for example, upper limit value information of out-of-band emission, information regarding a blocking characteristic of the receiver, and the like. Typically, the authentication information can include, for example, type approval information (FCC ID, Technical Standard Conformance Certificate, and the like), legal/regulatory information (for example, FCC regulation number, ETSI Harmonized Standard number, and the like) to be a standard for authentication acquisition, and the like.

Among the legal information, information related to a numerical value may be substituted by information defined in the specification of the wireless interface technology. For example, the upper limit value of the out-of-band emission may be derived for application by using an Adjacent Channel Leakage Ratio (ACLR) instead of the upper limit value information of the out-of-band emission. In addition, the ACLR itself may be used as necessary. Furthermore, adjacent channel selectivity (ACS) may be used instead of the blocking characteristic. In addition, these may be used in combination, or an adjacent channel interference ratio (ACIR) may be used. Typically, ACIR has a relationship with ACLR and ACS represented by the following Formula (1).

$$A C I R = {( \frac{1}{A C S} + \frac{1}{A C L R} )}^{- 1} \qquad ( 1 )$$

Although the true value expression is used in the above Formula (1), the expression may be appropriately converted into a logarithmic expression.

The installer information can include information by which a person (installer) who installs the communication device (for example, the base station device 40) can be specified, specific information associated with the installer, and the like. Typically, the information can include information related to a person responsible for the location information of the communication device, which is a certified professional installer (CPI) defined in Non-Patent literature 2. For example, Certified Professional Installer Registration ID (CPIR-ID) and a CPI name are disclosed as the information. In addition, for example, a postal address (mailing/contact address), an e-mail address, a telephone number, a Public Key Identifier (PKI), and the like are disclosed as specific information associated with CPI. The information is not limited thereto, and other information related to the installer may be included as necessary.

The communication device group information can include information related to a communication device group to which a communication device belongs. Specifically, for example, the information can include information related to the same or equivalent type of group as disclosed in WINNF-SSC-0010. Furthermore, for example, in a case where a network operator manages communication devices in units of groups based on its own operation policy, the group information can be included.

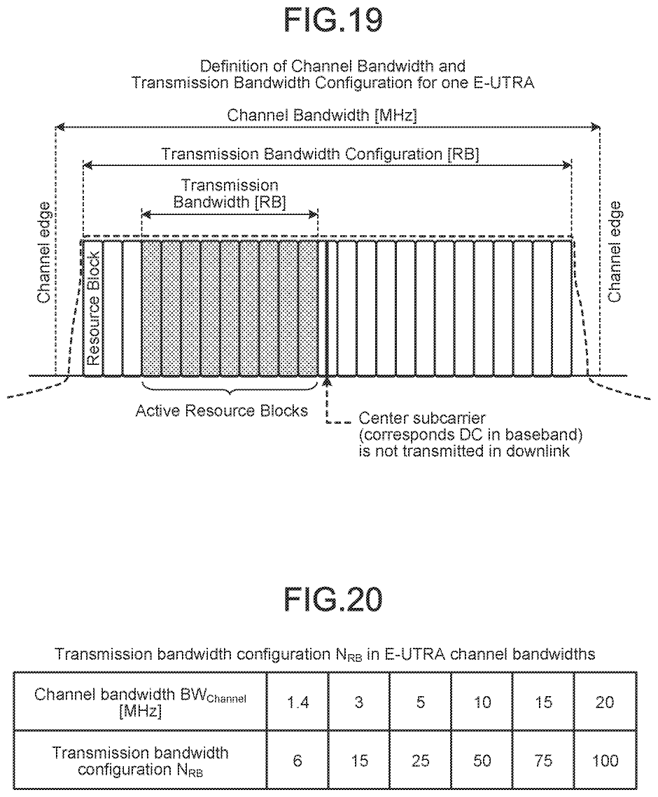

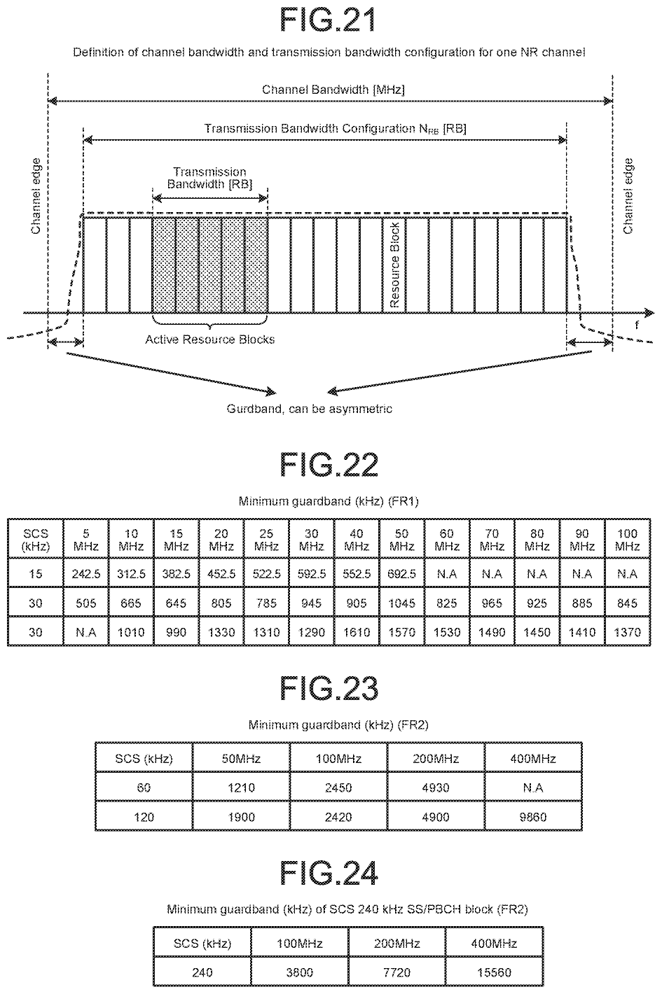

The information listed so far need not be provided by the communication device to the communication control device but may be estimated by the communication control device from other information provided from the communication device. Specifically, for example, the guardband information can be estimated from the wireless interface specification information. When the wireless interface used by the communication device is E-UTRA or 5G NR, the information can be estimated based on the transmission bandwidth specification described in TS 36.104 or the table described in TS 38.104. FIGS. 19 to 24 are diagrams illustrating specifications of the transmission bandwidth. FIGS. 19 and 20 are diagrams illustrating specifications of the transmission bandwidth in E-UTRA, and FIGS. 21, 22, 23, and 24 are diagrams illustrating specifications of the transmission bandwidth in NR.

In other words, the communication device or an intermediate device (for example, a network manager) that substitutes for the plurality of communication devices does not necessarily need to provide the information listed so far to the communication control device. Providing information to the communication control device by the communication device or an intermediate device that substitutes for the plurality of communication devices is merely one means of information provision. The information listed so far represents information that can be necessary for the communication control device to normally complete the present procedure, and any means for providing the information may be used.

Note that the transmission bandwidth of the present embodiment is not limited to the examples illustrated in FIGS. 19 to 24.

(Supplement to Required Parameters)

In the registration procedure, depending on the embodiment, it is assumed that not only the base station device 40 but also the device parameters related to the terminal device 30 are required to be registered in the communication control device 60. In such a case, the term “communication device” in the above description (details of required parameters) may be replaced with a term “terminal device” or an equivalent term for application. In addition, a parameter specific to the “terminal device” that is not described above (details of required parameters) may also be handled as a required parameter in the registration procedure. An example of this is a user equipment (UE) category defined in 3GPP.

(Details of Registration Process)

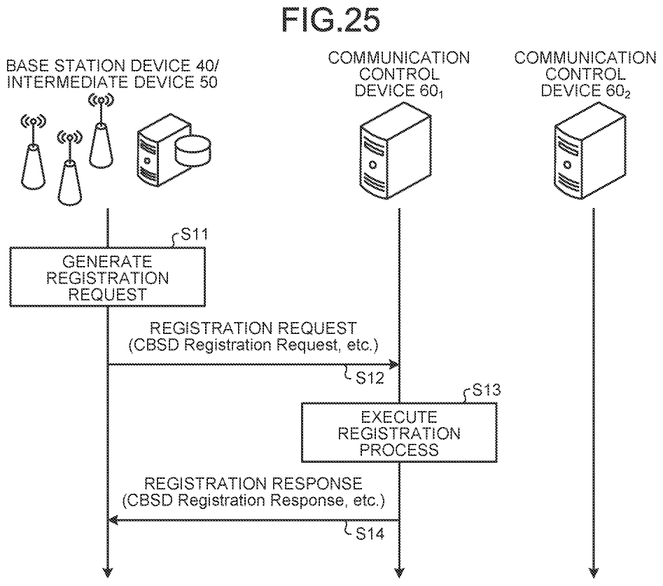

FIG. 25 is a sequence diagram illustrating a registration procedure. One or more communication systems including the base station device 40 or a plurality of the base station devices 40 generate a registration request message using the device parameter (step S11), and then notify the communication control device 60 of the registration request message (step S12). The generation and/or notification of the message may be performed by the intermediate device 50.

Here, in a case where the device parameter includes installer information, falsification prevention processing or the like may be performed on the registration request by using this information. In addition, a part or all of the information included in the registration request may be subjected to an encryption process. Specifically, for example, it is possible to apply a process in which a public key specific to the installer is shared in advance between the installer and the communication control device 60, and the installer performs encryption on information using a secret key. Examples of the encryption target include security sensitive information such as location information.

Further, as disclosed in Non Patent Literature 2, the installer may directly write the location information into the communication control device 60, for example.

After receiving the registration request, the communication control device 60 performs a registration process regarding the base station device 40 (step S13), and returns a registration response according to a processing result (step S14). When there is no lack or abnormality of information necessary for registration, the communication control device 60 records the information to the storage unit 42 and notifies normal completion. Otherwise, the communication control device 60 notifies a registration failure. In a case of normal completion of registration, the communication control device 60 may assign an ID to each communication device and may notify the communication device of the ID information by enclosing the ID information at the time of response. In a case of a registration failure, typically, one or more communication systems including the base station device 40 or a plurality of the base station devices 40, or an operator (for example, a mobile network operator or an individual) or an installer thereof performs correction or the like of the registration request, and attempts the registration procedure until normal completion of the registration.

Note that the registration procedure is sometimes executed a plurality of times. Specifically, for example, when the location information is changed beyond a predetermined standard due to movement of the device, accuracy improvement, or the like, the registration procedure can be executed again. The predetermined standard is typically defined by a legal system. For example, in 47 C.F.R Part 15, the Mode II personal/portable white space device is required to access the database again when the location information changes by 100 meters or more.

<5-2. Available Spectrum Query Procedure>

The available spectrum query procedure is a procedure used by the base station device 40 or the intermediate device 50 to make a query about information regarding the available spectrum to the communication control device 60. Typically, the procedure is started when the base station device 40 or the intermediate device 50 notifies the communication control device 60 of a query request including information by which the base station device 40 (or the base station device 40 under the intermediate device 50) can be specified.

As described above, the description of the “base station device 40” can be replaced with a word indicating another communication device having a wireless communication function. Furthermore, the description of “intermediate device 50” can also be replaced with a word indicating a communication system that substitutes (represents) another communication device, such as a proxy system.

Here, typically, the available spectrum information is information indicating a spectrum that can be safely provided as a secondary use without giving fatal interference to the primary system by the base station device 40 (or the base station device 40 under the intermediate device 50).

### (1) Example 1

The available spectrum information is determined based on a secondary use prohibited area referred to as an exclusion zone, for example. Specifically, in a case where the base station device 40 is installed in a secondary use prohibited area provided for the purpose of protecting the primary system using the frequency channel F1, for example, the frequency channel F1 is not notified as an available channel to the base station device 40.

### (2) Example 2

The available spectrum information can also be determined by the degree of interference given to the primary system, for example. Specifically, when it is determined, for example, that fatal interference might be given to the primary system even outside the secondary use prohibited area, the frequency channel would not be notified as an available channel in some cases. An area where such determination can be necessary is also referred to as a neighborhood area. An example of a specific calculation method related to the determination in the neighborhood area is described in “Details of available spectrum evaluation process” described below.

### (3) Example 3

Moreover, in the available spectrum information, there can also be frequency channels not to be notified as available channels because of conditions other than the primary system protection requirements of Examples 1 and 2. Specifically, in order to avoid interference that can occur between the base station devices 40 in advance, for example, a frequency channel being used by another base station device 40 existing in the neighborhood of the base station device 40 (or the base station device 40 under the intermediate device 50) might not be notified as an available channel in some cases. In this manner, the available spectrum information set in consideration of interference with other communication devices may be set as “recommended spectrum information” for example, and may be provided together with the available spectrum information. That is, the “recommended spectrum information” is desirably a subset of the available spectrum information.

Note that the communication control device 60 may transmit, as recommended frequency information, information regarding a frequency at which no interference occurs between the base station devices 40, separately from the available spectrum described in Examples 1 and 2. Here, the available spectrum information referred to in Examples 1 and 2 may be, for example, information of an available channel described in Non Patent Literature 13. The recommended frequency information may be information regarding a recommended channel described in Non Patent Literature 13. Note that the recommended spectrum information can be regarded as a type of available spectrum.

### (4) Example 4

Even in a case corresponding to the situation described in Examples 2 and 3, the spectrum same as that of the primary system or the neighboring base station device 40 can be notified as an available channel. In such a case, typically, the maximum allowable transmission power information is included in the available spectrum information. The maximum allowable transmission power is typically expressed by Equivalent Isotropic Radiated Power (EIRP). The power is not necessarily limited to this, and may be provided by a combination of conducted power and antenna gain, for example. Furthermore, the antenna gain may have an allowable peak gain set for each spatial direction.

(Details of Required Parameters)

Examples of assumable information by which the base station device 40 can be specified include information specific to the communication device registered at the time of the registration procedure, and the ID information described above (details of the registration process).

The query request can also include query requirement information. The query requirement information can include, for example, information indicating a frequency band availability of which is desired to be obtained. Also, for example, transmission power information can be included. For example, the base station device 40 or the intermediate device 50 can include the transmission power information when it is desired to know only the spectrum information likely to be available for utilization of desired transmission power. The query requirement information does not necessarily need to be included.

The query request can also include a measurement report. The measurement report includes a result of measurement performed by the base station device 40 and/or the terminal device 30. The report can include not only raw data but also processed information, for example. For example, it is possible to use standardized metrics represented by Reference Signal Received Power (RSRP), Reference Signal Strength Indicator (RSSI), and Reference Signal Received Quality (RSRQ).

(Details of Available Spectrum Evaluation Process)

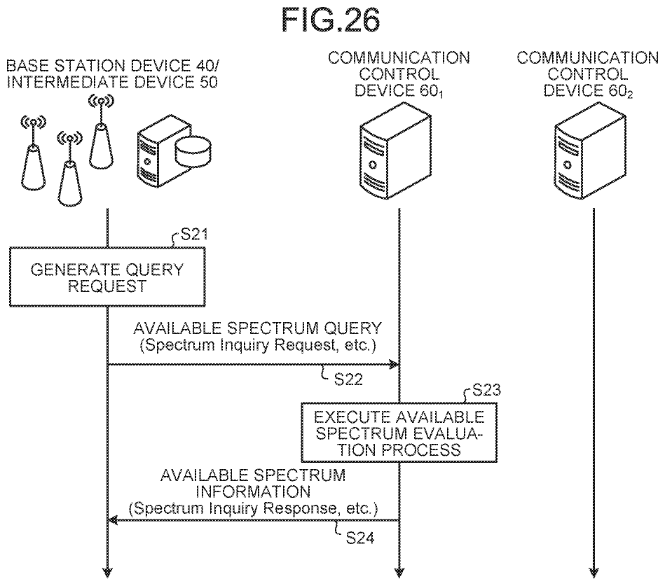

FIG. 26 is a sequence diagram illustrating an available spectrum query procedure. The base station device 40 or the intermediate device 50 generates a query request including information by which the base station device 40 (or the base station device 40 under the intermediate device 50) can be specified (step S21) and notifies the communication control device 60 of the query request (step S22).

After receiving the query request, the communication control device 60 evaluates the available spectrum based on the query requirement information (step S23). For example, as described in Examples 1 to 3 described above, the available spectrum can be evaluated in consideration of the existence of the primary system, the secondary use prohibited area thereof, and the neighboring base station device 40.

As described in Example 4 above, the communication control device 60 may derive the maximum allowable transmission power information. Typically, the maximum allowable transmission power is calculated by using allowable interference power information in the primary system or its protection zone, calculation reference point information of an interference power level experienced by the primary system, registration information of the base station device 40, and a propagation loss estimation model. Specifically, as an example, calculation is performed by the following equation.

P_{MaxTx(dBm)}=I_{Th(dBm)}+PL(d)_{(dB)}

Here, P_{MaxTx(dBm)} is maximum allowable transmission power, I_{Th(dBm)} is allowable interference power, d is a distance between the reference point and the base station device 40, and PL(d)_{(dB)} is a propagation loss at the distance d. Although the antenna gain in the transceiver is not explicitly indicated in the mathematical expression, the antenna gain may be included according to a method of expressing the maximum allowable transmission power (EIRP, conducted power, etc.) or a reference point for the reception power (antenna input point, antenna output point, and the like). Furthermore, a safety margin or the like for compensating for variation due to fading may also be included. In addition, feeder loss and the like may be taken in consideration as necessary.

In addition, the above mathematical expression is described based on the assumption that the single base station device 40 is an interference source. For example, in a case where it is necessary to consider aggregated interference from a plurality of base station devices 40 at the same time, a correction value may be added. Specifically, for example, the correction value can be determined based on three types (Fixed/Predetermined, Flexible, and Flexible Minimized) of interference margin methods disclosed in Non Patent Literature 3 (ECC Report 186).

Note that, although the above mathematical expression is expressed using logarithms, the mathematical expression may naturally be converted into a true number to be used at the time of implementation. In addition, all parameters in logarithmic notation described in the present embodiment may be appropriately converted into true numbers to be used.

(1) Method 1

Furthermore, as described in the section of “Details of required parameters” above, in a case where the transmission power information is included in the query requirement information, the available spectrum can be evaluated by a method different from the above-described method. Specifically, in an exemplary case where it is assumed that desired transmission power indicated by transmission power information is used and when an estimated interfering amount is less than the allowable interference power in the primary system or its protection zone, it is determined that the frequency channel is available, and the base station device 40 (or the intermediate device 50) is notified of the frequency channel.

(2) Method 2

The above is an example in which the band use condition is calculated based on the other system related information, and the present disclosure is not limited to such an example. For example, similarly to an area of a radio environment map (REM), in a case where an area/space in which the base station device 40 can use the shared band is determined in advance, the available spectrum information may be derived based on only the position-related information and the height-related information. Furthermore, for example, in a case where a lookup table associating a position and a height with available spectrum information is prepared, the available spectrum information may also be derived based on only the position-related information and the height-related information.

The evaluation of the available spectrum does not necessarily need to be performed after reception of the query request. For example, after the normal completion of the above-described registration procedure, the communication control device 60 may proactively perform the procedure without any query request. In such a case, the communication control device 60 may create an REM or a lookup table exemplified in Method 2 or an information table similar thereto.

In any method, the radio wave utilization priority such as PAL or GAA may also be evaluated. For example, in a case where the registered device parameter or the query requirement includes information regarding the radio wave utilization priority, it is allowable to determine whether the spectrum is available based on the priority, and may make a notification. Furthermore, for example, as disclosed in Non Patent Literature 2, in a case where information regarding the base station device 40 (referred to as Cluster List in Non Patent Literature 6 (WINNF-TS-0112)) that performs high priority use (for example, PAL) is registered in the communication control device 60 in advance by the user, evaluation may be performed based on the information.

After the evaluation of the available spectrum is completed, the communication control device 60 notifies the base station device 40 (or the intermediate device 50) of the evaluation result (step S24). The base station device 40 may select a desired communication parameter by using the evaluation result received from the communication control device 60.

<5-3. Spectrum Grant Procedure>

The spectrum grant procedure is a procedure needed for the base station device 40 to receive secondary use grant of a spectrum from the communication control device 60. Typically, after normal completion of the registration procedure, one or more communication systems including the base station device 40 or the plurality of base station devices 40 notify the communication control device 60 of a spectrum grant request including information by which the base station device 40 can be specified, thereby starting the procedure. This notification may be performed by the intermediate device 50. Note that “after normal completion of the registration procedure” also implies that the available spectrum query procedure does not necessarily need to be performed.

As described above, the description of the “base station device 40” can be replaced with a word indicating another communication device having a wireless communication function. Furthermore, the description of “intermediate device 50” can also be replaced with a word indicating a communication system that substitutes (represents) another communication device, such as a proxy system.

In the present invention, it is assumed that at least the following two types of spectrum grant request method are usable.

Designation method

Flexible method

The designation method is a request method in which the base station device 40 designates at least a frequency band channel desired to be used and the maximum transmission power as desired communication parameters and requests the communication control device 60 to permit operation based on the desired communication parameters. The parameters are not necessarily limited to these parameters, and parameters specific to the wireless interface technology (such as a modulation scheme and a duplex mode) may be designated. In addition, information indicating radio wave utilization priority such as PAL and GAA may be included in the parameter.

The flexible method is a request method in which the base station device 40 designates only a requirement regarding a communication parameter and requests the communication control device 60 to designate a communication parameter that can achieve secondary use grant while satisfying the requirement. A requirement for a communication parameter can include bandwidth or a desired maximum transmission power or a desired minimum transmission power. The parameters are not necessarily limited to these parameters, and parameters specific to the wireless interface technology (such as a modulation scheme and a duplex mode) may be designated. Specifically, for example, one or more parameters of TDD Frame Configurations may be selected in advance and notified.

In any manner, a measurement report may be included in the request. The measurement report includes a result of measurement performed by the base station device 40 and/or the terminal device 30. The report can include not only raw data but also processed information, for example. For example, it is possible to use standardized metrics represented by Reference Signal Received Power (RSRP), Reference Signal Strength Indicator (RSSI), and Reference Signal Received Quality (RSRQ).

The scheme information used by the base station device 40 may be registered in the communication control device 60 at the time of the registration procedure described in <5-1>.

(Details of Spectrum Grant Process)

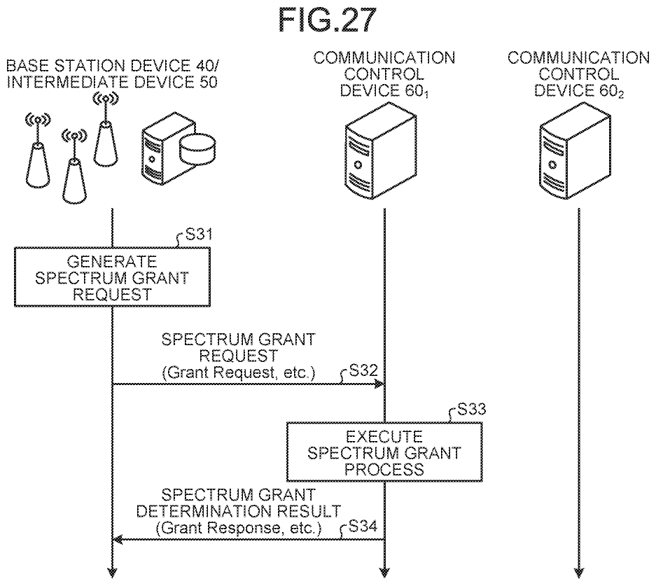

FIG. 27 is a sequence diagram illustrating a spectrum grant procedure. One or more communication systems including the base station device 40 or the plurality of base station devices 40 generate a spectrum grant request including information by which the base station device 40 can be specified (step S31) and notify the communication control device 60 of the request (step S32). The generation and/or notification of the request may be performed by the intermediate device 50.

After acquiring the spectrum grant request, the communication control device 60 performs spectrum grant process based on the spectrum grant request method (step S33). For example, using the methods described in <5-2. Available spectrum query procedure>, the communication control device 60 can perform the spectrum grant process in consideration of the existence of the primary system, the secondary use prohibited area thereof, and the base station device 40 in the neighborhood.

In a case where the flexible method is used, the communication control device 60 may derive the maximum allowable transmission power information using the method described in Details of available spectrum evaluation process” of <5-2. Available spectrum query procedure>. Typically, the communication control device 60 calculates the maximum allowable transmission power by using allowable interference power information in the primary system or its protection zone, calculation reference point information of an interference power level experienced by the primary system, registration information of the base station device 40, and a propagation loss estimation model. For example, the communication control device 60 calculates the maximum allowable transmission power by the following equation.

P_{MaxTx(dBm)}=I_{Th(dBm)}+PL(d)_{(dB)}

Here, P_{MaxTx(dBm)} is maximum allowable transmission power, I_{Th(dBm)} is allowable interference power, d is a distance between the reference point and the base station device 40, and PL(d)_{(dB)} is a propagation loss at the distance d. Although the antenna gain in the transceiver is not explicitly indicated in the mathematical expression, the mathematical expression may be transformed according to a method of expressing the maximum allowable transmission power (EIRP, conducted power, etc.) or a reference point for the reception power (antenna input point, antenna output point, and the like). Furthermore, a safety margin or the like for compensating for variation due to fading may also be included. In addition, feeder loss and the like may be taken in consideration as necessary.

In addition, the above mathematical expression is described based on the assumption that the single base station device 40 is an interference source. For example, in a case where it is necessary to consider aggregated interference from a plurality of base station devices 40 at the same time, a correction value may be added. Specifically, for example, the correction value can be determined based on three types of method (Fixed/Predetermined, Flexible, and Flexible Minimized) disclosed in Non Patent Literature 3 (ECC Report 186).

Various models can be used as the propagation loss estimation model. When a model is designated for each application, it is desirable to use the designated model. For example, in Non Patent Literature 6 (WINNF-TS-0112), a propagation loss model such as Extended Hata (eHATA) or Irregular Terrain Model (ITM) is adopted for each application. Certainly, during implementation of the present invention, the propagation loss model does not need to be limited thereto.

The propagation loss estimation model requires radio wave propagation path information depending on the model. This may include, for example, information indicating presence or absence of line of sight (LOS/NLOS), terrain information (undulations, sea levels, etc.), environmental information (Urban, Suburban, Rural, Open Sky, etc.), and the like. In using the propagation loss estimation model, these pieces of information may be estimated from the communication device registration information or primary system information. Alternatively, when there is a pre-designated parameter, it is desirable to use the pre-designated parameter for that item.

In a predetermined application, when a model is not designated, the model may be selectively used as necessary. As a specific example, for example, it is possible to selectively use models in such a way as to use a model that calculates the loss as low such as a free space loss model when estimating the interfering power to another base station device 40 and use a model that calculates the loss as high when estimating the coverage of the base station device 40.

In addition, in a case where the designation method is used, as an example, the spectrum grant process can be performed by evaluating the interference risk. Specifically, in an exemplary case where it is assumed that desired transmission power indicated by transmission power information is used and when an estimated interfering amount is less than the allowable interference power in the primary system or its protection zone, it is determined that the use of the frequency channel can be granted, and the base station device 40 (or the intermediate device 50) is notified of the frequency channel.

In any method, the radio wave utilization priority such as PAL or GAA may also be evaluated. For example, in a case where the registered device parameter or the query requirement includes information regarding the radio wave utilization priority, it is allowable to determine whether the spectrum is available based on the priority, and may make a notification. Furthermore, for example, as disclosed in Non Patent Literature 2, in a case where information regarding the base station device 40 (referred to as Cluster List in Non Patent Literature 6 (WINNF-TS-0112)) that performs high priority use (for example, PAL) is registered in the communication control device 60 in advance by the user, evaluation may be performed based on the information.

The spectrum grant process does not necessarily have to be performed when the spectrum grant request is received. For example, after normal completion of the registration procedure described above, the communication control device 60 may proactively perform the spectrum grant process without any spectrum grant request. Furthermore, for example, the spectrum grant determination process may be performed at regular intervals. In such a case, it is allowable to create the REM and the lookup table exemplified in Method 2 of <5-2. Available spectrum query procedure> or an information table similar to these tables. That is, the communication control device 60 can quickly return a response after receiving the spectrum grant request.

After completion of the spectrum grant process, the communication control device 60 notifies the base station device 40 of the determination result (step S34).

<5-4. Spectrum Use Notification/Heartbeat>

The spectrum use notification/heartbeat is a procedure in which the base station device 40 or the intermediate device 50 notifies the communication control device 60 of the spectrum use based on the communication parameter allowed to be used in the spectrum grant procedure. This is also referred to as a heartbeat. Typically, the procedure is started when the base station device 40 or the intermediate device 50 has notified the communication control device 60 of a notification message including information by which the base station device 40 can be specified.

As described above, the description of the “base station device 40” can be replaced with a word indicating another communication device having a wireless communication function. Furthermore, the description of “intermediate device 50” can also be replaced with a word indicating a communication system that substitutes (represents) another communication device, such as a proxy system.

This procedure is desirably performed periodically until the use of the spectrum is rejected from the communication control device 60. After this procedure is normally completed, the base station device 40 may start or continue radio transmission. For example, when the state of the grant indicated Granted, the state of the grant transitions to Authorized as a result of the success of this procedure. In addition, when the state of the grant indicated Authorized, failure of this procedure causes the state of the grant to transition to Granted or Idole.

Here, the grant is authorization for radio transmission given by the communication control device 60 (for example, SAS) to the base station device 40 (for example, CBSD). The grant is described, for example, in Non Patent Literature 2. According to Non Patent Literature 2, a signaling protocol between a database (SAS) and a base station (CBSD) for spectrum sharing of 3550-3700 MHz in the United States is standardized. In this standard, the authorization for radio transmission given by SAS to CBSD is referred to as a “grant”. The operational parameters permitted in the grant are defined in two parameters, namely, maximum allowable equivalent isotropic radiated power (EIRP) and a frequency channel. That is, in order to perform radio transmission using a plurality of frequency channels, CBSD needs to acquire a plurality of grants from SAS.

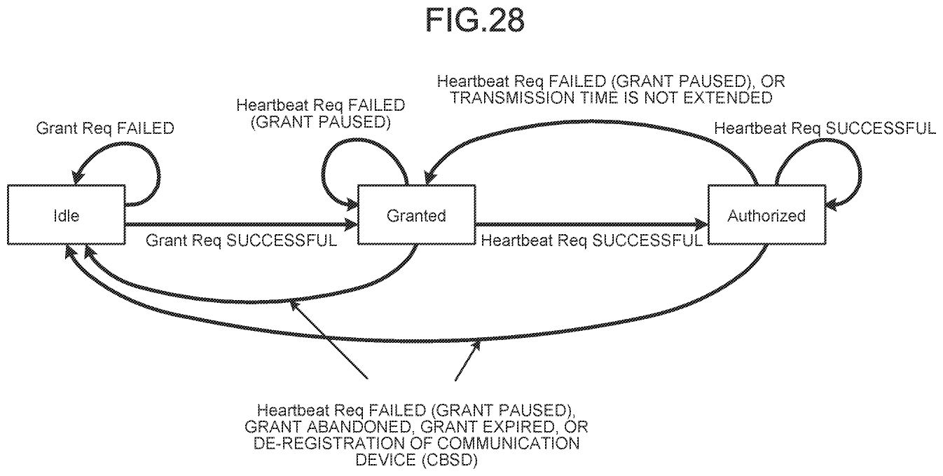

The grant has defined states indicating radio transmission permission states. Examples of the states indicating the radio transmission permission states include a Granted state and an Authorized state. FIG. 28 is a state transition diagram illustrating a radio transmission permission state. In FIG. 28, the Granted state indicates a state of holding a grant but being prohibited from performing radio transmission, while the Authorized state indicates a state in which radio transmission is permitted based on an operational parameter value defined in the grant. These two states transition according to a result of a heartbeat procedure defined in the same standard.

In the following description, the spectrum use notification/heartbeat will be sometimes referred to as a heartbeat request or simply a heartbeat. In addition, a transmission interval of a heartbeat request may be referred to as a heartbeat interval. Note that the description of a heartbeat request or a heartbeat in the following description can be appropriately replaced with another description indicating “a request for starting or continuing radio transmission”. Similarly, the heartbeat interval can also be replaced with another description (for example, the transmission interval) indicating the transmission interval of the spectrum use notification/heartbeat.

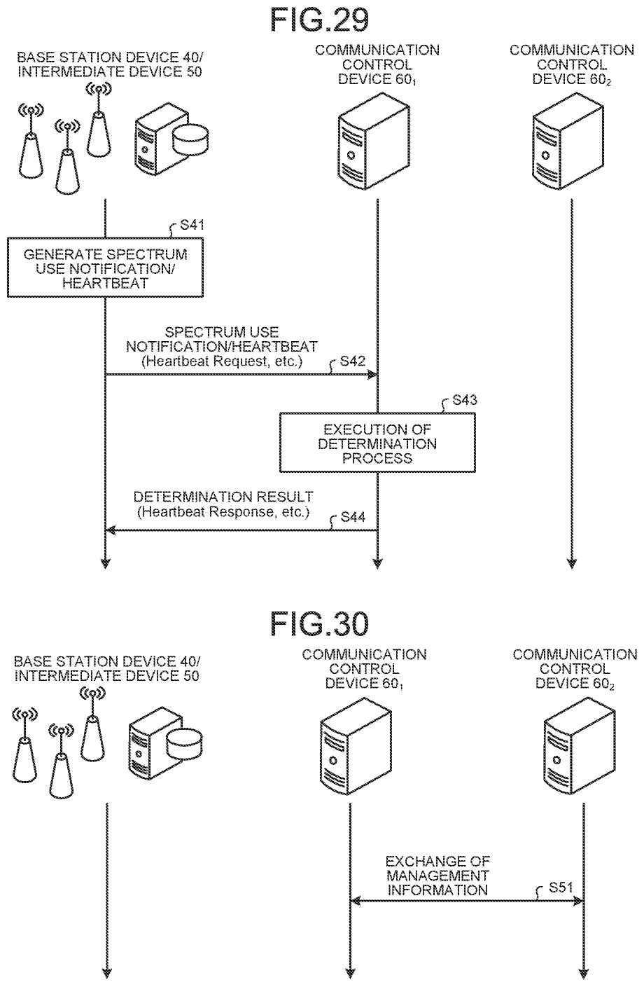

FIG. 29 is a sequence diagram illustrating a spectrum use notification/heartbeat procedure. One or more communication systems including the base station device 40 or the plurality of base station devices 40 generate a notification message including information by which the base station device 40 can be specified (step S41) and notify the communication control device 60 of the message (step S42). The generation and/or notification of the message may be performed by the intermediate device 50.

After receiving the spectrum use notification/heartbeat, the communication control device 60 may determine whether the start/continuation of the radio transmission is permitted (step S43). Examples of the determination method include confirmation of the spectrum use information of the primary system. Specifically, the start/continuation permission or refusal for the radio transmission can be determined based on a change in the spectrum used by the primary system, a change in the status of spectrum used by the primary system with no steady use of radio waves (for example, in-ship radar), or the like.

After the determination process is completed, the communication control device 60 notifies the base station device 40 (or the intermediate device 50) of the determination result (step S44).

In the present procedure, a communication parameter reconfiguration command may be issued from the communication control device 60 to the base station device 40 (or the intermediate device 50). Typically, the reconfiguration command can be executed in response to the spectrum use notification/heartbeat. For example, recommended communication parameter information can be provided. The base station device 40 (or the intermediate device 50) to which the recommended communication parameter information has been provided desirably performs the spectrum grant procedure described in <5-4> again using the recommended communication parameter information.

<5-5. Supplement to Various Procedures>

Here, the various procedures do not necessarily need to be individually implemented as described below. For example, the two different procedures may be implemented by substituting a third procedure with the roles of the two different procedures. Specifically, the registration request and the available spectrum information query request may be integrally notified, for example. Furthermore, for example, the spectrum grant procedure and the spectrum use notification/heartbeat may be integrally performed. It is of course allowable to set the number of combinations to three or more, not limited to these combinations. Furthermore, the above procedure may be separately performed.

In addition, in a case where the present embodiment is applied for the purpose of spectrum sharing with an incumbent system, it is desirable that appropriate procedures or equivalent procedures are selected and used based on the radio law related to the frequency band in a country or region in which the technology of the present embodiment is implemented. For example, in a case where registration of a communication device is required to use a specific frequency band in a specific country or region, it is desirable to perform the registration procedure.

In addition, the expression of “acquiring information” or an expression equivalent thereto in the present embodiment does not necessarily mean that the information is acquired precisely following the procedure described above. For example, even with a description that the location information of the base station device 40 is used in the available spectrum evaluation process, it means it is not always necessary to use the information acquired in the registration procedure. For example, when the location information is included in the available spectrum query procedure request, the location information may be used. In other words, this means that the described parameters may be included in other procedures within the scope described in the present embodiment and within the scope of technical feasibility.

Furthermore, information that can be included in the response from the communication control device 60 to the base station device 40 (or the intermediate device 50) described in the above procedure may be notified by push notification. As a specific example, available spectrum information, recommended communication parameter information, radio transmission continuation/refusal notification, and the like may be notified by push notification.

<5-6. Various Procedures Related to Terminal Device>

Hereinabove, the description has been made assuming mainly the communication device (Type A). However, in some embodiments, there is an assumable scenario in which communication parameters are under management of the communication control device 60, that is, communication parameters are determined by the communication control device 60 not only for the communication device (Type A) but also for the terminal device 30 and the communication device (Type B) including the terminal device 30. Even in these cases, individual procedures described in <5-1> to <5-4> are usable. However, unlike the communication device (Type A), the terminal device 30 and the communication device (Type B) need to use the spectrum managed by the communication control device 60 for the backhaul link, and cannot perform radio transmission without permission. Therefore, it is desirable to start backhaul communication for the purpose of accessing the communication control device 60 only after the detection of a radio wave or an authorization signal transmitted by the serving communication device or the master communication device.

On the other hand, under the management of the communication control device 60, it is desirable to set allowable communication parameters for the purpose of primary system protection also in the terminal device 30 and the communication device (Type B). However, the communication control device 60 has no prior knowledge of location information and the like regarding these devices. These devices are also likely to have mobility. That is, the location information is dynamically updated. Depending on the legal system, when the change in the location information is a certain level or more, re-registration to the communication control device 60 would be required in some cases.

In consideration of these various use modes of terminal and communication devices, in an operation mode of TVWS defined by the Office of Communication (Ofcom) (refer to Non Patent Literature 4), the following two types of communication parameters are defined.

Generic operational parameters

Specific operational parameters

The generic operational parameters are communication parameters defined as “operational parameters usable by any slave WSD located within the coverage area of a predetermined master WSD (corresponding to the base station device 40)” in the Non Patent Literature. The parameter is characterized by being calculated by the WSDB without using the location information of the slave WSD.

The generic operational parameters can be provided by unicast/broadcast from a communication device (for example, the base station device 40) that is already permitted to perform radio transmission by the communication control device 60. For example, a broadcast signal represented by Contact Verification Signal (CVS) defined in FCC rule Part 15 Subpart H can be used for providing the information. Alternatively, the information may be provided by a broadcast signal specific to a wireless interface. This enables the generic operational parameters to be handled as communication parameters to be used by the terminal or the communication device (Type B) in radio transmission for the purpose of accessing the communication control device 60.

The specific operational parameters are communication parameters defined as “parameters that can be used by a specific slave White Space Device (WSD)” in the Non Patent Literature. In other words, the parameter is a communication parameter calculated by using the device parameter of the slave WSD corresponding to the terminal. The parameter is characterized by being calculated by a White Space Database (WSDB) using the location information of the slave WSD.

<5-7. Procedure Occurring Between Communication Control Devices>

(Information Exchange)

The communication control device 60 can exchange management information with another communication control device 60. FIG. 30 is a sequence diagram illustrating a management information exchange procedure. In the example of FIG. 30, the communication control device 60₁ and the communication control device 60₂ exchange information. Note that the communication control device that exchanges information is not limited to the two devices, namely, the communication control device 60₁ and the communication control device 60₂.

It is desirable that, in the management information exchange procedure, at least the following information is to be exchanged.

Information related to communication device

Area information

Protection target system information

The information related to the communication device includes at least registration information and communication parameter information regarding the communication device (for example, the base station device 40) operating under permission of the communication control device 60. Registration information of a communication device that having no permitted communication parameter may be included.

The communication device registration information is typically a device parameter of the base station device 40 to be registered in the communication control device 60 in the registration procedure. There is no need to exchange all the registered information. For example, there is no need to exchange information that might correspond to personal information. Furthermore, when the communication device registration information is exchanged, information that has undergone encryption or obfuscation may be exchanged. For example, information converted into a binary value or information signed using an electronic signature mechanism may be exchanged.

Typically, the communication device communication parameter information is information related to a communication parameter currently used by the base station device 40. It is desirable that the information includes at least information indicating the spectrum being used and the transmission power. The information may include other communication parameters.

The area information is typically information indicating a predetermined geographical zone. The information can include zone information of various attributes in various modes.

For example, the information may include protection zone information of the base station device 40 to be a high priority secondary system such as PAL Protection Area (PPA) disclosed in Non Patent Literature 6 (WINNF-TS-0112). The area information in this case can be expressed by a set of three or more geolocation coordinates, for example. Furthermore, for example, in a case where a plurality of communication control devices 60 can refer to a common external database, the information can be expressed by an ID indicating the information.

Furthermore, the information may include information indicating the coverage of the base station device 40, for example. The area information in this case can also be expressed by a set of three or more geolocation coordinates, for example. Furthermore, for example, the information can also be expressed by information indicating a radius size when assuming a circle having its origin in the geographical location of the base station device 40. Furthermore, for example, in a case where a plurality of communication control devices 60 can refer to a common external database that records area information, the information can be expressed by an ID indicating the information.

Furthermore, as another aspect, the area information can include information regarding an area section determined in advance by the government or the like. Specifically, for example, it is possible to indicate a certain region by indicating a postal address. Furthermore, for example, a license area or the like can be similarly expressed.

Furthermore, as still another aspect, the area information does not necessarily have to express a planar area, and may express a three-dimensional space. For example, it may be expressed using a spatial coordinate system. In addition, for example, information indicating a predetermined closed space, such as a floor number, a floor, or a room number of a building, may be used.

Protection target system information is, for example, information regarding a radio system handled as Incumbent. Examples of the situation in which this information needs to be exchanged include cross-border coordination. It is highly conceivable that there are different Incumbent systems in the same band region between adjacent countries and regions. In addition, it is not always possible to acquire Incumbent information regarding the adjacent country or region even in the case of Incumbents which use the same radio system. In such a case, the protection target system information can be exchanged as necessary between communication control devices in different countries and regions to which the systems belong.

As another aspect, the protection target system information can include information regarding a secondary licensee and a radio system operated under the secondary license. The secondary licensee is specifically the lessee of the license, and for example, it is assumed that the secondary licensee uses a leased PAL from the owner and operates a radio system owned by the secondary licensed person. In a case where the communication control device independently performs lease management, the communication control device can exchange information regarding the secondary licensee and a radio system operated under the secondary license with another communication control device 60 for the purpose of protection.

These pieces of information can be exchanged between the communication control devices 60 regardless of the decision-making topology applied to the communication control device 60.

In addition, these pieces of information can be exchanged in various methods. Example of methods will be described below.

ID designation method

Period designation method

Zone designation method

Dump method

The ID designation method is a method of acquiring information corresponding to an ID assigned in advance to specify information managed by the communication control device 60 by using the ID. For example, it is assumed that the communication control device 60₁ manages a base station device 40 with ID: AAA. At this time, the communication control device 60₂ designates the ID: AAA and makes an information acquisition request to the communication control device 60₁. After receiving the request, the communication control device 60₁ searches for information of ID: AAA, and notifies the registration information and the communication parameter information of the corresponding base station device 40 as a response.

The period designation method in which a specific period is designated and information satisfying a predetermined condition can be exchanged during the period.

Examples of the predetermined condition include the presence or absence of information update. For example, in a case where acquisition of communication device information in a specific period is designated by a request, registration information regarding the base station device 40 newly registered in the period, registration information of the base station device 40 whose communication parameter has been changed, and information regarding the communication parameter, can be notified as a response.

Examples of the predetermined condition include whether the communication control device 60 has performed recording. For example, in a case where acquisition of the communication device information in a specific period is designated by the request, the registration information of the base station device 40 and the information of the communication parameter recorded by the communication control device 60 in the specific period can be notified as a response. Furthermore, the latest information in the period can be notified. Alternatively, the update history may be notified for each piece of information.

The zone designation method is a method of designating a specific zone, and exchanging information belonging to the zone. For example, in a case where acquisition of communication device information in a specific zone is designated by a request, registration information regarding the base station device 40 installed in the zone and information regarding a communication parameter can be notified as a response.

The dump method is a method of providing all information recorded by the communication control device 60. At least information and area information regarding the base station device 40 are desirably provided by the dump method.

All the above description of the information exchange between the communication control devices 60 is based on a pull method. That is, information exchange is performed in a mode in which information corresponding to the parameter designated in the request is given as a response, and can be implemented by the HTTP GET method as an example. However, the present invention is not limited to the pull method, and information may be actively provided to another communication control device 60 by a push method. The push method can be implemented by the HTTP POST method, as an example.

(Command/Request Procedure)

The communication control device 60 may send a command and/or a request to each other. A specific example of this is reconfiguration of communication parameters of the base station device 40. For example, when it is determined that the base station device 40₁ managed by the communication control device 60₁ is experiencing a large amount of interference from the base station device 40₄ managed by the communication control device 60₂, the communication control device 60₁ may request the communication control device 60₂ to change the communication parameter of the base station device 40₄.

Another example is reconfiguration of area information. For example, when incompletion is found in calculation of the coverage information and the protection zone information regarding the base station device 40₄ managed by the communication control device 60₂, the communication control device 60₁ may request the communication control device 60₂ to reconfigure the area information. Besides this, the area information reconfiguration request may be made for various reasons.

<5-8. Information Transmission Means>

Signaling between the entities described above can be implemented via various types of media. The case of E-UTRA or 5G NR will be described as an example. As a matter of course, the embodiment is not limited to these.

(Signaling Between Communication Control Device and Communication Device)

The notification from the communication device (for example, the base station device 40 and the intermediate device 50) to the communication control device 60 may be performed in an application layer, for example. For example, the hyper text transfer protocol (HTTP) may be used for notification. Signaling can be performed by describing required parameters in a message body of the HTTP according to a predetermined format. Furthermore, in the case of using HTTP, notification from the communication control device 60 to the communication device is also performed according to the HTTP response mechanism.

(Signaling Between Communication Device and Terminal)

The notification from the communication device (for example, the base station device 40 and the intermediate device 50) to the terminal device 30 may be performed by using at least some of radio resource control (RRC) signaling, system information (SI), or downlink control information (DCI), for example. Additionally, the notification may be implemented by using at least some of downlink physical channels (Physical Downlink Control Channel (PDCCH), Physical Downlink Shared Channel (PDSCH), or Physical Broadcast Channel (PBCH)).

The notification from the terminal device 30 to the communication device may be performed by using a part of radio resource control (RRC) signaling or using uplink control information (UCI), for example. Additionally, the notification may be implemented by using uplink physical channels (Physical Uplink Control Channel (PUCCH), Physical Uplink Shared Channel (PUSCH), or Physical Random Access Channel (PRACH).

The signaling is not limited to the physical layer signaling described above, and the signaling may be performed in a higher layer. For example, at the time of implementation in the application layer, signaling may be implemented by describing a required parameter in a message body of HTTP according to a predetermined format.

(Terminal-to-Terminal Signaling)

Assumable forms of communication between one terminal device 30 and another terminal device 30 are terminal-to-terminal communication, device-to-device (D2D), and vehicle-to-everything (V2X). The terminal-to-terminal communication, D2D, and V2X may be performed using a physical sidelink channel (Physical Sidelink Control Channel (PSCCH), Physical Sidelink Shared Channel (PSSCH), or Physical Sidelink Broadcast Channel (PSBCH).

When a target frequency channel for spectrum sharing is used in the sidelink, the communication parameter may be notified, acquired, and configured in association with a sidelink resource pool in the target frequency channel. The resource pool is a sidelink radio resource set by a specific frequency resource (for example, a resource block, a component carrier, or the like) and a time resource (for example, a radio frame, a subframe, a slot, a mini-slot, or the like). In a case where the resource pool is set in the frequency channel to be subjected to spectrum sharing, the resource pool is set by at least one of RRC signaling, system information, or downlink control information from the communication device to the terminal device. In addition, the communication parameters to be applied in the resource pool and the sidelink are also set by at least one of RRC signaling, system information, or downlink control information from the communication device to the terminal device. The notification of the setting of the resource pool and the notification of the communication parameter to be used in the sidelink may be performed simultaneously or individually.

(Example of Signaling Procedure)

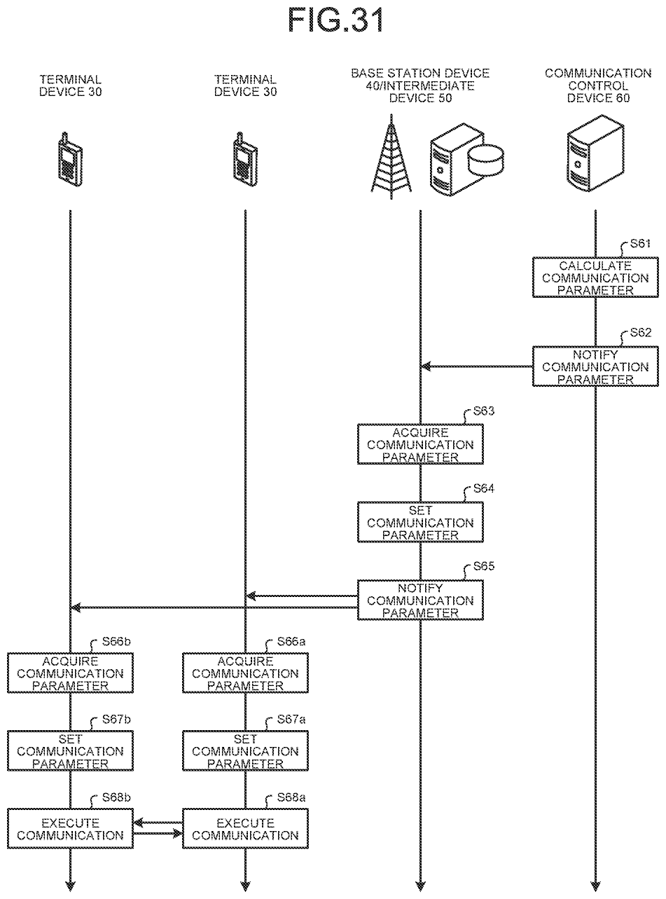

FIG. 31 is a diagram illustrating an example of a signaling procedure in a case where communication between terminal devices 30 is assumed as communication of a secondary system. Hereinafter, the signaling procedure will be described with reference to FIG. 31.

The communication control device 60 calculates a communication parameter to be used by the communication device (the base station device 40 or the intermediate device 50) of the secondary system (step S61). Subsequently, the communication control device 60 notifies the communication device of the secondary system of the communication parameter (step S62). At this time, the communication device of which the communication parameter is notified from the communication control device 60 may be the base station device 40 or the intermediate device 50. Furthermore, the communication device of which the communication parameter is notified from the communication control device 60 may be the terminal device 30. In the following description, it is assumed that the communication device of which the communication parameter is notified from the communication control device 60 is the base station device 40.

The base station device 40 acquires the communication parameter to be used by the communication device (the terminal device 30, the base station device 40, or the intermediate device 50) of the secondary system from the communication control device 60 (step S63). Subsequently, the base station device 40 sets a communication parameter to use (step S64). The base station device 40 then notifies its own subordinate communication device of a communication parameter to be used by the subordinate communication device (step S65). The subordinate communication device may be the terminal device 30 or another base station device 40. In the following description, the subordinate communication device is assumed to be the terminal device 30.

The terminal device 30 acquires a communication parameter to use from the base station device 40 (steps S66a and S66b). Subsequently, the terminal device 30 sets a communication parameter to use (steps S67a and S67b). The terminal device 30 communicates with another communication device (for example, another terminal device 30) of the secondary system (steps S68a and S68b).

<5-9. Representative Operation Flow>

Next, a representative operation flow related to interference control calculation will be described.

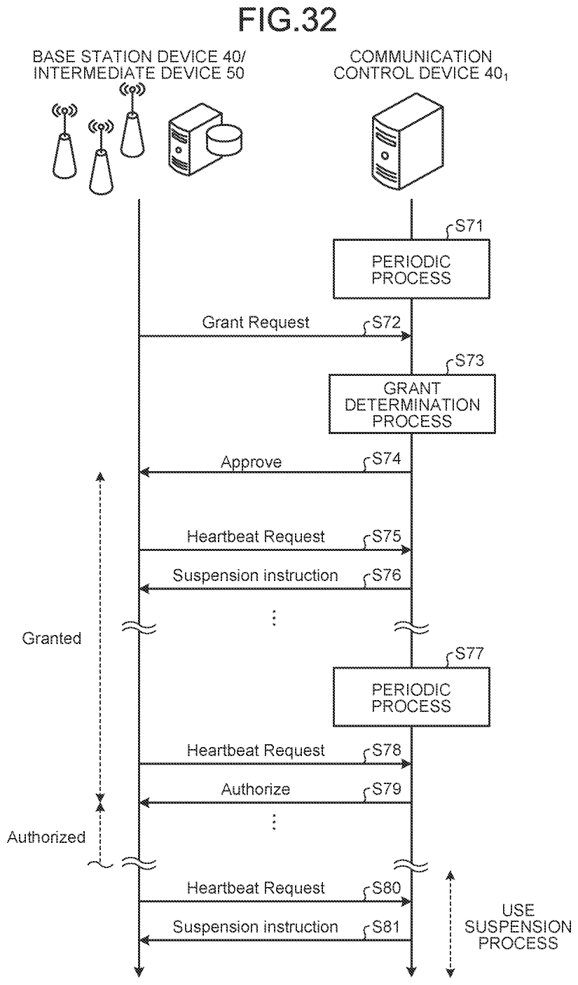

FIG. 32 is a sequence diagram illustrating an example of an operation related to a grant. Specifically, FIG. 32 is a sequence diagram illustrating an operation of the communication system 2 corresponding to procedures of <5-3. Spectrum grant procedure> and <5-4. Spectrum use notification/heartbeat>. Note that the operation flow illustrated in FIG. 32 is merely an example, and various changes are made depending on a state of the base station device 40, the communication control device 60, and the intermediate device 50, or the like.

First, the communication control device 60₁ executes a periodic process at the execution timing of the periodic process (step S71). The periodic process is a process of executing information synchronization between the communication control devices 60 and calculation related to primary system protection. An example of the periodic process is Coordinated Periodic Activities among SASs (CPAS) described in Non Patent Literature 10 and Non Patent Literature 11. In the following description, the periodic process may be referred to as periodic protection calculation. The execution timing of the periodic process is a point 24 hours after the previous execution of the periodic process, for example. Naturally, the execution interval of the periodic process is not limited to 24 hours.

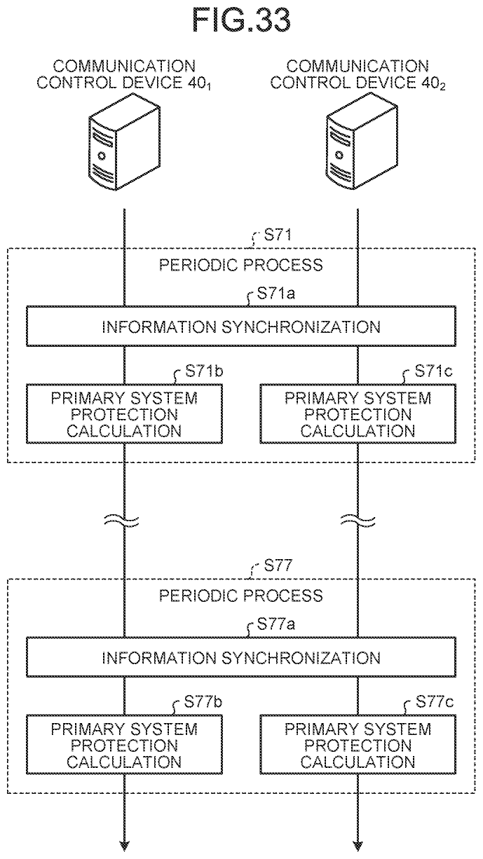

FIG. 33 is a diagram illustrating specific processing contents of the periodic process. In the example of FIG. 33, the communication control device 60₁ and the communication control device 60₂ perform information synchronization and primary system protection calculation. Note that the number of communication control devices 60 that perform periodic process (information synchronization or the like) may be more than two.

As illustrated in FIG. 33, each of the plurality of communication control devices 60 executes a periodic process (step S71). First, each of the plurality of communication control devices 60 synchronizes information with the other communication control device(s) 60 (step S71a). Subsequently, each of the plurality of communication control devices 60 performs primary system protection calculation (step S71b and step S71c). At this time, the communication control device 60 may calculate an estimated value of an interference amount, a residual interference margin, or the like that can be individually given to the primary system by each communication node (for example, the base station device 40).

Returning to FIG. 32, the base station device 40 or the intermediate device 50 transmits a grant request to the communication control device 60₁ (step S72). In the present embodiment, the base station device 40 or the intermediate device 50 adds, to the grant request, information regarding the use mode of spectrum resource (radio resource) allocated as a result of the grant request. For example, the base station device 40 or the intermediate device 50 adds information indicating “grant application and details” to the grant request.

The communication control device 60₁ acquires a grant request to which the use mode information is added. The communication control device 60₁ performs a process related to the spectrum resources (that is, a process related to grant) based on the use mode information (step S73). For example, the communication control device 60₁ performs a grant determination process for allocating an available spectrum to the base station device 40 based on the use mode information.

After allocating the spectrum, the communication control device 60₁ transmits a grant response to the base station device 40 or the intermediate device 50. In the example of FIG. 32, the communication control device 60₁ notifies the success of the grant request (Approve illustrated in FIG. 32) as the grant response (step S74). The acquisition unit 441 of the base station device 40 or the acquisition unit 541 of the intermediate device 50 acquires the grant response from the communication control device 60₁. Due to the success of the grant request, the grant state of the base station device 40 transitions from Idole to Granted as illustrated in FIG. 28. The base station device 40 performs setting of individual parts based on the allocated grant.

Subsequently, the base station device 40 or the intermediate device 50 transmits a heartbeat request to the communication control device 60₁ (step S75). Subsequently, the communication control device 60₁ acquires the transmitted heartbeat request. The communication control device 60₁ then transmits a heartbeat response.

Note that, in the example of FIG. 32, the grant allocated to the base station device 40 has not passed the periodic process (for example, CPAS) yet. Therefore, in the example of FIG. 32, the communication control device 60₁ cannot approve the start of the radio transmission. Accordingly, the communication control device 60₁ transmits a radio transmission suspension instruction as a heartbeat response (step S76).

Thereafter, the base station device 40 or the intermediate device 50 continues to transmit the heartbeat request at the heartbeat interval notified from the communication control device 60₁. In response to the heartbeat request, the communication control device 60₁ continues to transmit the radio transmission suspension instruction as a heartbeat response until the next periodic process is completed.

When the execution timing of the periodic process arrives, each of the plurality of communication control devices 60 including the communication control device 60₁ executes the periodic process (step S77). For example, as illustrated in FIG. 33, each of the plurality of communication control devices 60 synchronizes information with the other communication control device(s) 60 (step S77a). Subsequently, each of the plurality of communication control devices 60 performs primary system protection calculation (step S77b and step S77c). This protection calculation is an example of interference calculation of the present embodiment.

Subsequently, the base station device 40 or the intermediate device 50 transmits a heartbeat request to the communication control device 60₁ (step S78). Subsequently, the communication control device 60₁ acquires the transmitted heartbeat request. Next, the communication control device 60₁ transmits the heartbeat response. At this time, since the grant allocated to the base station device 40 has passed the periodic process, the communication control device 60₁ can approve the start of the radio transmission of the base station device 40 that has transmitted the heartbeat request. Accordingly, the communication control device 60₁ transmits success (Authorize illustrated in FIG. 32) of the heartbeat response as the heartbeat response (step S79). As a result of the success of the heartbeat request, the grant state of the base station device 40 transitions from Granted to Authorized as illustrated in FIG. 28. The base station device 40 performs radio communication by controlling the radio communication unit 41 based on the allocated grant.

As described above, the state of the grant (the state indicating the radio transmission permission state) transitions according to the result of the heartbeat procedure. One purpose among various purposes defined in the heartbeat procedure is a radio wave suspension instruction of the base station device 40 at the time of use of the radio wave by incumbent systems (for example, in-ship radar) in the same band. For example, when it is determined that an incumbent system such as the communication system 1 is using radio waves, the communication control device 60 must suspend radio waves of all the base station devices 40 that can cause interference within a predetermined time (for example, within 300 seconds). At this time, push notification of the suspension instruction is assumed to be complicated in implementation, the communication control device 60 may issue the radio wave suspension instruction using a heartbeat response. In the following description, a process for causing the base station device 40 to suspend the use of the spectrum resources, which is executed by the communication control device 60, is referred to as a “spectrum resource use suspension process” or a “grant suspension process”.

For example, the base station device 40 or the intermediate device 50 transmits a heartbeat request to the communication control device 60₁ (step S70). Subsequently, the communication control device 60₁ acquires the transmitted heartbeat request. The communication control device 60₁ then determines whether a primary system such as the communication system 1 is using radio waves. When it is determined that the primary system is performing radio wave utilization related to a predetermined spectrum resource, the communication control device 60₁ transmits a radio transmission suspension instruction as a heartbeat response (step S71). The base station device 40 suspends the transmission of the radio wave related to the predetermined spectrum resource. With this procedure, the grant state of the base station device 40 transitions from Authorized to Idle (or Granted) as illustrated in FIG. 28. Alternatively, as illustrated in FIG. 28, the grant state of the base station device 40 transitions from Granted to Idole.

### 6. Operation Related to Allocation of Interference Margin

Next, operations related to the allocation of the interference margin of the present embodiment will be described using the operation of the communication control device 60 as an example.

<6-1. Operation According to Conventional IAP>

First, an operation according to a conventional IAP will be described. In the conventional IAP, the following Processes (a) to (d) are performed.

Process (a)

In Process (a), first, an interference margin is provisionally and equally allocated to all grants corresponding to the second radio system (protection point or protection area) to be the interference calculation target. That is, the total interference margin allowed by the first radio system is provisionally and equally allocated to each of a plurality of second radio systems which are interference calculation targets.

Process (b)

Subsequently, in Process (b), in a case where the interfering amount (estimated interfering amount) estimated based on the grant is less than (less than or equal to) the interference margin (provisionally allocated interference margin) provisionally equally-allocated in Process (a), the estimated interfering amount will be set as an interference margin allocation amount. Note that a grant in which the interfering amount is smaller than the provisionally allocated interference margin is referred to as a satisfied grant, and a grant in which the amount of interference is larger than the provisionally allocated interference margin is referred to as an unsatisfied grant. Hereinafter, the difference between the provisionally allocated interference margin and the interference margin allocation amount is referred to as a surplus margin (surplus interference amount).

Process (c)

Subsequently, in Process (c), the total amount of the surplus margin is equally divided and reallocated to one or more unsatisfied grants. When the estimated interfering amount obtained by reallocation is less than the provisionally allocated interference margin after the reallocation, the estimated interfering amount is set as the interference margin allocation amount. Note that, according to Process (c), an unsatisfied grant in which the estimated interfering amount is less than the provisionally allocated interference margin after reallocation is handled as a satisfied grant.

Process (d)

Subsequently, Process (d) is performed in a case where an unsatisfied grant remains even after the Process (c). Specifically, in Process (d), in a case where a surplus margin occurs in Process (c), the total amount of the surplus margin is equally divided and reallocated to the unsatisfied grants, and then Process (c) is repeated. In a case where no surplus margin occurs in the Process (c) (no more grant to be handled as a satisfied grant), the transmission power of the unsatisfied grant is lowered by 1 dB, and Process (c) is repeated again. Process (d) is repeated until there is no unsatisfied grant.

<6-2. Case of Allocation Prioritization>

The present embodiment performs allocation prioritization to improve the conventional IAP. Note that the following two cases are assumed for allocation prioritization.

Case 1: Allocation prioritization by authorization status

Case 2: Allocation prioritization by required parameters

<Case 1: Allocation Prioritization by Authorization Status>

Here, the authorization status is typically information indicating tiers such as PAL/GAA. That is, the authorization status is information related to the second radio system, and more specifically, is information related to the hierarchy of the CBRS. Note that, even in the same tier, there may be an equivalent rank in the tier. In the present description, the term PAL/GAA is used, but is not limited thereto in practice. This example is expected to be effective, for example, in the following situation or a situation equivalent thereto.
Protection of Incumbent Tier
Protection from other PALs or GAA for specific PAL

In the case of performing allocation prioritization by an authorization status, the IAP is improved as described in the following Processes (a-1) to (c-1).

Process (a-1)

In Process (a-1), first, all grants as interference calculation targets are grouped into upper and lower groups by an authorization status. For example, PAL is grouped into the upper group and GAA is grouped into the lower group. Specifically, the communication control device 60 first acquires information (authorization status) related to the second radio system, and calculates the allocation priority based on the acquired information. Subsequently, the communication control device 60 groups a plurality of second radio systems into the upper group and the lower group according to the allocation priority. Note that the number of groups to be formed by grouping may be three or more. Furthermore, as described above, the communication control device 60 preferably sets the allocation priority such that the higher (PAL) the second radio system in the hierarchy of CBRS, the higher the allocation priority.

Process (b-1)

In Process (b-1), Processes (a) to (d) which are conventional IAPs are applied to the grants of the upper group. That is, the communication control device 60 allocates the interference margin of the same amount as the interfering amount estimated based on the grant by applying the conventional IAP to each of the plurality of second radio systems included in the upper group. In addition, the interference margin (surplus margin) that is surplus in the upper group is reallocated to the lower group, details of which will be described below. That is, the communication control device 60 increases the interference margin to be allocated to the plurality of groups such that the upper the group with higher allocation priority, the more the interference margin to be allocated. This increases the opportunity to allocate the interference margin to the group having the higher allocation priority, making it possible to increase the radio wave utilization opportunity.

Process (c-1)

In Process (c-1), the communication control device 60 checks the surplus margin after completion of Process (b-1). Subsequently, in a case of occurrence of a surplus margin, that is, in a case where there is a surplus margin even after the communication control device 60 has allocated the interference margin of the same amount as the interfering amount to all of the plurality of second radio systems included in the upper group, the communication control device 60 allocates the surplus margin to the lower group. In other words, the communication control device 60 provisionally and equally allocates the total interference amount (the total interference amount allowed by the first radio system) to each of the plurality of second radio systems included in the upper group, and in a case where the provisionally and equally allocated interference amount (the provisional interference amount) exceeds the interfering amount, the communication control device 60 reallocates the surplus margin to other second radio systems included in the lower group.

Note that Processes (a) to (d) that are conventional IAPs are applied as the allocation method. That is, the communication control device 60 allocates the interference margin of the same amount as the interfering amount estimated based on the grant by applying the conventional IAP to each of the plurality of second radio systems included in the lower group. Since the presence of the surplus margin is synonymous with the presence of a spatially unused radio spectrum, this allocation method makes it possible to improve the spectrum use efficiency. In addition, the target of reallocation is unsatisfied grants. That is, the communication control device 60 reallocates the surplus margin to the second radio system in which the provisional interference amount is less than the interfering amount. With this reallocation, more unsatisfied grants will be able to be handled as satisfied grants.

In addition, in a case where no surplus margin occurs, the interference margin allocation to the lower group is abandoned. That is, the grant allocation is terminated. When the grant allocation is terminated, the communication control device may notify the communication device of termination of the grant allocation as a response (for example, a heartbeat response) to the spectrum use notification/heartbeat request. That is, when there is the second radio system in which there is no surplus margin and the provisional interference amount is less than the interfering amount in the lower group (or the upper group), the communication control device 60 terminates the authorization (grant) of the radio transmission for the second radio system.

Note that, when there is a plurality of protection points (or the second radio system) to be interference calculation targets, there is a case where the interference margin remains even after execution of Processes (a-1) to (c-1). This is because, for example, there is an assumable situation in which, when there are two protection points being interference calculation targets for a certain grant, the IAP for one protection point is a satisfied grant without lowering the transmission power, while the IAP for the other protection point can be a satisfied grant only after lowering the transmission power. In such a case, from the viewpoint of protection against interference, restriction is performed on the side of the lower transmission power, and as a result, a surplus margin occurs on the grant side that has become a satisfied grant without lowering the transmission power.

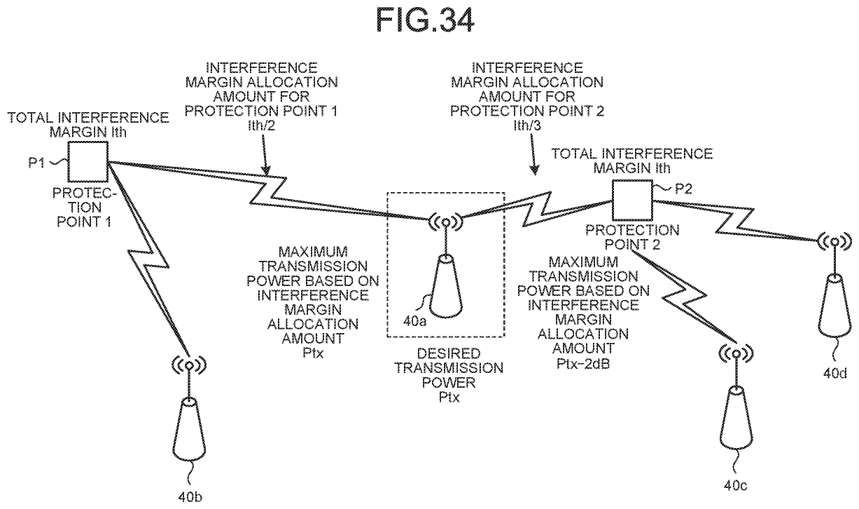

FIG. 34 is a diagram in a case where there are a plurality of protection points to be interference calculation targets. FIG. 34 illustrates a case where a base station device 40a being the second radio system includes two protection points P1 and P2 being interference calculation targets. This also illustrates a case where the protection point P1 equally allocates the interference margin to two base station devices 40a and 40b, while the protection point P2 equally allocates the interference margin to three base station devices 40a, 40c, and 40d.

As illustrated in FIG. 34, the protection point P2 includes the larger number of base station devices as an allocation target than the protection point P1, and naturally is provided with less interference margin allocated to one base station device. Therefore, regarding the base station device 40a, the maximum transmission power based on the interference margin is lower at the protection point P2 than at the protection point P1.

Therefore, in such a case, the maximum transmission power for the protection point P1 is limited to the maximum transmission power for the protection point P2 in the base station device 40a. In the example illustrated in FIG. 34, since the base station device 40a has transmission power of Ptx-2 dB, leading to occurrence of a surplus margin that is not utilized on the protection point P1 side.

Therefore, in a case where there is a plurality of protection points, the method described in the ECC report 186 is utilized for improvement as in the following Processes (a-2) to (f-2).

Process (a-2)

In Process (a-2), first, all grants as interference calculation targets are grouped into upper and lower groups by an authorization status.

Process (b-2)

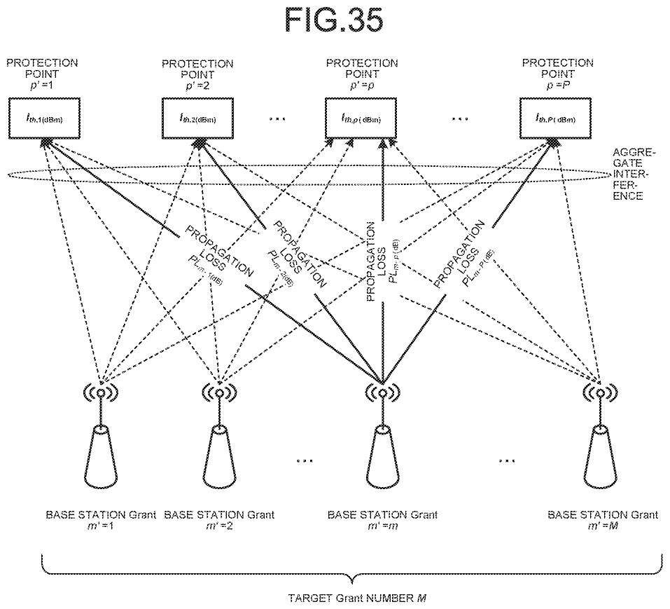

Next, Process (b-2) will be described with reference to FIG. 35. FIG. 35 is a diagram illustrating a relationship between base station devices (grants) in an upper group obtained as grouping and protection points. FIG. 35 illustrates a total number M of base station devices included in the upper group and a total number P of protection points. In Process (b-2), when the second radio system performs shared use of the radio waves used by the plurality of first radio systems, the communication control devices 60 calculates the maximum allowable transmission power in each of the plurality of first radio systems based on the acquired information regarding the second radio system. Specifically, for the m-th grant in the upper group, the communication control device 60 calculates a maximum allowable transmission power P_{TempMax, m, p (dBm)} calculated from the positional relationship between the installation position of the base station device holding the grant and each protection point by using the following Formula (2). That is, the communication control device 60 acquires information regarding the positional relationship between the first radio system and the second radio system and calculates the maximum allowable transmission power.

P_{TempMax,m,p(dBm)}=I_{th,p(dBm)}−10 log(M)_{(dB)}+PL_{m-p(dB)}−SM_{(dB)} (2)

In the above Formula (2), 10 log(M)_{(dB)} is a fixed margin, and Ith,p(dBm) is a total interference margin. That is, Ith,p(dBm)−10 log(M) can be regarded as the provisionally allocated interference margin. Note that Ith,p(dBm) may be a predetermined threshold. SM(dB) is a shadowing margin, and PLm-p(dB) is a propagation loss between the protection point and the base station. SM(dB) may be omitted.

The processing of the conventional IAP has not performed calculation of the maximum allowable transmission power based on the positional relationship, and has been performed based on the transmission power associated with the grant. Therefore, for example, by calculating the maximum allowable transmission power based on the positional relationship so as to initially performing the interference margin allocation only to the PAL without including the GAA being the lower group, the interference margin that can be allocated per grant is increased by the amount excluding the GAA, making it also possible to increase the surplus margin.

Process (c-2)

Subsequently, in Process (c-2), the maximum allowable transmission power is calculated for all the protection points, and a minimum value of the maximum allowable transmission power P_{TempMax,m} is derived by the following Formula (3). In addition, the protection point p_{MostVictim,m} that receives the largest interference from the m-th grant is obtained by the following Formula (4).

P_{TempMax,m}=min_{1≤p≤P}(P_{TempMax,m,p}) (3)

P_{MostVictim,m}=argmin_{1≤p≤P}(P_{TempMax,m,p}) (4)

That is, the communication control device 60 sets the interference amount in one first radio system (protection point) having the smallest maximum allowable transmission power as the interference amount in other first radio systems. With this configuration, since the maximum allowable transmission power as the reference is determined by the protection point that receives the largest interference as long as the positional relationship with the protection point does not change, it will be possible, in the subsequent processing, to handle the interfering power estimated by the maximum allowable transmission power as the reference as an appropriate interference margin allocation amount without surplus in the protection of each protection point.

Process (d-2)

Subsequently, Process (d-2) compares the maximum transmission power with the maximum allowable transmission power on the device class or hardware. That is, the communication control device 60 calculates the maximum transmission power of the second radio system based on the information regarding a transmission characteristic of the second radio system, and allocates the interference margin based on a comparison result between the maximum transmission power and the maximum allowable transmission power calculated in Process (c-2). Note that the maximum allowable transmission power is the maximum allowable transmission power between the protection point obtained by the above Formula (4) and the m-th grant.

In this comparison, the maximum allowable transmission power can greatly exceed the maximum transmission power depending on the calculation result. In other words, the calculation result of the maximum allowable transmission power might greatly exceed the transmission capability of the base station device. In other words, a surplus margin occurs in such a case, and therefore, by specifying such a surplus margin by comparing the maximum allowable transmission power with the maximum transmission power, the surplus margin can be reallocated to other grants.

The comparison result in Process (d-2) is one of the following (1) and (2). Hereinafter, the operation in each of (1) and (2) will be described.

(1) Maximum transmission power is lower

(2) Maximum allowable transmission power is lower

(1) Maximum Transmission Power is Lower

In such a case, comparison between the transmission power associated with the m-th grant and the maximum transmission power is performed.

(1-1) Transmission Power is Lower

In such a case, the m-th grant is handled as a satisfied grant. Next, the interference margin allocation amount is calculated by the following Formula (5).

IM_{m,p(dBm)}=P_{Max,m(dBm)}−PL_{m-p(dBm)}+SM_{(dB)} for all p (5)

With this operation, the estimated value of the interfering amount generated in the current parameter of the grant can be determined as the interference margin allocation amount, making it possible to avoid excessive allocation of the interference margin.

The surplus margin is calculated by the following Formula (6).

$${IM}_{Surplus , m , p ( dBm )} = 10 log ( {10}^{\frac{{I}_{th , p ( dBm )} - 10 log M}{10}} - {10}^{\frac{{IM}_{m , p ( dBm )}}{10}} ) for all p \qquad ( 6 )$$

(1-2) Maximum Transmission Power is Lower

In such a case, the m-th grant is handled as an unsatisfied grant.

(2) Maximum Allowable Transmission Power is Lower

In such a case, comparison between the transmission power associated with the m-th grant and the maximum allowable transmission power is performed.

(2-1) Transmission Power is Lower

In such a case, the m-th grant is handled as a satisfied grant. Next, the interference margin allocation amount is calculated by the following Formula (7).

IM_{m,p(dBm)}=P_{Grant,m(dBm)}−PL_{m-p(dBm)}+SM_{(dB)} for all p (7)

With this operation, the estimated value of the interfering amount generated in the current parameter of the grant can be determined as the interference margin allocation amount, making it possible to avoid excessive allocation of the interference margin.

The surplus margin is calculated by the following Formula (8).

$${IM}_{Surplus , m , p ( dBm )} = 10 log ( {10}^{\frac{{I}_{th , p ( dBm )} - 10 log M}{10}} - {10}^{\frac{{IM}_{m , p ( dBm )}}{10}} ) for all p \qquad ( 8 )$$

(2-2) Maximum Allowable Transmission Power is Lower

In such a case, the m-th grant is handled as an unsatisfied grant.

Process (e-2)

Subsequently, Process (e-2) applies Processes (a) to (d), which are conventional IAPs, to the unsatisfied grant using the total surplus margin generated in the Processes (a-2) to (d-2) described above. The total surplus margin at each protection point is calculated by the following Formula (9).

$${IM}_{Surplus , p ( dBm )} = 10 log {\sum }_{m = 1 , m \neq Unsatisfied}^{M} {10}^{\frac{{IM}_{Surplus , m , p ( dBm )}}{10}} \qquad ( 9 )$$

With this operation, the estimated value of the interfering amount generated in the current parameter of the grant can be determined as the interference margin allocation amount, making it possible to avoid excessive allocation of the interference margin.

Process (f-2)

Subsequently, Process (f-2) checks the surplus margin after Process (e-2). When the surplus margin occurs, the surplus margin is allocated to the lower group. Processes (a) to (d) that are conventional IAPs are applied as the allocation method. Note that an interference margin initial value of each protection point is set to IM_{Surplus,p(dBm)}.

In addition, in a case where no surplus margin occurs, the interference margin allocation to the lower group is abandoned. That is, the grant allocation is terminated. When the grant allocation is terminated, the communication control device may notify the communication device of termination of the grant allocation as a response (for example, a heartbeat response) to the spectrum use notification/heartbeat request.

In this manner, by performing Processes (a-2) to (f-2), the interference margin can be allocated to the upper group more efficiently and preferentially.

<Case 2: Allocation Prioritization by Required Parameters>

5G is highly expected as a communication method for realizing various use cases. However, depending on uses cases, there might be a difference in required parameters such as required transmission power, required QoS, and coverage between use cases, making it inappropriate to handle all grants equally.

Therefore, in a case, in Case 2, where allocation prioritization by a required parameter is performed, the conventional IAP is improved as described in the following Processes (a-3) to (d-3). Note that the method of Case 2 may be applied as a substitute for the IAP for the GAA in Case 1 described above. Note that the required parameter is parameter information regarding communication of the second radio system.

Process (a-3)

Process (a-3) first converts the above-described required parameters into required transmission power. That is, the communication control device 60 calculates the transmission power based on the parameter information, as allocation priority. This facilitates application of the IAP. For example, when a required Signal-to-Interference plus Noise power Ratio (SINR) is available, conversion into the required transmission power is performed by the following Formula (10).

P_{Tx,Required(dB)}=10 log[SINR_{Required}(I+N)]−PL_{(dB)}+SM_{(dB)} (10)

In the above Formula (10), PL is a propagation loss between the base station and an arbitrary point, SINR_{Required} is a required SINR at the arbitrary point, and I is reception interfering power at the arbitrary point.

Furthermore, for example, in a case where a required coverage is available, the required transmission power can be calculated by Formula (10) with the “arbitrary point” described above set to a “coverage end”.

Furthermore, for example, in a case where a required throughput is available, a required transport block size is estimated to obtain the corresponding MCS, thereby deriving the required SINR (corresponding to the reverse operation of the effective SINR mapping). The required transmission power is then calculated by the above Formula (10) using the derived required SINR. This makes it possible to perform allocation in consideration of a situation in which the throughput and the required SINR are not necessarily proportional depending on the position.

Process (b-3)

In Process (b-3), all grants as interference calculation targets are grouped into a plurality of groups based on the required transmission power calculated in (a-3). That is, the communication control device 60 handles the transmission power as the allocation priority and performs grouping. For example, the grouping is performed into a high-output (high transmission power) upper group and a low-output lower group.

Note that the number of groups to be obtained by grouping may be three or more. In addition, for example, grouping using a device class may be performed into a group including a device that belongs category B and a group including a device that belongs category A.

Furthermore, for example, a range in units of several dBm may be created for the grouping. For example, a group of 10-15 dBm and a group of 15-20 dBm may be formed by the grouping.

Note that, among the plurality of groups, for example, a higher priority is preferably given to a high-output group. This makes it possible to perform allocation preferentially to a high-output group that requires a larger interference margin. In addition, in such a case, even when the surplus margin after the allocation to the high-output upper group is allocated to the low-output lower group, the necessary interference margin is relatively small, leading to the sufficient handling of the margin.

Note that higher priority may be given to low-output groups. This makes it possible to reliably allocate the interference margin to the low-output groups.

Process (c-3)

In Process (c-3), Processes (a) to (d) which are conventional IAPs are applied in order from the highest group. That is, the communication control device 60 allocates the interference margin to each of the second radio systems based on the transmission power. This increases the opportunity to allocate the interference margin to the group having the higher transmission power (higher output) as allocation priority, making it possible to increase the radio wave utilization opportunity.

Process (d-3)

Process (d-3) checks the surplus margin after Process (c-3). When the surplus margin occurs, the surplus margin is allocated to the lower group. Processes (a) to (d) that are conventional IAPs are applied as the allocation method. Since the presence of the surplus margin is synonymous with the presence of a spatially unused radio spectrum, this allocation method makes it possible to achieve improvement of the spectrum use efficiency.

In addition, in a case where no surplus margin occurs, the interference margin allocation to the lower group is abandoned. That is, the grant allocation is terminated. When the grant allocation is terminated, the communication control device may notify the communication device of termination of the grant allocation as a response (for example, a heartbeat response) to the spectrum use notification/heartbeat request.

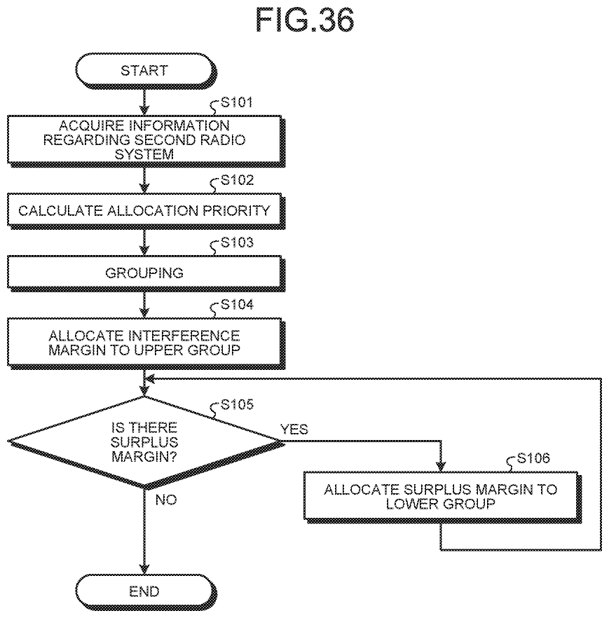

Next, a procedure of an interference margin allocation process executed by the communication control device 60 according to the embodiment will be described with reference to FIG. 36. FIG. 36 is a flowchart illustrating a procedure of an interference margin allocation process.

As illustrated in FIG. 36, communication control device 60 first acquires information related to a plurality of second radio systems that share radio waves used by the first radio system (step S101).

Subsequently, the communication control device 60 calculates the allocation priority for each of the plurality of second radio systems based on the acquired information (step S102).

Subsequently, the communication control device 60 groups the plurality of second radio systems into a plurality of groups based on the allocation priority (step S103).

Subsequently, the communication control device 60 allocates, as an interference margin, a total interference amount allowed by the first radio system to the second radio system included in the upper group (step S104).

Subsequently, the communication control device 60 determines whether there is a surplus margin as a result of the allocation (step S105). In a case where there is no surplus margin (step S105: No), the communication control device 60 ends the process.

In contrast, in a case where there is a surplus margin (step S105: Yes), the communication control device 60 allocates the surplus margin to the lower group (step S106), and proceeds the process to step S105.

### 7. Modification

The communication control device 60 of the present embodiment is not limited to the device described in the above-described embodiment. For example, the communication control device 60 may be a device having a function other than controlling the base station device 40 that performs secondary use of a frequency band in which spectrum sharing is performed. For example, the function of the communication control device 60 of the present embodiment may be provided in a network manager. At this time, the network manager may be, for example, a centralized base band unit (C-BBU) having a network configuration referred to as a centralized radio access network (C-RAN) or a device including the C-BBU. Furthermore, the function of the network manager may be provided in a base station (including an access point). These devices (such as a network manager) can also be regarded as communication control devices.

Furthermore, in the above-described embodiment, the communication control device 60 is a device belonging to the communication system 2, but does not necessarily have to be a device belonging to the communication system 2. The communication control device 60 may be a device outside the communication system 2. The communication control device 60 may indirectly control the base station device 40 via a device constituting the communication system 2 rather than directly controlling the base station device 40. In addition, there may be a plurality of secondary systems (communication systems 2). At this time, the communication control device 60 may manage the plurality of secondary systems. In this case, each of the secondary systems can be regarded as the second radio system.

As general naming in spectrum sharing, an incumbent system using a target band is referred to as a primary system, and a secondary user is referred to as a secondary system. However, the primary system and the secondary system may be each replaced with different terms. A macro cell in a Heterogeneous Network (HetNET) may be defined as the primary system, and a small cell or a relay station may be defined as the secondary system. In addition, a base station may be defined as the primary system, and relay user equipment (Relay UE) or vehicle user equipment (Vehicle UE) that implements D2D or vehicle-to-everything (V2X) existing in the coverage may be defined as the secondary system. The base station is not limited to a fixed type, and may be a portable/mobile type.

Furthermore, the interface between the entities may be either wired or wireless. For example, the interface between the entities (communication device, communication control device, or terminal device) described in the present embodiment may be a wireless interface that does not depend on spectrum sharing. Examples of the wireless interface that does not depend on spectrum sharing include a wireless communication line provided by a mobile communication carrier (network operator) via a licensed band, and wireless LAN communication using an incumbent license-exempt band.

The control device that controls the radio wave utilization device 10, the management device 20, the terminal device 30, the base station device 40, the intermediate device 50, or the communication control device 60 according to the present embodiment may be implemented by a dedicated computer system or a general-purpose computer system.

For example, a program for executing the above-described operations is stored in a computer-readable recording medium such as an optical disk, semiconductor memory, a magnetic tape, or a flexible disk and distributed. For example, the program is installed on a computer and the above processes are executed to achieve the configuration of the control device. At this time, the control device may be a device (for example, a personal computer) outside the radio wave utilization device 10, the management device 20, the terminal device 30, the base station device 40, the intermediate device 50, or the communication control device 60. Furthermore, the control device may be a device (for example, the control unit 13, the control unit 23, the control unit 34, the control unit 44, the control unit 54, or the control unit 64) inside the radio wave utilization device 10, the management device 20, the terminal device 30, the base station device 40, the intermediate device 50, or the communication control device 60.

Furthermore, the communication program may be stored in a disk device included in a server device on a network such as the Internet so as to be able to be downloaded to a computer, for example. Furthermore, the functions described above may be implemented by using operating system (OS) and application software in cooperation. In this case, the sections other than the OS may be stored in a medium for distribution, or the sections other than the OS may be stored in a server device so as to be downloaded to a computer, for example.

Furthermore, among individual processes described in the above embodiments, all or a part of the processes described as being performed automatically may be manually performed, or the processes described as being performed manually can be performed automatically by known methods. In addition, the processing procedures, specific names, and information including various data and parameters illustrated in the above Literatures or drawings can be arbitrarily altered unless otherwise specified. For example, various types of information illustrated in each of the drawings are not limited to the information illustrated.

In addition, each of the components of each of the illustrated devices is provided as a functional and conceptional illustration and thus does not necessarily have to be physically configured as illustrated. That is, the specific form of distribution/integration of each of the devices is not limited to those illustrated in the drawings, and all or a part thereof may be functionally or physically distributed or integrated into arbitrary units according to various loads and use conditions.

Furthermore, the above-described embodiments can be appropriately combined within a range implementable without contradiction of processes. Furthermore, the order of individual steps illustrated in the sequence diagram or the flowchart of the present embodiment can be changed as appropriate.

Furthermore, for example, the present embodiment can be implemented as any configuration constituting a device or a system, for example, a processor as a large scale integration (LSI) or the like, a module using a plurality of processors or the like, a unit using a plurality of modules or the like, and a set obtained by further adding other functions to the unit, or the like (that is, a configuration of a part of the device).

In the present embodiment, a system represents a set of a plurality of components (devices, modules (components), or the like), and whether all the components are in the same housing would not be a big issue. For example, a plurality of devices housed in separate housings and connected via a network or the like, and one device in which a plurality of modules is housed in one housing, are both systems.

Furthermore, for example, the present embodiment can adopt a configuration of cloud computing in which one function is cooperatively shared and processed by a plurality of devices via a network.

### 8. Conclusion

As described above, according to an embodiment of the present disclosure, the communication control device 60 that is an information processing device includes: an acquisition unit that acquires information regarding each of a plurality of second radio systems that share a radio wave used by a first radio system; a calculation unit that calculates an allocation priority for each of the plurality of second radio systems based on the information acquired by the acquisition unit; and an allocation unit that allocates a total interference amount allowed by the first radio system to each of the plurality of second radio systems as an interference amount based on the allocation priority calculated by the calculation unit. This makes it possible to appropriately allocate the interference margin.

The embodiments of the present disclosure have been described above. However, the technical scope of the present disclosure is not limited to the above-described embodiments, and various modifications can be made without departing from the scope of the present disclosure. Moreover, it is allowable to combine the components across different embodiments and modifications as appropriate.

The effects described in individual embodiments of the present specification are merely examples, and thus, there may be other effects, not limited to the exemplified effects.

Note that the present technology can also have the following configurations.

(1)

An information processing device comprising:

an acquisition unit that acquires information regarding each of a plurality of second radio systems that share a radio wave used by a first radio system;

a calculation unit that calculates an allocation priority for each of the plurality of second radio systems based on the information acquired by the acquisition unit; and

an allocation unit that allocates a total interference amount allowed by the first radio system to each of the plurality of second radio systems as an interference amount based on the allocation priority calculated by the calculation unit.

(2)

The information processing device according to (1), further comprising

a grouping unit that groups the plurality of second radio systems into a plurality of groups according to the allocation priority calculated by the calculation unit,

wherein the allocation unit

sets the interference amount allocated to the plurality of groups such that the higher the allocation priority of the group, the more the interference amount to be allocated.

(3)

The information processing device according to (2),

wherein the allocation unit

allocates the interference amount being a same amount as an interfering amount estimated based on desired transmission power, to each of the plurality of second radio systems included in the group.

(4)

The information processing device according to (3),

wherein the allocation unit

provisionally and equally allocates the total interference amount to each of the plurality of second radio systems included in the group, and, when a provisional interference amount, which is the amount provisionally and equally allocated to each system, exceeds the interfering amount, the allocation unit reallocates a surplus interference amount to others of the second radio systems included in the group.

(5)

The information processing device according to the above-described (3) to (4),

wherein the allocation unit

reallocates the surplus interference amount to the second radio system in which the provisional interference amount is less than the interfering amount.

(6)

The information processing device according to the above-described (3) to (5),

wherein the allocation unit

allocates the interference amount, which is the same amount as the interfering amount, to all of the plurality of second radio systems included in the group, and when there is the surplus interference amount, the allocation unit allocates the surplus interference amount to another group.

(7)

The information processing device according to the above-described (3) to (6),

wherein, when there is the second radio system in which there is no surplus interference amount and the provisional interference amount is less than the interfering amount, the allocation unit

terminates authorization of radio transmission for the second radio communication system.

(8)

The information processing device according to the above-described (1) to (7), further comprising

a power calculation unit that calculates maximum allowable transmission power in each of a plurality of the first radio systems based on the information acquired by the acquisition unit in a case where the second radio system shares radio waves used by the plurality of first radio systems,

wherein the allocation unit
sets the interference amount in the first radio system having the lowest maximum allowable transmission power among the calculation results of the power calculation unit, as the interference amount in others of the first radio systems.
   (9)

The information processing device according to (8),

wherein the acquisition unit

acquires information regarding a positional relationship between the first radio system and the second radio system, and

the power calculation unit

calculates the maximum allowable transmission power based on the information regarding the positional relationship.

(10)

The information processing device according to the above-described (8) to (9),

wherein the acquisition unit

acquires information regarding a transmission characteristic of the second radio system,

the power calculation unit

calculates a maximum transmission power of the second radio system based on the information regarding the transmission characteristic, and

the allocation unit

allocates the interference amount of the second radio system based on a comparison result between the maximum allowable transmission power and the maximum transmission power.

(11)

The information processing device according to the above-described (1) to (10),

wherein the acquisition unit

acquires parameter information regarding communication of the second radio system,

the calculation unit

calculates, as the allocation priority, a transmission power based on the parameter information, and

the allocation unit
allocates the interference amount to each of the plurality of second radio systems based on the transmission power.
   (12)

The information processing device according to the above-described (1) to (11),

wherein the acquisition unit

acquires information regarding a hierarchy of a Citizens Broadband Radio Service (CBRS), and

the calculation unit

sets the allocation priority such that the higher the hierarchy of the second radio system in the CBRS, the higher the allocation priority is given.

(13)

An information processing method comprising:

acquiring information regarding each of a plurality of second radio systems that share a radio wave used by a first radio system;

calculating an allocation priority for each of the plurality of second radio systems based on the acquired information; and

allocating a total interference amount allowed by the first radio system to each of the plurality of second radio systems based on the calculated allocation priority.

(14)

An information processing program that causes a computer to function as:

an acquisition unit that acquires information regarding each of a plurality of second radio systems that share a radio wave used by a first radio system;

a calculation unit that calculates an allocation priority for each of the plurality of second radio systems based on the information acquired by the acquisition unit; and

an allocation unit that allocates a total interference amount allowed by the first radio system to each of the plurality of second radio systems as an interference amount based on the allocation priority calculated by the calculation unit.

(15)

A communication device comprising:

an acquisition unit that acquires information regarding each of a plurality of second radio systems that share a radio wave used by a first radio system, calculates an allocation priority for each of the plurality of second radio systems based on the acquired information, and acquires information regarding an interference amount in which a total interference amount allowed by the first radio system is allocated to each of the plurality of second radio systems based on the calculated allocation priority; and

a communication control unit that performs radio transmission based on the information regarding the interference amount acquired by the acquisition unit.

(16)

A communication method including:

acquiring information regarding each of a plurality of second radio systems that share a radio wave used by a first radio system, calculating an allocation priority for each of the plurality of second radio systems based on the acquired information, and acquiring information regarding an interference amount in which a total interference amount allowed by the first radio system is allocated to each of the plurality of second radio systems based on the calculated allocation priority; and

performing radio transmission based on the acquired information regarding the interference amount.

(17)

A communication program that causes a computer to function as:

an acquisition unit that acquires information regarding each of a plurality of second radio systems that share a radio wave used by a first radio system, calculates an allocation priority for each of the plurality of second radio systems based on the acquired information, and acquires information regarding an interference amount in which a total interference amount allowed by the first radio system is allocated to each of the plurality of second radio systems based on the calculated allocation priority; and

a communication control unit that performs radio transmission based on the information regarding the interference amount acquired by the acquisition unit.

### REFERENCE SIGNS LIST

1, 2, 1000 COMMUNICATION SYSTEM
10 RADIO WAVE UTILIZATION DEVICE
20 MANAGEMENT DEVICE
30 TERMINAL DEVICE
40 BASE STATION DEVICE
50 INTERMEDIATE DEVICE
60 COMMUNICATION CONTROL DEVICE
11 PROCESSING UNIT
12, 22, 32, 42, 52, 62 STORAGE UNIT
13, 23, 34, 44, 54, 64 CONTROL UNIT
21 COMMUNICATION UNIT
31, 41, 51, 61 RADIO COMMUNICATION UNIT
33 INPUT/OUTPUT UNIT
43, 53, 63 NETWORK COMMUNICATION UNIT
311, 411 RECEPTION PROCESSING UNIT
312, 412 TRANSMISSION PROCESSING UNIT
313, 413 ANTENNA
341, 441, 541 ACQUISITION UNIT
342, 442, 542 COMMUNICATION CONTROL UNIT
443, 543, 645 NOTIFICATION UNIT
641 ACQUISITION UNIT
642 CALCULATION UNIT
643 ALLOCATION UNIT
644 GROUPING UNIT
645 POWER CALCULATION UNIT

1. An information processing device comprising:
an acquisition unit that acquires information regarding each of a plurality of second radio systems that share a radio wave used by a first radio system;
a calculation unit that calculates an allocation priority for each of the plurality of second radio systems based on the information acquired by the acquisition unit; and
an allocation unit that allocates a total interference amount allowed by the first radio system to each of the plurality of second radio systems as an interference amount based on the allocation priority calculated by the calculation unit.

2. The information processing device according to claim 1, further comprising
a grouping unit that groups the plurality of second radio systems into a plurality of groups according to the allocation priority calculated by the calculation unit,
wherein the allocation unit
sets the interference amount allocated to the plurality of groups such that the higher the allocation priority of the group, the more the interference amount to be allocated.

3. The information processing device according to claim 2,
wherein the allocation unit
allocates the interference amount being a same amount as an interfering amount estimated based on desired transmission power, to each of the plurality of second radio systems included in the group.

4. The information processing device according to claim 3,
wherein the allocation unit
provisionally and equally allocates the total interference amount to each of the plurality of second radio systems included in the group, and, when a provisional interference amount, which is the amount provisionally and equally allocated to each system, exceeds the interfering amount, the allocation unit reallocates a surplus interference amount to others of the second radio systems included in the group.

5. The information processing device according to claim 4,
wherein the allocation unit
reallocates the surplus interference amount to the second radio system in which the provisional interference amount is less than the interfering amount.

6. The information processing device according to claim 4,
wherein the allocation unit
allocates the interference amount, which is the same amount as the interfering amount, to all of the plurality of second radio systems included in the group, and when there is the surplus interference amount, the allocation unit allocates the surplus interference amount to another group.

7. The information processing device according to claim 4,
wherein, when there is the second radio system in which there is no surplus interference amount and the provisional interference amount is less than the interfering amount, the allocation unit
terminates authorization of radio transmission for the second radio communication system.

8. The information processing device according to claim 1, further comprising
a power calculation unit that calculates maximum allowable transmission power in each of a plurality of the first radio systems based on the information acquired by the acquisition unit in a case where the second radio system shares radio waves used by the plurality of first radio systems,
wherein the allocation unit
sets the interference amount in the first radio system having the lowest maximum allowable transmission power among the calculation results of the power calculation unit, as the interference amount in others of the first radio systems.

9. The information processing device according to claim 8,
wherein the acquisition unit
acquires information regarding a positional relationship between the first radio system and the second radio system, and
the power calculation unit
calculates the maximum allowable transmission power based on the information regarding the positional relationship.

10. The information processing device according to claim 8,
wherein the acquisition unit
acquires information regarding a transmission characteristic of the second radio system,
the power calculation unit
calculates a maximum transmission power of the second radio system based on the information regarding the transmission characteristic, and
the allocation unit
allocates the interference amount of the second radio system based on a comparison result between the maximum allowable transmission power and the maximum transmission power.

11. The information processing device according to claim 1,
wherein the acquisition unit
acquires parameter information regarding communication of the second radio system,
the calculation unit
calculates, as the allocation priority, a transmission power based on the parameter information, and
the allocation unit
allocates the interference amount to each of the plurality of second radio systems based on the transmission power.

12. The information processing device according to claim 1,
wherein the acquisition unit
acquires information regarding a hierarchy of a Citizens Broadband Radio Service (CBRS), and
the calculation unit
sets the allocation priority such that the higher the hierarchy of the second radio system in the CBRS, the higher the allocation priority is given.

13. An information processing method comprising:
acquiring information regarding each of a plurality of second radio systems that share a radio wave used by a first radio system;
calculating an allocation priority for each of the plurality of second radio systems based on the acquired information; and
allocating a total interference amount allowed by the first radio system to each of the plurality of second radio systems based on the calculated allocation priority.

14. A communication device comprising:
an acquisition unit that acquires information regarding each of a plurality of second radio systems that share a radio wave used by a first radio system, calculates an allocation priority for each of the plurality of second radio systems based on the acquired information, and acquires information regarding an interference amount in which a total interference amount allowed by the first radio system is allocated to each of the plurality of second radio systems based on the calculated allocation priority; and
a communication control unit that performs radio transmission based on the information regarding the interference amount acquired by the acquisition unit.
